(19) United States
(12) Patent Application Publication
(10) Pub. No.: US 2026/0111984 A1
(43) Pub. Date: Apr. 23, 2026

(54) SYSTEMS AND METHODS FOR DETERMINING ACTIONS DURING EMERGENCIES

(71) Applicant: LifeSpot Technology, Inc., Parker, CO (US)

(72) Inventors: Brett TITUS, Parker, CO (US); Leslie MCCLANEN, Parker, CO (US); Jacob KENDRICK, Bloomfield, CO (US)

(73) Assignee: LifeSpot Technology, Inc., Parker, CO (US)

(21) Appl. No.: 19/379,379

(22) Filed: Nov. 4, 2025

Related U.S. Application Data
(63) Continuation of application No. PCT/US2024/028897, filed on May 10, 2024.
(60) Provisional application No. 63/501,990, filed on May 12, 2023.

(51) Int. Cl. G06Q 50/26

(52) U.S. Cl. CPC G06Q 50/265

(57) ABSTRACT

Described are systems and methods for determining at least one action in an emergency. Methods can include receiving a set of user data associated with one or more users; receiving a set of responder data associated with one or more responders; processing, via a trained machine learning model, the set of user data or the set of responder data to generate the at least one action; and transmitting the at least one action to one or more commanders, wherein the one or more commanders direct the one or more users or the one or more responders to perform the at least one action during the emergency.

### CROSS-REFERENCE TO RELATED APPLICATIONS

This application is a continuation of PCT Application No. PCT/US2024/028897, filed May 10, 2024, which claims the benefit of U.S. Provisional Application No. 63/501,990, filed May 12, 2023, each of which is incorporated by reference herein in its entirety.

### BACKGROUND

Mobile devices and mobile communication systems have vastly improved the ability to communicate. Mobile devices such as mobile phones play an increasingly important role in communications during emergencies. With extensive mobile service coverage and the ability to transmit large amounts of data over existing wireless networks, mobile phones can be an effective emergency communication tool. However, such large amounts of data pose problems for users, responders, or commanders to effectively conclude emergencies. Problems can include inefficient processing of data, inaccurate understanding of data, or untimely generation of actions based on data. These problems can result in actions that fail to eliminate or mitigate active threats during emergencies. Machine learning methods including natural language processing of data can help to improve actions for eliminating or mitigating casualties or injuries during emergencies.

### SUMMARY

Recognized is a need for systems and methods to improve generating, determining, or predicting of actions in response to emergencies. Disclosed herein are systems and methods for generating, determining, or predicting actions in response to emergencies. Systems and methods can generate, determine, or predict actions to eliminate or mitigate active threats thereby eliminating or mitigating casualties or injuries during emergencies.

In an aspect, disclosed herein is method for determining at least one action in an emergency, the method comprising: (a) receiving a set of user data associated with one or more users; (b) receiving a set of responder data associated with one or more responders; (c) processing, via a trained machine learning model, the set of user data or the set of responder data to generate the at least one action; and (d) transmitting the at least one action to one or more commanders, wherein the one or more commanders direct the one or more users or the one or more responders to perform the at least one action during the emergency.

In some embodiments, the emergency is associated with one or more active threats on a same or different campus, workplace, or commercial establishment.

In some embodiments, the trained machine learning model is obtained by: training the model using (1) a first and second set subset of the set of user data, (2) a first and second subset of the responder data, and (3) associating an action score with each of the first and second subsets of the user data or responder data; validating the model on an independent subset of the user data or the responder data; and selecting a threshold performance for the validated model such that the validated model determines the at least one action based at least on each of the action scores, wherein the threshold performance is indicative of a likelihood of the at least one action resolving the emergency.

In some embodiments, the trained machine learning model comprises a natural language processing (NLP) model for processing one or more communications associated with the one or more users, the one or more responders, or the one or more commanders to determine the at least one action.

In some embodiments, the method occurs in a mode comprising an actual emergency mode or a training emergency mode.

In some embodiments, the set of user data comprises user communications data, user status data, or user location data.

In some embodiments, the set of responder data comprises responder communications data, responder status data, responder location data, or responder navigation data.

In some embodiments, the one or more commanders are associated with a set of commander data comprising commander communications data, commander status data, commander location data, or commander navigation data.

In some embodiments, the at least one action associated with the one or more users comprises a user communication action, a fortify action, a flee action, an injury action, or a user status action.

In some embodiments, the at least one action associated with the one or more responders comprises a responder communication action, a respond action, a command action, or a responder status action.

In some embodiments, the at least one action associated with the one or more commanders comprises a commander communication action, a respond action, an aerial action, a ground action, an intervention action, or a reunify action.

In some embodiments, the at least one action comprises the one or more responders or the one or more commanders mitigating one or more active threats associated with the emergency.

In some embodiments, the method further comprises: receiving a set of aerial data, ground data, or structural data; and processing, via the trained machine learning model, the set of aerial data, ground data, or structural data to generate the at least one action.

In some embodiments, the set of aerial data comprises data associated with or received from one or more unmanned aerial vehicles, one or more manned aerial vehicles, or any combination thereof.

In some embodiments, the set of ground data comprises data associated with or received from one or more image devices, one or more security doors, one or more communications towers, one or more networked devices, or any combination thereof.

In some embodiments, the set of structural data comprises data associated with or received from one or more architectural plans, one or more aerial images, one or more satellite images, or any combination thereof.

In some embodiments, the method further comprises: transmitting the at least one action to the one or more users, the one or more responders, or the one or more commanders, wherein the transmitting is via a communications network configured with the one or more users in communication with the one or more responders or the one or more commanders.

In some embodiments, the method further comprises: determining a reunification status of the one or more users; and transmitting the reunification status to the one or more responders or the one or more commanders.

In some embodiments, the reunification status comprises: unaccounted for status, accounted for status, released to a guardian status, released to emergency medical services (EMS) status, absent status, other status, or any combination thereof.

In some embodiments, the one or more users transmit the set of user data to the one or more responders, the one or more commanders, or at least another user of the one or more users.

In some embodiments, the one or more responders transmit the set of responder data to the one or more users, the one or more commanders, or at least another responder of the one or more responders.

In some embodiments, the one or more commanders transmit a set of commander data to the one or more users, the one or more responders, or at least another commander of the one or more commanders.

In some embodiments, the one or more users receive the set of responder data from the one or more responders or a set of commander data from the one or more commanders.

In some embodiments, the one or more responders receive the set of user data from the one or more users or a set of commander data from the one or more commanders.

In some embodiments, the one or more commanders receive the set of user data from the one or more users or the set of responder data from the one or more commanders.

In some embodiments, before the at least one action is transmitted to the one or more commanders, the at least one action is transmitted to the one or more users to perform during the emergency.

In some embodiments, before the at least one action is transmitted to the one or more commanders, the at least one action is transmitted to the one or more responders to perform during the emergency.

In some embodiments, before the at least one action is transmitted to the one or more commanders, the at least one action is transmitted to the one or more users or the one or more responders to perform during the emergency.

In some embodiments, the one or more users and the one or more responders transmit the at least one action to each other to perform during the emergency.

In some embodiments, the method further comprises determining, via the trained machine learning model, a threat assessment of one or more active threats.

In some embodiments, the at least one action comprises automatically deploying one or more threat countermeasures based at least on the threat assessment.

In some embodiments, the at least one action comprises automatically controlling at least one security door based at least on the threat assessment.

In another aspect, disclosed herein is a system for determining at least one action in an emergency, comprising: a user module configured to received or transmit a set of user data associated with one or more users; a responder module configured to receive or transmit a set of responder data associated with one or more responders; a processing module configured to process, via a trained machine learning model, the set of user data or the set of responder data to generate the at least one action; a commander module configured to transmit the at least one action to the one or more commanders, wherein the one or more commanders direct the one or more users or the one or more responders to perform the at least one action during the emergency.

In another aspect, disclosed herein is a computer program product for determining at least one action in an emergency, the computer program product comprising at least one non-transitory computer-readable medium having computer-readable program code portions embodied therein, the computer-readable program code portions comprising: an executable portion configured to receive or transmit a set of user data associated with one or more users; an executable portion configured to receive or transmit a set of responder data associated with one or more responders; an executable portion configured to process, via a trained machine learning model, the set of user data or the set of responder data to generate the at least one action; and an executable portion configured to transmit the at least one action to the one or more commanders, wherein the one or more commanders direct the one or more users or the one or more responders to perform the at least one action during the emergency.

Some example embodiments are directed to a mobile device having a gesture-based user interface. The mobile device may include a user interface that is configured to accept simple commands from a user and relay key information during emergency situations. The commands and information may be relayed to third-party responders that can facilitate communication with the authorities or other rescue personnel. Some example embodiments are also directed to distributed alert systems that are configured to pass selected communications to users that are subscribers to an alert communication service, but may be located away from or outside of a geo-fenced region associated with an active incident.

Some example embodiments are directed to a mobile device having a display and a touch sensor configured to detect gesture input. The mobile device may be configured to display an initiate-alert region on the display. In response to receiving a first gesture input while the initiate-alert region is displayed, the mobile device may initiate an alert communication interface, which may be operable to contact authorities or an emergency responder service. The mobile device may also display a bifurcated status region on the display, the bifurcated status region indicating a first user status option and a second user status option. In response to receiving a second gesture input, the mobile device may initiate a status communication associated with the first user status option. In response to receiving a third gesture input, the mobile device may initiate a status communication associated with the second user status option.

In some embodiments, the first gesture is a vertical swipe gesture over the initiate-alert region. Touch input other than a vertical swipe gesture does not initiate an alert communication interface. The second gesture may be a horizontal swipe gesture toward a first area associated with the first user status option and the third gesture may be a horizontal swipe gesture toward a second area associated with the second user status option. Touch input other than a horizontal swipe gesture in the bifurcated status region does not initiate a communication to the responder server.

In some embodiments, the mobile device is further configured to determine a location of the mobile device and determine if the location is within a predefined geo-fence. In accordance with a determination that the location is within the geo-fence, the mobile device may be configured to initiate the alert communication interface in response to receiving the first gesture. In accordance with a determination that the location is not within the geo-fence, the mobile device may prohibit or suppress an initiation of the alert communication interface in response to receiving the first gesture.

Some example embodiments are directed to a mobile device having a global positioning system configured to determine location information using a wireless communication network. The device may also include a display for displaying a user interface and a touch sensor incorporated with the display and configured to detect touch input for the user interface. The mobile device may also include internal memory configured to store computer-readable instructions and a processor configured to execute the computer-readable instructions. The instructions may provide various functionality including displaying an initiate-alert icon on the display. In response to receiving a swipe-gesture input over the initiate-alert icon, the mobile device may initiate an alert communication interface, which may be operable to contact authorities or an emergency responder service (e.g., 9-1-1). The interface may be used to automatically communicate a location of the user to the authorities or an emergency responder service. The instructions may also include instructions for displaying a bifurcated status region on the display, the bifurcated status region indicating a first user status option at a first end and a second user status option at a second end. In response to receiving a first swipe-gesture input directed toward the first end, the mobile device may initiate a status communication associated with the first user status option. In response to receiving a second swipe-gesture input directed toward the second end, the mobile device may initiate a status communication associated with the second user status option. In some embodiments, the first user status option is to stay, indicating that a user intends to remain in one location (e.g., fortify), and the second user status option is to move (e.g., flee), indicating that the user intends to change location.

In some embodiments, the instructions further comprise instructions for displaying an update status region on the display. The update status region may include the first user status option in a first area and the second user status option in a second area. In response to an additional swipe-gesture input being directed toward the first area, the mobile device may initiate an updated status communication associated with the first user status option. In response to the additional swipe-gesture input being directed across the second area, the mobile device may initiate an updated status communication associated with the second user status option.

In some embodiments, the instructions further comprise instructions for: determining a current user status; displaying a maintain current status icon in a first region using the display; and displaying a change status icon in a second region using the display. In response to an additional swipe-gesture input over the first region, the mobile device may initiate a maintain status communication. In response to an additional swipe-gesture input toward the second region, the mobile device may initiate a change status communication.

In some embodiments, the instructions further comprise instructions for displaying an injury icon on the display. In response to receiving a touch input on the injury icon, the mobile device may initiate an injury report communication to the responder server. In some implementations, the mobile device is configured to notify police authorities using the alert communication interface.

In some embodiments, the instructions further comprise instructions for defining a geo-fence based on the location information obtained using the global positioning system, and displaying a map associated with the geo-fence adjacent to the bifurcated status region.

In some embodiments, the instructions further comprise instructions for displaying an update status region on the display and displaying a scrolling message in a region adjacent to the update status region. In some cases, the scrolling message includes instructions for the user.

Some example embodiments are directed to a portable electronic device having a display and a touch sensor configured to detect gesture input. The portable electronic device may also include a memory configured to store computer-readable instructions. The portable electronic device may be configured to execute the computer-readable instructions for displaying an initiate-alert region on the display. In response to receiving a swipe-gesture input while the initiate-alert region is displayed, the portable electronic device may initiate an alert communication interface. The alert communication interface may be used to place a telephone call to authorities or an emergency responder service and broadcast location information automatically to the authorities or the service. In some instances, the portable electronic device displays a bifurcated status region on the display, the bifurcated status region indicating a first user status option and a second user status option. In response to receiving a first swipe-gesture input in a first direction, the portable electronic device may initiate a status communication associated with the first user status option. In response to receiving a second swipe-gesture input in a second direction, the portable electronic device may initiate a status communication associated with the second user status option. In some implementations, the first user status option is to maintain a current location, and the second user status option is to change a current location.

In some embodiments, the portable electronic device is configured to display a first user interface screen in response to a user selection of the first user status option, and display a second user interface screen in response to a user selection of the second user status option.

In some embodiments, the portable electronic device is further configured to: display a number pad on the display; receive a touch input on the number pad indicating a floor number of a building; and communicate the floor number to the responder server in response to the touch input.

Some example embodiments are directed to an emergency communication system comprising a group of subscriber mobile devices and a responder server. The group of subscriber mobile devices may be configured to communicate using a wireless network. Each subscriber mobile device may include a global positioning system configured to determine location information. The subscriber mobile devices may also include a touch-sensitive display and a processor configured to execute various functions in accordance with the following. For example, the subscriber mobile devices may communicate the location information to a responder server in response to an initiated alert. The subscriber mobile devices may also display a bifurcated status region on the display. In response to receiving a first swipe-based gesture over the bifurcated status region, the subscriber mobile devices may communicate a first status to the responder server. In response to receiving a second swipe-based gesture over the bifurcated status region, the subscriber mobile devices may communicate a second status to the responder server.

In some embodiments, the responder server includes a communications or command module configured to receive communications from the group of subscriber mobile devices. The responder server may also include a display and a processor configured to perform various functions in accordance with the following. For example, the responder server may be configured to define a geo-fence associated with location information received from the group of subscriber mobile devices. The responder server may display a map of a region associated with the defined geo-fence and display an icon on the map associated with each subscriber mobile device of the group of subscriber mobile devices that are located within the geo-fence. The responder server may be configured to change the color of the icon in response to a change in a status received from a respective subscriber device.

In some embodiments, the icon associated with each subscriber mobile device of the group of subscriber mobile devices is positioned on a map in a map location that corresponds to the location information. The map location may be updated based on an update of the location information. In some embodiments, the responder server is configured to receive an injury status from a subscriber mobile device of the group of subscriber mobile devices. A corresponding icon associated with the subscriber mobile device may change color in response to a change in the injury status.

In some embodiments, a subscriber mobile device of the group of subscriber mobile devices is configured to activate an onboard sensor of the subscriber mobile device. The 55 responder server may be configured to receive data from a set of activated onboard sensors from a set of subscriber mobile devices of the group of subscriber mobile devices. The responder server may be configured to estimate a location of a threat based on the received data.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

References will be made to embodiments of the present disclosure, examples of which may be illustrated in the accompanying drawings (also “Figure” and “FIG.” herein). The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIGS. 1A-1B depict example system architectures and an example mobile device thereof, in accordance with some embodiments; FIG. 1A depicts an example high-level architecture or system configured to implement methods herein; FIG. 1B depicts an example mobile device configured to implement methods herein;

FIG. 2 depicts an example communications network including a device and example responder servers, in accordance with some embodiments;

FIG. 3 depicts an example user interface for a device configured to initiate an alert, in accordance with some embodiments;

FIGS. 4A-4B depict example user interfaces for devices herein, in accordance with some embodiments. FIG. 4A depicts an example user interface for a device configured to initiate an alert communication using an alert communication interface; FIG. 4B depicts an example user interface for a device configured to receive location information from the user;

FIG. 5 depicts an example user interface for a device configured to relay location or mobility information, in accordance with some embodiments;

FIG. 6 depicts an example user interface for a device configured to relay a change in location or mobility information, in accordance with some embodiments;

FIG. 7 depicts an example map of a region associated with a geo-fence, in accordance with some embodiments;

FIG. 8 depicts an example system for a first type of distributed alert system, in accordance with some embodiments;

FIGS. 9A-9C depict example user interfaces for a first type of distributed alert system, in accordance with some embodiments; FIG. 9A depicts an example user interface for a device, e.g., a home screen feature once an alert communication has been received; FIG. 9B depicts an example user interface for a device, e.g., a map display feature providing location information; FIG. 9C depicts an example user interface for a device, e.g., initiating a communication to responders or commanders;

FIG. 10 depicts an example system for a second type of distributed alert system, in accordance with some embodiments;

FIGS. 11A-11B depict example user interfaces for the second type of distributed alert system, in accordance with some embodiments; FIG. 11A depicts an example user interface for a device, e.g., a home screen feature once an alert communication has been received; FIG. 11B depicts an example user interface for a device, e.g., a map display feature providing location information;

FIGS. 12A-12G depict example user interfaces associated with user devices, in accordance with some embodiments; FIG. 12A depicts an example user interface for a device, e.g., an initiate-alert feature; FIG. 12B depicts an example user interface for a device, e.g., an alert confirmation feature; FIG. 12C depicts an example user interface for a device, e.g., location information feature; FIG. 12D depicts an example user interface for a device, e.g., user status feature; FIG. 12E depicts an example user interface for a device, e.g., an update status feature; FIG. 12F depicts an example user interface for a device, e.g., an update status feature; FIG. 12G depicts an example user interface for a device, e.g., an update status feature;

FIG. 13 depicts example responder interfaces associated with responder devices, in accordance with some embodiments;

FIGS. 14A-14D depict example commander interfaces associated with commander devices, in accordance with some embodiments; FIG. 14A depicts an example user interface for a device, e.g., a commander authentication feature; FIG. 14B depicts an example user interface for a device, e.g., an alert preview feature; FIG. 14C depicts an example user interface for a device, e.g., an alert dashboard feature; FIG. 14D depicts an example user interface for a device, e.g., a reunification feature;

FIGS. 15A-15H depict example data flows of distributed alert systems, in accordance with some embodiments; FIG. 15A depicts an example of responder servers configured in a cloud services application; FIG. 15B depicts an example of configuring the cloud services application with application programming interfaces (APIs); FIG. 15C depicts an example flow of data associated with location data; FIG. 15D depicts an example flow of data associated with user data; FIG. 15E depicts an example flow of data associated with responder data; FIG. 15F depicts example flow of data associated with communication data; FIG. 15G depicts an example flow of data associated with alert status data; FIG. 15H depicts an example backend architecture for distributed alert systems;

FIGS. 16A-16K depict example user interfaces associated with door locking systems, in accordance with some embodiments. FIG. 16A depicts an example user interface for a device, e.g., integrating with a school locking system; FIG. 16B depicts an example user interface for a device, e.g., integrating with a school locking system; FIG. 16C depicts an example user interface for a device, e.g., entering the auto door lock information; FIG. 16D depicts an example user interface for a device, e.g., after the door lock information is entered; FIG. 16E depicts an example user interface for a device, e.g., creating a user action; FIG. 16F depicts an example user interface for a device, e.g., creating a door lock action; FIG. 16G depicts an example user interface for a device, e.g., entering the name and unique key of the door; FIG. 16H depicts an example user interface for a device, e.g., entering and saving a door lock to the alert system; FIG. 16I depicts an example user interface for a device, e.g., creating actions, editing the door information or action, and deleting a door lock for the configured door; FIG. 16J depicts an example user interface for a device, e.g., editing an action if Edit is clicked; FIG. 16K depicts an example user interface for a device, e.g., deleting a door lock if Delete Door Lock is clicked;

FIG. 17 depicts an example architecture or system configured to integrate with unmanned aerial vehicles (UAVs) or drones, in accordance with some embodiments;

FIG. 18 depicts an example architecture or system configured to integrate with threat countermeasures, in accordance with some embodiments;

FIG. 19 depicts an example computing device configured to perform methods herein, in accordance with some embodiments;

FIG. 20 depicts an example web or mobile application provision system configured to perform methods herein, in accordance with some embodiments; and

FIG. 21 depicts an example cloud-based web or mobile application provision system configured to perform methods herein, in accordance with some embodiments.

### DETAILED DESCRIPTION

The following detailed description provides several example embodiments that are not intended to limit the claims to a single embodiment or implementation. The description is intended to describe example implementations and alternatives of the embodiments defined by the claims.

### Overview

The following disclosure relates to devices and systems that are configured to implement methods such as facilitating communication between a user and a third party during an emergency situation. In particular, example devices are configured to facilitate communication using a specially configured user interface that provides clear visual cues and provides for simple, gesture-based user input. In some instances, the user interface is configured to suppress a response or reject/ignore user input that does not correspond to particular gesture-based input and may, therefore, prevent incidental or accidental communication between the user and a responder or emergency rescue personnel.

The user interface and systems described herein may be adapted for response to an emergency situation. Example emergency situations include active threats, e.g., active shooters, bomb threats, natural disasters, or other potentially life-threatening situations. In some cases, the user interface and systems described herein can be used to coordinate communications between users within a zone of danger and other parties that may be able to provide assistance. In some instances, the user interface and systems and methods described herein can be used to identify and locate the active threat and provide responders with more complete information about a developing or changing emergency situation.

In some cases, the user interface is implemented on a mobile device or other portable electronic device. The user interface may include a series of screens, displays, or user-interface panels, each screen or panel responsive to a gesture-based input. In response to receiving the correct gesture input, the user interface may cause the device to execute various functions in accordance with an emergency response procedure. Functions include transmission of an alert communication to an emergency responder service, transmission of the location of the user, transmission of regularly updated status communications indicating a propensity of a user to either move or remain in place, and transmission of an injury status. These and other transmissions may be received by a responder server that may coordinate information between the user and emergency responding personnel or authorities.

### Responder Servers for Emergencies

The responder server may serve as a centralized information communication point that coordinates information from a group of mobile devices that have subscribed or are running an application associated with the emergency responder services. These devices are referred to herein as “subscriber mobile devices.” The responder server may define a geo-fence associated with a geographic location, which may include a public institution like a school, hospital, or other institution. The responder server may be used to identify subscriber mobile devices that are located within the geo-fence and display a map or other graphical interface indicating the relative position of each subscriber mobile device. The locations of each subscriber mobile device may be represented by an icon that may change color in response to a change in status of the associated user.

In some instances, the responder server may automatically activate the subscriber mobile devices that are located within the geo-fence. The activated devices may provide updated information to each user via a streaming message or dialogue window. The activated devices may also initiate or activate onboard sensors, such as microphones, cameras, or other acquisition devices that can be used to collect environmental data or information. Based on the collected data from mobile devices within the geo-fence, the responder server may estimate a location or region of potentially violent activity.

In some instances, the responder server may communicate with subscriber mobile devices that are within the geo-fence and relay information about the user's location with respect to an incident location or estimated location of a potential threat. The responder server may then communicate messages or other information with subscriber mobile devices that are within a specified region associated with the incident or potential threat. The responder server may also communicate messages or other information with subscriber mobile devices that are outside of the region associated with the incident but are associated with a common entity (e.g., company, university, or agency) or service administrator. For subscriber mobile devices that are outside of the region, the responder server may cause the application to be activated and display a user interface on respective subscriber mobile devices that provides information from the responder server and several options for the user to select to initiate further action.

### Mobile Devices for Emergencies

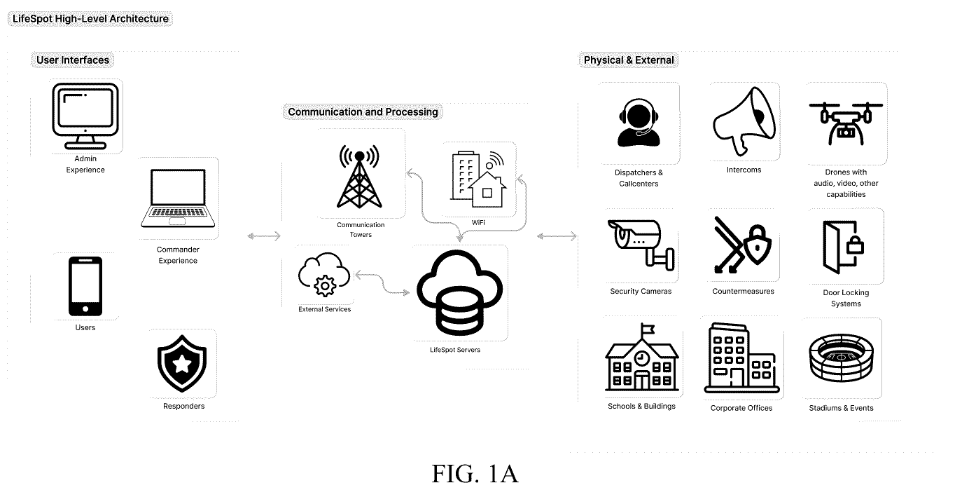

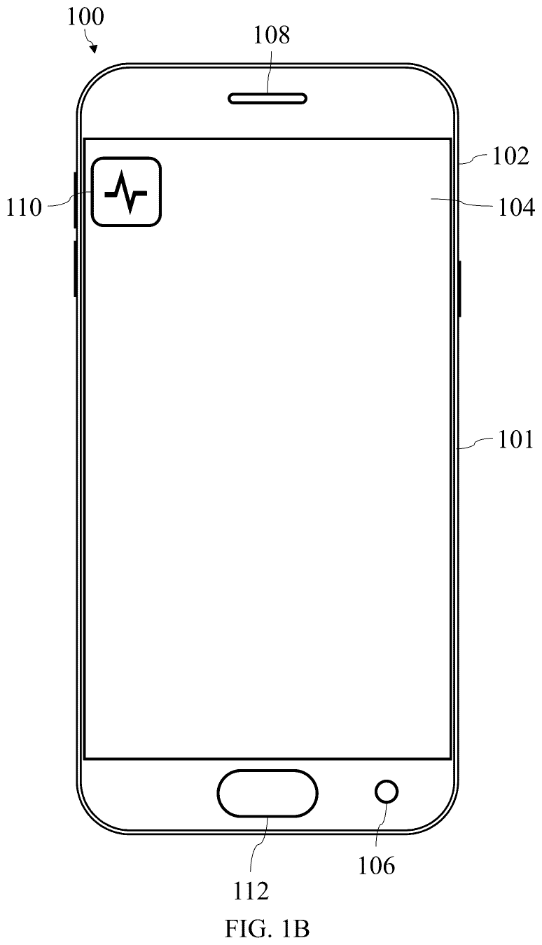

FIG. 1 depicts an example mobile device. In particular, FIG. 1 depicts a device 100 that may be configured to provide one or more of the user interfaces in accordance with the embodiments provided herein. In this example, the device 100 is a mobile phone configured to provide telephone communications or data communications, and provide an advanced touch-based or gesture-based user interface, e.g., a smart phone. The following examples are provided with respect to device 100. However, the same techniques can also be applied to a variety of portable electronic devices, including tablet devices, notebook computing systems, portable media players, and the like.

As shown in FIG. 1, the device 100 includes a display 102 positioned within an enclosure 101. The device enclosure 101 or housing may be formed from a variety of rigid materials and structural elements configured to protect the internal components of the device 100. The display 102 may include one or more display elements including, for example, a liquid-crystal display (LCD) element, a light-emitting diode (LED) display element, an organic light-emitting display (OLED) element, and the like. In some cases, the display 102 is configured to display aspects of a user interface including various interactive screens, displays, panels, or other forms of graphical user-interfaces, in accordance with the embodiments described herein.

As shown in FIG. 1, the device 100 also includes a touch sensor 104 that is integrated or incorporated with the display 102. The touch sensor 104 may include a capacitive array or other sensing element that is configured to detect the presence and location of a touch on the display 102. In some implementations, the touch sensor 104 is configured to detect the touch of a finger, stylus, or other object incident on a cover or other protective layer positioned over the display 102 and touch sensor 104. The touch sensor 104 may be configured to detect gesture input. Gesture input may be used to describe touch input that is based on more than simple touch presence and touch location. For example, a device that is configured to receive gesture input may be configured to detect one or more of: a duration of a touch, motion of a touch, a direction of motion of a touch, multiple touches, motion of multiple touches, direction of multiple touches, and other characteristics of one or more touches detected using the touch sensor. Example gesture input includes swipe gestures, pinch gestures, tap gestures, and so on.

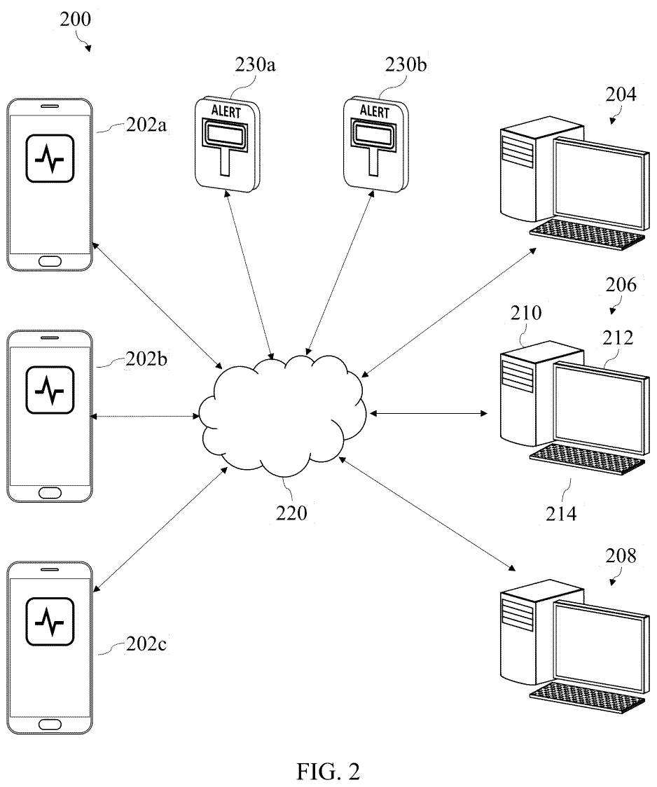

The device 100 may also include a variety of other components including, for example, a speaker 108, a micro-phone 106, and one or more buttons 112. In accordance with some embodiments, the microphone 106 may be activated to collect ambient or environmental signals or audio input associated with the environment of the device 100. The device 100 may include other onboard sensors in addition to the microphone 106. Example onboard sensors include optical sensors, light sensors, pressure transducers, accelerometers, gyroscopes, magnetometers, altimeters, and so on. As described in more detail below with respect to FIG. 2, data collected using the various onboard sensors of the device 100 may be communicated to an external device, such as a responder server, which may use data from multiple devices to determine a location, monitor conditions, and/or locate potentially violent activity.

In some cases, the onboard sensors include a transmitter that is configured to emit an energy pulse or transmission including, for example, acoustic signals, radio signals, magnetic fields, and so on. An onboard receiver may be configured to detect reflections of the energy pulse or transmission, which may be used to locate objects in the proximity of the device 100. In some cases, the transmitter and receiver may be used to estimate a location of a device 100 or user within a building or partially enclosed space. For example, acoustic or radio energy signals may be transmitted by the device 100 and reflections of the transmitted signals may be used to help estimate a location of the device 100 within a building or enclosed structure. The transmitter/receiver sensor scheme may also be used in conjunction with another onboard sensor or sensors to improve the accuracy of the location estimate. In some cases, a layout or floorplan of the building is also used to improve the accuracy of the location estimate.

In another example, the onboard sensors include a magnetometer that is configured to detect a magnetic field. While the magnetometer may be generally configured to detect the location of the earth's natural magnetic field, the device 100 may be adapted to monitor changes in the reading of the structure. For example, the magnetometer may be used to detect the presence and relative location of internal walls, which combined with additional data or information, may be used to locate the device 100 within a building or enclosed structure. For example, a building layout or floorplan may be used in combination with the magnetometer to determine the device's 100 (and the user's) location within the building or enclosed structure. The magnetometer may also be used in conjunction with one or more other sensors or devices to improve the location accuracy.

The device 100 may also include a global positioning system (GPS) or other location system that is configured to determine the location of the device 100 using a wireless communications network. In one example, the device 100 includes a wireless transceiver that is used to collect data from satellites, cellular stations, or other locating equipment that can be used to determine a current location of the device 100. The GPS may be used alone or in conjunction with one or more onboard sensors in order to estimate a location or track movement of the device 100.

The device 100 may also include other wireless communication systems including, for example, a Wi-Fi wireless transceiver system. The wireless communication systems may enable data transmissions with a wireless computer network and connection to the Internet. In some instances, the wireless communication systems may also be configured to communicate with a wireless access point (WAP) using a beacon signal, which may be used to help locate the device within a building or enclosed space. The device 100 may also be configured to use geo-magnetic sensing techniques, described above, in combination with a WAP or Wi-Fi signal to help locate the device within a building or enclosed space.

The device 100 may also include one or more processors and computer memory configured to store computer-readable instructions. The processors may include a central processing unit (CPU), programmable circuit, or other computer processing hardware. The processor(s) may be configured to execute the computer-readable instructions for performing one or more aspects of the user interface and device functionality described herein.

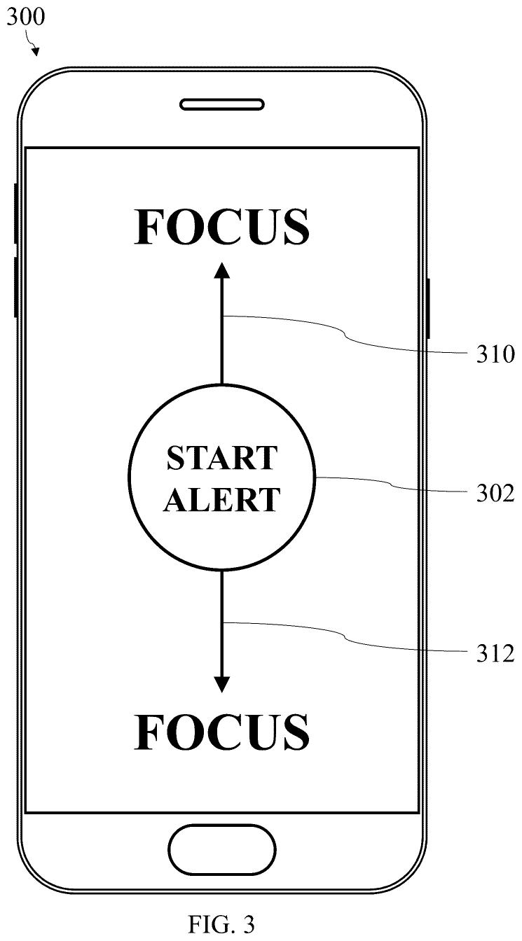

In the example of FIG. 1, the display 102 is used to display an icon 110 associated with a mobile software application or app. The icon 110 may be installed by the user or device administrator as part of an emergency preparedness plan or activity. The icon may be installed on a mobile device operating system or software platform. The device 100 may launch or execute the app when the icon 110 is selected using the touch sensor 104. The app associated with the icon 110 may display a series or screens, displays, or user-interface panels similar to those described below with respect to FIGS. 3-6, 9A-9C, and 11A-11B. While a single icon 110 is depicted in the example of FIG. 1, the device 100 may include multiple apps or software programs, each app configured to perform a different aspect of the systems described herein. Alternatively, a single app may be configured to operate in a manner consistent with all of the embodiments described herein and be configured to alternate between different modes of operation or operational states, as appropriate.

### Emergency Communication Systems for Emergencies

FIG. 2 depicts an example emergency communication system including an example mobile device and example responder servers. In particular, the emergency communication system 200 includes multiple subscriber mobile devices 202a-c in wireless communication with one or more responder servers 204, 206, 208 using network 220. The subscriber mobile devices 202a-c may correspond to the device 100 described above with respect to FIG. 1. In many cases, the emergency communication system 200 includes a large number of subscriber mobile devices that may include mobile phones, tablets, wearable devices, and the like, which are represented by subscriber mobile devices 202a-c as a simplified example. Each of the subscriber mobile devices 202a-c may be associated with a different user or subscriber.

The subscriber mobile devices 202a-c may be configured to transmit and receive data between one or more responder servers 204, 206, 208 using a communications network 220, such as a cellular or mobile device wireless communications network. In some cases, the subscriber mobile devices 202a-c are in communication with the one or more responder servers 204, 206, 208 via one or more cellular base stations, network communication servers, or other intermediate communications equipment. The subscriber mobile devices 202a-c may also be configured to send and receive telephone calls and other traditional data communications depending on the capabilities of the individual devices 202a-c and mobile service provider.

In accordance with the following embodiments, the emergency communication system 200 may be used to facilitate data transfer between the devices including, for example, location information of the subscriber mobile devices 202a-c, alert communications from the subscriber mobile devices 202a-c, update communications from the subscriber mobile devices 202a-c, and the like. The emergency communication system 200 may also facilitate the transmission of data that corresponds to the signals or information collected using the various onboard sensors of the subscriber mobile devices 202a-c. The emergency communication system 200 may also push notifications, messages, and other information from the responder servers 204, 206, 208 to the subscriber mobile devices 202a-c.

As shown in FIG. 2, each of the responder servers 204, 206, 208 may include a computer hardware module 210, a display 212, and a keyboard 214 or other user input device. The computer hardware module 210 may include one or more processors and computer memory configured to store computer-readable instructions. The computer-readable instructions may include instructions for performing one or more aspects of the responder servers 204, 206, 208 as described herein.

In some implementations, the responder servers 204, 206, 208 are configured to define or identify a geo-fence associated with a geographic location, which may include an entity like a school, hospital, company, agency or other organization having a geographic presence. The geo-fence may be predefined using geographic or other location-based information associated with a building or group of buildings associated with the organization. The geo-fence may be defined or created, for example, as part of an emergency preparedness plan or activity in conjunction with local authorities or emergency responders. The geo-fence may also include information about the floorplan or layout of the buildings, which may be used to locate subscriber mobile devices 202a-c within a building or structure.

As discussed previously, one or more of the responder servers 204, 206, 208 may be configured to determine if one or more of the subscriber mobile devices 202a-c is located within the geo-fence. The responder servers 204, 206, 208 may also use the display 212 to display a map or other graphical interface indicating the relative position of each of the subscriber mobile devices 202a-c located within the geo-fence. The locations of each subscriber mobile device may be represented by an icon that may change color in response to a change in status of the associated user. In some cases, the responder servers 204, 206, 208 are configured to receive an injury status from any one of the subscriber mobile devices 202a-c. A corresponding icon associated with the subscriber mobile device may change color or change some other visual aspect in response to a change in the injury status. An example map is depicted in FIG. 7, described below.

As shown in FIG. 2, emergency communication system 200 may include other types of devices for providing input to the responder servers 204, 206, 208. The other devices may include a dedicated alarm pull device 230 that is installed in a building or facility. The dedicated alarm pull device 230 may resemble a fire alarm or other emergency alert device, but may be designated with an “Active Threat,” “Alert,” or other similar text instead of the traditional “Fire” designation. The alarm pull device 230 may include a pull handle, button, or other user input device that is used to trigger an alert communication or other signal to the responder servers 204, 206, 208. The alarm pull device 230 may be configured to communicate with the network 220 directly using a wired or wireless communication protocol. The alarm pull device 230 may also be configured to communicate with the network 220 via one or more intermediate devices or relay systems.

In some instances, one or more of the responder servers 204, 206, 208 may automatically activate the subscriber mobile devices 202a-c that are located within the geo-fence. The activated devices may provide updated information to each user via a streaming message or dialogue window. Example user interfaces depicting non-limiting example messaging information are provided below with respect to FIGS. 5, 9A-9C, and 11A-11B. The activated devices may also initiate or activate onboard sensors, such as microphones, cameras, or other acquisition devices that can be used to collect environmental data or information. Based on the collected data from activated devices within the geofence, the responder servers 204, 206, 208 may estimate a location or region of potentially violent activity.

In some implementations, one or more of the responder servers 204, 206, 208 may be configured to estimate the location or region of the potentially violent activity based on acoustic or pressure wave signals gathered by one or more subscriber mobile devices 202a-c. For example, a responder server (204, 206, 208) may be configured to identify or estimate the location of an event such as a gunshot or explosion. A gunshot or explosion may produce a shock wave, an acoustic signal, and/or a flash of light. Any one or a combination of which can be detected using the onboard sensors of the subscriber mobile devices 202a-c.

In one example, a responder server (204, 206, 208) may be configured to measure a time differential between an impulse or acoustic signal or shock wave received by two or more devices. Based on the location of the respective devices and the time differential between the received signals, the responder server (204, 206, 208) may be able to triangulate the location of the source of the loud event. Alternative techniques may also be used. For example, the relative intensity of two or more signals may be compared and used to estimate a distance from the event (e.g., the gunshot or explosion). In some cases, an optical sensor (e.g., the camera or light sensor) of the device may be used to measure an amount of emitted light due to the event. The light and, in particular, relative differences between received light from multiple devices may be used to estimate the location or occurrence of the event. In some cases, signals received from the onboard sensors may be used to determine a type of event (e.g., gunshot or explosion) and the source of the event (e.g., type of firearm or type of explosive). Information about the event may be used to update or track the location of potentially violent activity over time.

In some embodiments, each of the responder servers 204, 206, 208 is associated with a different authority or responding organization. For example, responder server 206 may be associated with an emergency medical service or hospital, responder server 208 may be associated with a police or law enforcement agency, and responder server 204 may be associated with an emergency responder service, private institution, or organization having authority to manage emergency communications.

### Subscriber Mobile Devices and Interfaces for Emergencies

FIGS. 3-6 depict a first set of example screens, displays, or user-interface panels in accordance with some embodiments. The screens or displays of FIGS. 3-6 depict selected aspects of an example gesture-based user interface that may be adapted for use in emergency situations. FIGS. 3-6 are provided by way of example only and aspects of the user interface described below may vary or depart from the examples depending on the implementation.

FIG. 3 depicts an example user interface for a device configured to initiate an alert. In particular, FIG. 3 depicts display 300, which includes an initiate-alert region 302. The display 300 may be the initial or one of the initial screens displayed when the application is launched or initiated. Display 300 may allow the user to initiate an alert communication with a responder server. The initiation of an alert communication may be performed in response to a threat or potentially violent activity sensed or otherwise perceived by the user.

As shown in FIG. 3, the initiate-alert region 302 includes a graphical icon. In particular, the graphical icon includes a geometric shape and a brief instruction or other text indicating the action to be performed. Here, the icon includes the text “start alert” indicating that the user may initiate an alert using the user interface.

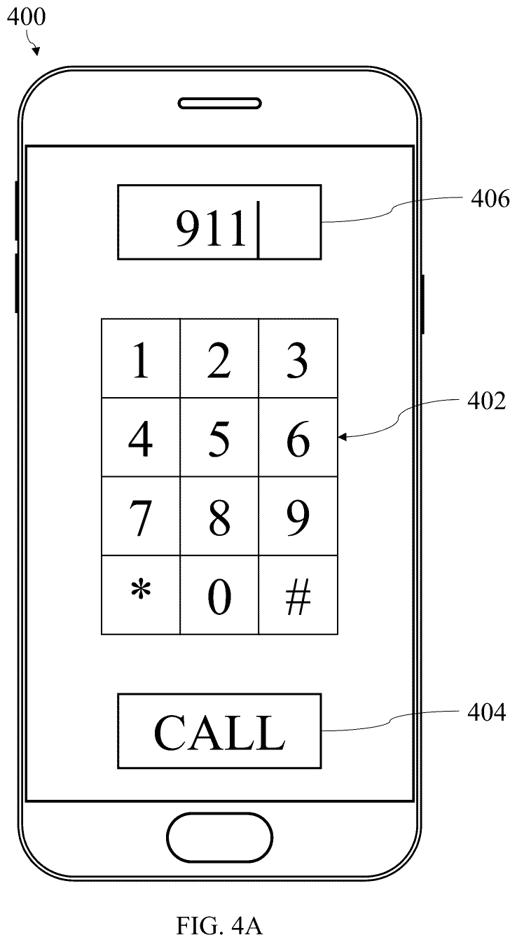

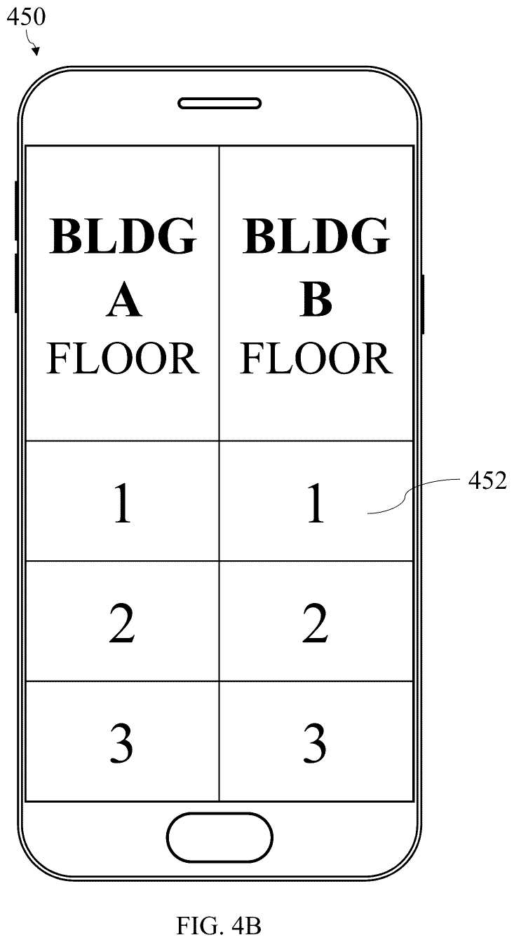

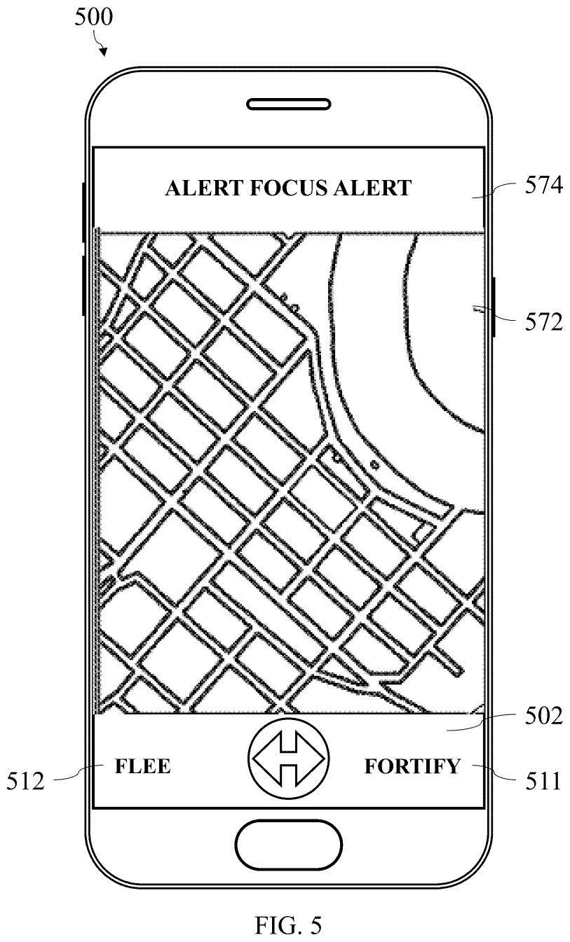

In this example, the user may perform a pre-defined gesture on the display 300 in order to initiate an alert communication and/or an alert communication interface (e.g., as shown in FIG. 4A). The alert communication may be transmitted to a responder server or directly to an emergency responder service, such as 9-1-1, local police department, or another similar emergency service. In some cases, the alert communication is transmitted automatically (e.g., without additional user input or with a user confirmation) or, alternatively, the alert communication may be performed at the direction of the user.

In some cases, the alert communication includes location information that is also transmitted to a responder server and may be based on information determined using a global positioning system or other device-enabled location system or location-determining technique. The location information may be relayed by the response server and/or used to generate a map of device locations (see, e.g., map 700 of FIG. 7).

The predefined gesture may be both simple enough to perform under duress and also not easily mistaken for an accidental or incidental touch on the touch sensor of the device. For example, the predefined gesture may include a swipe-gesture input over the initiate-alert region 302. In some cases, the predefined gesture includes a vertical upward swipe indicated by arrow 310 on FIG. 3. The predefined gesture may also include a vertical downward swipe indicated by arrow 312 on FIG. 3.

The device may be configured to suppress a response or ignore/reject user input that does not correspond to the predefined gesture. For example, touch input other than a vertical swipe gesture may not initiate an alert communication that is transmitted to the responder server. Additionally, a vertical swipe that is not long enough or does not pass over a predefined region (e.g., the initiate-alert region 302) may not initiate an alert communication.

In some embodiments, the device is configured to initiate an alert if the device is located within a predefined geo-fence. This may also prevent inadvertent or accidental alert initiation by the user. By way of example, the device may be configured to determine a location of the device and determine if the location is within a predefined geo-fence. In accordance with a determination that the location is within the geo-fence, the device may be configured to initiate the alert communication in response to receiving the predetermined gesture. In accordance with a determination that the location is not within the geo-fence, the device may prohibit or suppress an initiation of the alert communication in response to receiving the predetermined gesture.

FIG. 4A depicts an example user interface for a device configured to operate an emergency alert interface that can be used to communicate an emergency alert. In particular, FIG. 4A depicts a user-interface display 400 that may be used to initiate, confirm or otherwise facilitate a telephone call to an emergency responder service (e.g., 9-1-1). In the present example, the user-interface display 400 includes a number pad 402 that may be used to dial or enter a telephone number. The user-interface display 400 also includes a number display region 406 that may display the telephone number being entered using, for example, the number pad 402. In some instances, the number display region 406 displays a predetermined telephone number (e.g., 9-1-1) that is automatically entered when the emergency alert interface is initiated. The user-interface display 400 also includes a button 404, which may be used to confirm or initiate the call with the phone number displayed in the number display region 406.

The user-interface display 400 may be initiated automatically in response to the user performing a predetermined gesture on, for example the initiate-alert region 302 depicted in FIG. 3. When the user-interface display 400 is initiated, the telephone number may be automatically populated in the number display region 406. The user may then initiate a call by simply pressing the button 404. The call may be facilitated by one or more responder servers (described above with respect to FIG. 2) or, alternatively, may be conducted using a traditional mobile telephone communication network.

FIG. 4B depicts an example user interface for a device configured to receive location information from the user. In some embodiments, the device may be configured to display a user-interface display 450 including a number pad 452. In response to receiving touch input on the number pad 452 on a particular floor number, the device may communicate the floor number to the responder server. In some cases, the range of floor numbers is limited using the location information (obtained using the global positioning system), which may include altitude information that corresponds to a range of potential floors on which the user may be located. In some implementations, the user may be able to select from additional predetermined location options to help determine and track the location of the user and device within the building or enclosed structure. The floor or other information entered by the user may be combined with a floorplan or building layout in addition with one or more location tracking techniques (e.g., GPS, transmitter/receiver sensing, geo-magnetic sensing, wireless access point) to determine and track the location of the user and device.

FIG. 5 depicts an example user interface for a device configured to relay location and mobility information. In particular, FIG. 5 includes a display 500 having a bifurcated status region 502, a map 572, and an information region 574. In some implementations, the display 500 may include a bifurcated status region 502 and no map 572 and/or no information region 574. The display 500 may be displayed in response to the user initiating an alert in accordance with the example of FIG. 3.

Similar to the example provided above, the display 500 is configured to receive a predetermined gesture in order to transmit or communicate information to the responder server. By using a gesture-based input, accidental or unintentional input may be ignored while also providing a user interface that can be navigated by a user under duress.

In particular, the use of a bifurcated status region 502 may facilitate clear options that can be selected by the user by performing one of two predefined gestures. The bifurcated status region 502, as implemented in the user interface, is configured such that the device will perform one of two options depending on the type of gesture that is performed over the bifurcated status region 502. In some cases, the user interface will suppress a response or ignore user input that does not correspond to one of two predefined gestures.

In the present example, the bifurcated status region 502 includes two areas or ends that indicate a first status 511 and a second status 512. The first status 511 may be “fortify” or “stay” indicating that a user intends to remain in one location. The second status 512 may be to “flee” or “move” indicating that a user intends to change location. By performing a first gesture over the bifurcated status region 502, the device may initiate a status communication associated with the first status 511. The first gesture may be a horizontal swipe that is performed in a direction toward the first end or first area associated with the first status 511. Similarly, by performing a different, second gesture over the bifurcated status region 502, the device may initiate a status communication associated with the second status 512. The second gesture may be a horizontal swipe that is performed in a direction toward the second end or second area associated with the second status 512.

Similar to the previous example, the device may suppress a response or ignore any touch input that does not correspond to one of the two predefined gestures. For example, if the device receives any user input other than a horizontal swipe in either of the above-mentioned directions, the user input may be ignored or a communication with the responder server suppressed.

FIG. 5 also includes other information that may be communicated to the user. For example, the display 500 includes a map 572, which may correspond to a portion of the geo-fence occupied by or surrounding the device 100. The map 572 may be updated in accordance with a change of location of the device. The map may also indicate information including escape routes or first aid stations or locations of other types of assistance. As shown in FIG. 5, an information region 574 may be used to communicate a simple message to the user. For example, the information region 574 may be used to display a scrolling message “alert,” “focus,” “alert.”

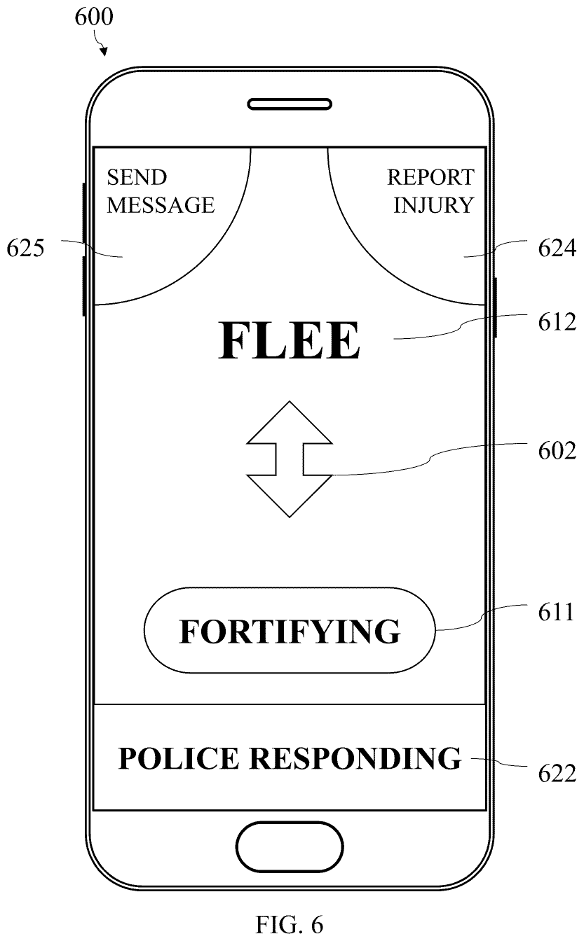

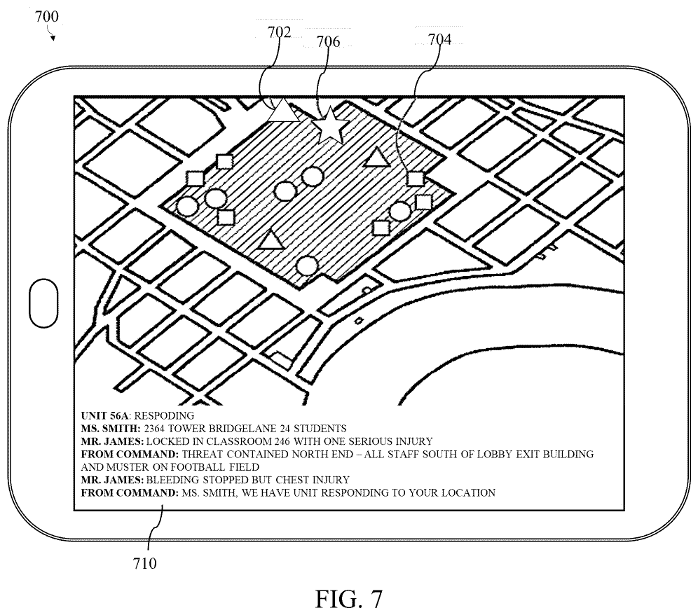

FIG. 6 depicts an example user interface for a device configured to relay a change in location or mobility information. In particular, FIG. 6 depicts a display 600 that is configured to receive additional gesture-based user input. The display 600 may be presented in response to the user selecting the “fortify” or “stay” user option in accordance with the example provided above with respect to FIG. 5. In the event that the user selected the “flee” or “move” user option, a similar but different display can be presented having the flee and fortifying options reversed to those shown in FIG. 6.

Similar to the previous examples, the display 600 may be configured to accept pre-defined gesture input and ignore or reject other touch input in order to prevent inadvertent or accidental communications. The display 600 is also configured to present simple and clear options for the user to update his or her location or mobility information.

In the example of FIG. 6, the display 600 may include an update status region 602. The update status region 602 may include the first user status option in a first area 611 and the second user status option in a second area 612. In response to a first predefined gesture, the device may initiate an updated status communication associated with the first user status option. For example, a vertical swipe-gesture input directed toward the first area 611 may result in an updated status communication that indicates that the user intends to fortify or stay in the same location. In response to a second predefined gesture, the device may initiate an updated status communication associated with the second user status option. For example, a vertical swipe-gesture input directed toward or across the second area 612 may result in an updated status communication that indicates that the user intends to flee or move from his or her current location.

As shown in FIG. 6, one of the two options may be to maintain a current or previous status. In the present example, the previous status was “fortify” or “stay” as indicated with a maintain current status icon displayed in the first area 611. A change status icon is displayed in the second area 612, which in this case corresponds to a changed status of “flee” or “move.”

As shown in FIG. 6, the display 600 may include other information and be configured to receive other non-gesture based input. For example, the display 600 includes a message region 622 that includes an updated message transmitted from the responder server. The display 600 also includes an injury icon 624. In response to receiving a touch input on the injury icon 624, the device may initiate an injury report communication to the responder server. Similarly, a message communication may be initiated in response to receiving touch input on the message icon 625.

FIG. 7 depicts an example map of a region associated with a geo-fence as displayed on a responder server. As discussed previously, the responder server may be configured to determine if a subscriber mobile device is located within a predefined geo-fence. FIG. 7 depicts an example map 700 indicating the relative position of each subscriber mobile device located within the geo-fence. The locations of each subscriber mobile device may be represented by an icon 702, 704 having a map location that corresponds to the location of the subscriber mobile device. The estimated location of a potential threat or potentially violent activity may be represented by icon 706. The estimated location of the potential threat or potentially violent activity may be determined using one or more sensors (located within the subscriber mobile devices or within the building) or may be determined based on input from the users or other persons witnessing activity within the building.

In some embodiments, the colors of the icons 702, 704 may change color in response to a change in status of the associated user. For purposes of illustration, the icons depicted in FIG. 7 having different colors are represented by different shapes (e.g., squares, circles, stars). Depending on the implementation, the icons may be color-coded, shape-coded, color- and shape-coded, or otherwise visually distinguished from each other.

The visual coding may be used to provide a simple overview of the status of the various users within the geo-fence. For example, the responder server may receive an indication of the user's mobility (e.g., that the user intends to remain in one place or move). In accordance with a change in the status of the user's mobility, the color/shape of the corresponding icon 702, 704 may change. Similarly, the responder server may receive an update regarding an injury status of the user, and a change in injury status may also be indicated by a change in color/shape of the corresponding icon 702, 704.

As shown in FIG. 7, the responder server user interface may also include a message dialogue region 710 located adjacent to the map 700. The message dialogue region 710 may be used to type messages to be transmitted to the various subscriber mobile devices. The message dialogue region 710 may also display messages received from the subscriber mobile devices and/or other entities. In some cases, the message dialogue region 710 displays messages received from law enforcement or other emergency response personnel.

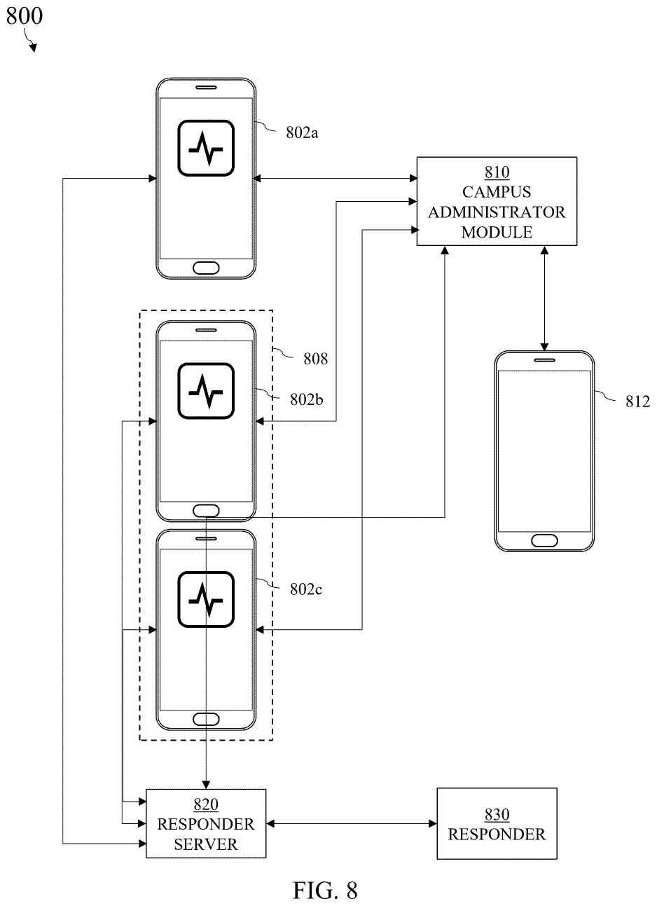

FIGS. 8-11B depict example systems and user interfaces for a distributed alert system in accordance with some embodiments. The distributed alert systems of the following examples may be implemented using the device hardware and systems described above with respect to FIGS. 1 and 2. In some implementations, the distributed alert systems are implemented using a different app or software program installed on a subscriber mobile device. Alternatively, the functionality of the distributed alert systems may be integrated or incorporated with the example system described above with respect to FIGS. 3-7.

### Distributed Alert Systems for Emergencies

FIG. 8 depicts an example system for a first type of distributed alert system. In particular, FIG. 8 depicts a distributed alert system 800 that may be implemented on a university, campus, or other organization that includes one or multiple buildings or a variety of locations. In some instances, the distributed alert system 800 may be a simplified notification system that is configured to operate independent of the functionality described above with respect to FIGS. 3-7.

The distributed alert system 800 may include a set of subscriber mobile devices 802a-802c having an app or software program installed for providing the functionality and user interfaces described herein. The subscriber mobile devices 802a-802c may be the personal mobile phones or personal computing devices owned by the students, employees, or other members of an organization. The subscriber mobile devices 802a-802c may be configured to communicate, using the app or software program, with a campus administrator module 810 and a responder server 820. Similar to the examples provided above with respect to FIG. 2, the subscriber mobile devices 802a-802c may be configured to perform wireless communication with the responder server 820 and the campus administrator module 810 using a wireless or cellular communication network.

In the present example, the campus administrator module 810 may include a server having a corresponding app or software program configured to facilitate the communications in accordance with the distributed alert system 800. The campus administrator module 810 may be operated by the university, school, employer, or other administrator of an organization. Access to the campus administrator module 810 may be restricted and/or monitored to reduce the incidence of false alarms or incorrect information being propagated through the distributed alert system 800. In some cases, aspects of the campus administrator module 810 may be controlled by a mobile or personal electronic device 812 operated by an authorized user.

As shown in FIG. 8, the distributed alert system 800 also includes a responder server 820, which may be implemented on a server system consistent with the embodiments described above with respect to FIG. 2. In particular, the responder server 820 may be configured to define or identify a geo-fence or region associated with a geographic organization. The geo-fence or region may correspond to a building or group of buildings associated with a campus or organization. The geo-fence or region may also correspond to a region surrounding a location of an incident or activity. The responder server 820 may also include information about the floorplan or layout of individual buildings, which may be used to locate subscriber mobile devices 802a-802c within a particular building or structure.

A single responder server 820 may be used to communicate with multiple organizations, each having a campus administrator module or similar server. The responder server 820 may also be configured to facilitate communication to an external entity like a responder 830 or commander, which may include a local fire department, police department, emergency medical service, or other type of responder organization. In some cases, the responder 830 is an emergency responder service associated with an emergency telephone number like 9-1-1.

In some embodiments, the distributed alert system 800 is configured to relay location information and key updates to the subscriber mobile devices 802a-802c associated with the campus, business, or organization. The distributed alert system 800 may be configured to provide essential information in an emergency situation and provide users a single or consolidated access point for communicating with authorities or responders. The distributed alert system 800 may also be configured to collect key information from users, which may facilitate an emergency response effort.

In an example implementation, the distributed alert system 800 may be implemented on a school or university campus. The subscriber mobile devices 802a-802c may be operated by students, teachers, or employees of the school or university in accordance with an emergency preparedness plan and configured to alert the appropriate users of a potential threat or incident. The campus administrator module 810 may be operated by or through a campus police department or security group that is associated with the school or university.

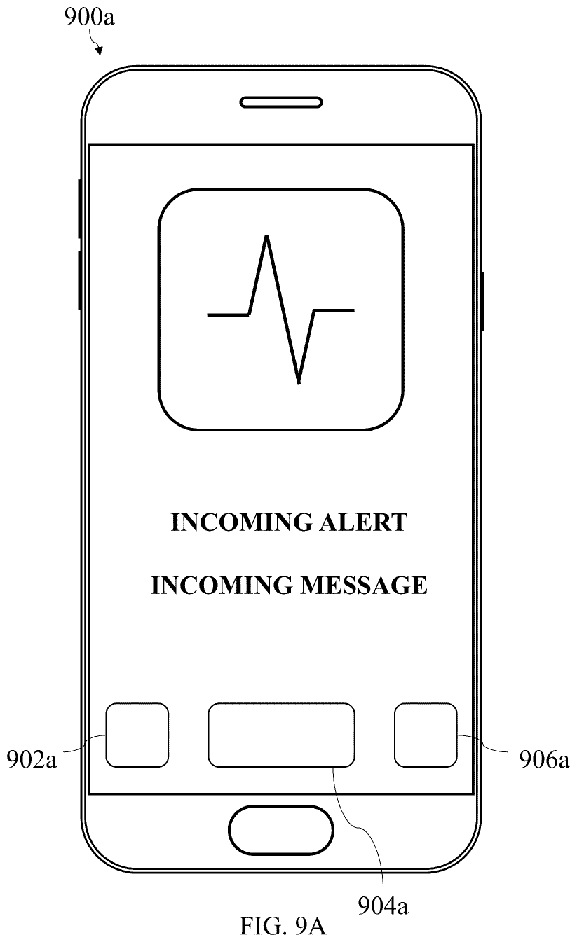

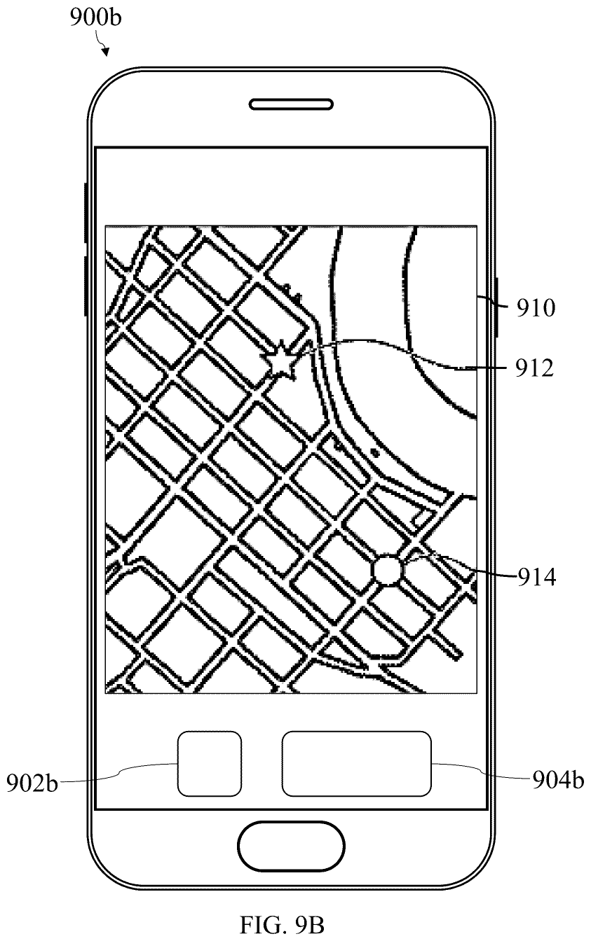

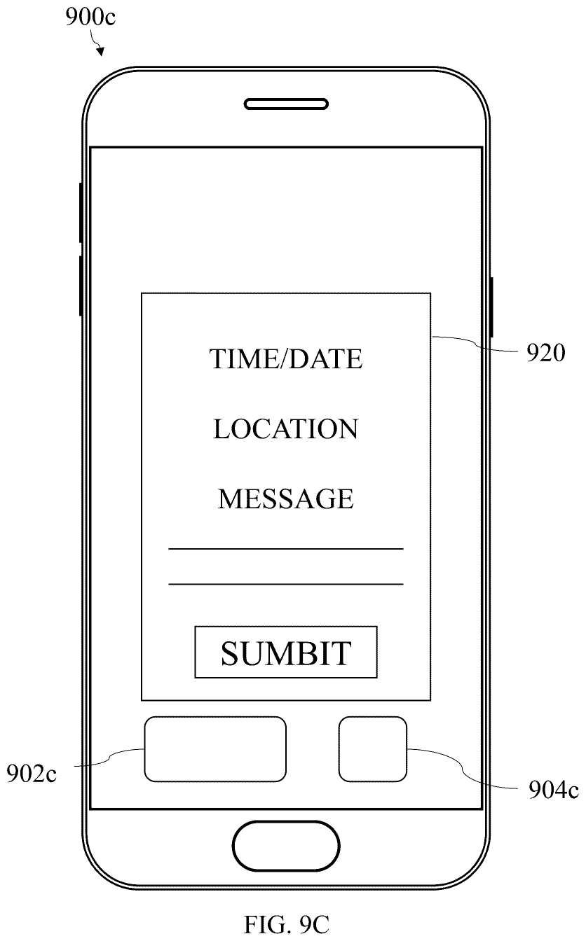

In one example, an alert communication may be initiated by the school or university using the campus administrator module 810. The alert communication may be associated with an incident location, which is an estimated location of a threat or potentially violent activity. In some cases, the campus administrator module 810, alone or in conjunction with the responder server 820, may be configured to identify a set of users that is located within a region 808 proximate to the incident location. The set of users within the region 808 may, for example, include students and teachers in a building in which the incident location has been identified. The alert communication may initiate or launch the app or software program on each subscriber mobile device 802b-802c within the region 808. The alert communication may include basic information about the type of alert and initial instructions like evacuate or remain in place. The alert communication may also include location information about incident location. Example user interfaces or screens displayed during an emergency alert are described below with respect to FIGS. 9A-9C.

After initiating the alert, the subscriber mobile devices 802b-802c may communicate with a responder server 820 either directly or through the campus administrator module 810. Information about the location of the subscriber mobile devices 802b-802c or data collected from the subscriber mobile devices 802b-802c may be related or sent directly to the responder server 820. Some or all of this information may be relayed to the responder 830 and used to provide emergency assistance.

The campus administrator module 810 may also be configured to transmit messages or an alert communications to other subscriber mobile devices 802a that fall outside of the region 808. The alert communications sent to the other subscriber mobile devices 802a may be different than the alert communications sent to the subscriber mobile devices 802b-802c located within the region 808. For example, the alert communications transmitted to the other subscriber mobile devices 802a may omit incident location information or may provide different instructions or guidance.

FIGS. 9A-9C depict example user interfaces for a first type of distributed alert system. FIGS. 9A-9C may be displayed, for example, in response to an alert communication transmitted by a campus administrator module (e.g., module 810 of FIG. 8). As mentioned previously, an initial alert communication may launch the app or software program on selected subscriber mobile devices that are associated with a particular location or region.

FIG. 9A depicts an example screen, display, or user interface that may correspond to a home screen once an alert communication has been received. In particular, display 900a includes an initial message or communication and may also include a graphical element or symbol. The message or communication may include instructions or guidance for handling an emergency situation. The message or communication may be updated as subsequent alert messages are received by the device.

As shown in FIG. 9A, the display 900a also includes various selectable options or virtual button objects that may be used to trigger other functionality. In one example, a first button 902a may trigger a telephone call to authorities. For example, the button 902a may initiate a 9-1-1 call, which may be facilitated through the user's cellular communication network or through communication with a responder server, in accordance with some embodiments. A second button 904a may be used to acknowledge the receipt of the communication. The acknowledgement may be transmitted to either or both the campus administrator module or a responder server. In some instances, the second button 904a may initiate a map display (e.g., map display 900b of FIG. 9B). The display 900a may also include a third button 906a that initiates a report display (e.g., report display 900c of FIG. 9C) used to provide information about an event or incident. Depending on the implementation, additional buttons or functionality may also be included in display 900a.

FIG. 9B depicts a map display 900b for providing location information to a user. In the present example, the map display 900b includes an image or graphical representation of a map 910 that may correspond to a user's location or building. The map 910 may be updated in accordance with a change of location of the device. The map 910 may also indicate information including escape routes or first aid stations or locations of other types of assistance. The map 910 may also include an icon 912 that represents an incident location, which may have been transmitted to the device by a campus administrator module or a responder server. The map 910 may also include an icon 914 that corresponds to the current location of the device and user. The map display 900b may be useful in navigating away from a threat or planning a course of action.

As shown in FIG. 9B, the map display 900b may also include a first button 902A that may trigger a telephone call to authorities. For example, the first button 902b may initiate a 9-1-1 call similar to the example described above. The map display 900b may also include a second button 904b, which may return the user to a display showing incoming messages, similar to the display 900a described above with respect to FIG. 9A.

FIG. 9C depicts a report display 900c that may be used to provide information about an event or incident. The report display 900c may be used to provide anonymous tips regarding suspicious occurrences or persons to authorities or a campus resource. As shown in FIG. 9C, the report may have a window 920 that includes a time, date, and location associated with the report. The window 920 may also provide a field or the ability to record a message about the incident or event. In some cases, a soft keyboard may be used to enter text or the user may record a message using the microphone of the device. The user may submit the report either anonymously or with personal information about the user. The information associated with the report may be transmitted to authorities via a responder server and/or to a campus resource through a campus administrator module.

As shown in FIG. 9C, the display 900c also includes a first button 902c that may be used to initiate a telephone call to authorities. For example, the first button 902c may initiate a 9-1-1 call similar to the examples described above. The report display 900c may also include a second button 904c, which may return the user to a display showing incoming messages, similar to the display 900a described above with respect to FIG. 9A.

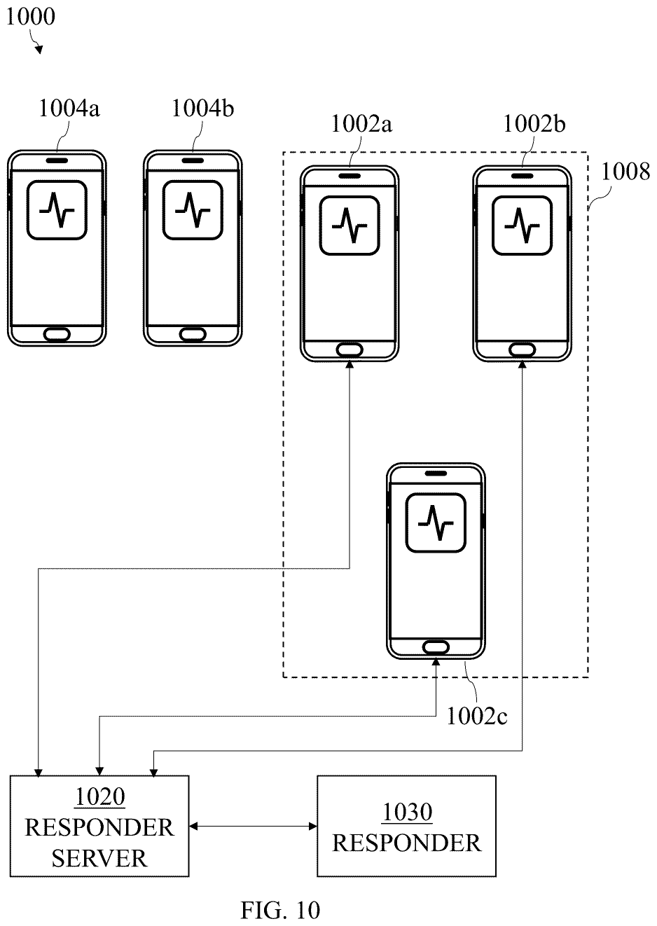

FIG. 10 depicts an example system for a second type of distributed alert system. In particular, FIG. 10 depicts a distributed alert system 1000 that may be implemented across a range of locations for users that are associated with one or more organizations that are equipped to implement the distributed alert system 1000. In some instances, the distributed alert system 1000 may be a simplified notification system that is configured to operate independent of the functionality described above with respect to FIGS. 3-7.

The distributed alert system 1000 may include a set of subscriber mobile devices 1002a-1002c and 1004a-1004b having an app or software program installed for providing the functionality and user interfaces described herein. The subscriber mobile devices 1002a-1002c and 1004a-1004b may be the personal mobile phones or personal computing devices owned by respective users. The subscriber mobile devices 1002a-1002c and 1004a-1004b may be configured to communicate, using the app or software program, with a responder server 820 similar to the other examples provided above.

As shown in FIG. 10, the distributed alert system 1000 includes a responder server 1020, which may be implemented on a server system consistent with the embodiments described above with respect to FIG. 2. In particular, the responder server 1020 may be configured to define or identify a geo-fence or region associated with a geographic organization. The geo-fence or region may correspond to a building or group of buildings associated with a particular organization. The geo-fence or region may also correspond to a region surrounding a location of an incident or activity. The responder server 1020 may also include information about the floorplan or layout of individual buildings, which may be used to locate subscriber mobile devices 1002a-1002c within a particular building or structure.

Similar to other examples, a single responder server 1020 may be used to communicate with multiple organizations, each having a campus administrator module or similar server. The responder server 1020 may also be configured to facilitate communication to an external entity like a responder 1030, which may include a local fire department, police department, emergency medical service, or other type of responder organization. In some cases, the responder 1030 is an emergency responder service associated with an emergency telephone number like 9-1-1.

In some embodiments, the distributed alert system 1000 is configured to relay location information and key updates to both a first group of subscriber mobile devices 1002a-1002c associated with a location or region 1008 and a second group of subscriber mobile devices 1004a-1004b outside of the location or region 1008. The distributed alert system 1000 may be configured to provide essential information in an emergency situation and provide users a single or consolidated access point for communicating with authorities or responders. The distributed alert system 1000 may also be configured to collect key information from users, which may facilitate an emergency response effort.

In an example implementation, the distributed alert system 1000 may be implemented over a wide region such as a town or portion of a metropolitan area and configured to coordinate with users that are within a geo-fence of a company or organization that is able to facilitate communications through the distributed alert system 1000. In some cases, the company or organization is a subscriber to a related emergency preparedness service.

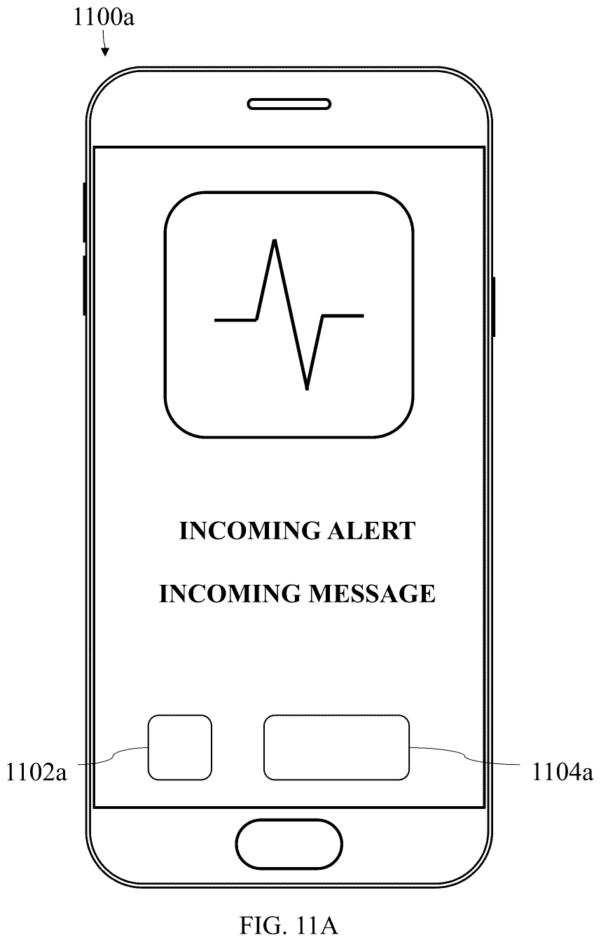

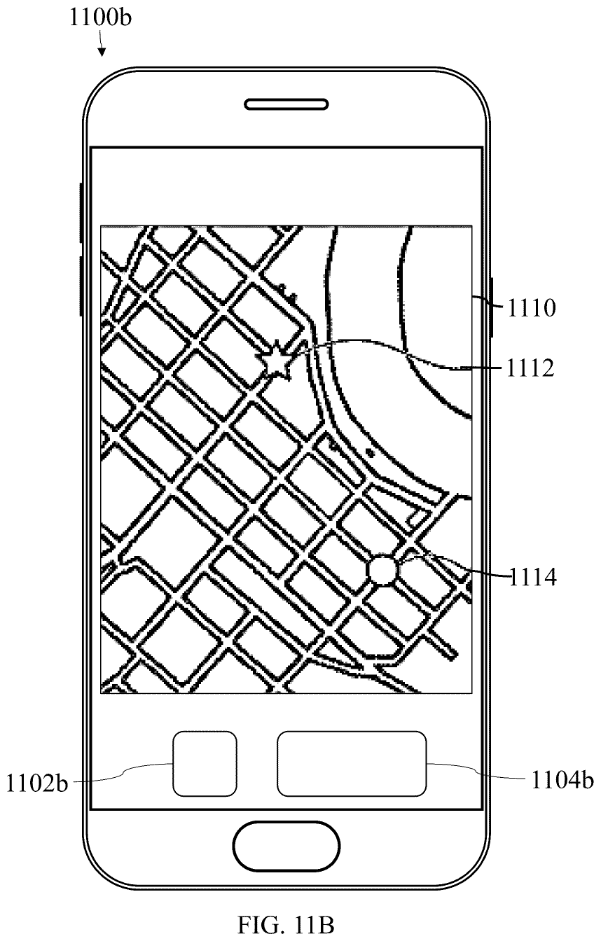

In one example, an alert communication may be initiated by the responder server 1020. The alert communication may be initiated in response to a report provided by a mobile subscriber device, a police call, or other type of initiating event. In some cases, the alert communication is associated with an incident location, which is an estimated location of a threat or potentially violent activity. In some cases, the responder server 820, may be configured to identify a set of users that is located within a region 1008 proximate to the incident location. The set of users having mobile subscriber devices 1002a-1002c within the region 1008 may, for example, include those users located within in a building or region in which the incident location has been identified. The alert communication may initiate or launch the app or software program on each subscriber mobile device 1002a-1002c within the region 1008. The alert communication may include basic information about the type of alert and initial instructions like evacuate or remain in place. The alert communication may also include location information about incident location. Example user interfaces or screens displayed during an emergency alert are described below with respect to FIGS. 11A-11B.

After initiating the alert, the subscriber mobile devices 1002a-1002c may communicate with the responder server 1020 either directly or through an intermediate server or module. Information about the location of the subscriber mobile devices 1002a-1002c or data collected from the subscriber mobile devices 1002a-1002c may be related or sent directly to the responder server 1020. Some or all of this information may be related to the responder 1030 and used to provide emergency assistance.

The responder server 1020 may also be configured to transmit global messages or alert communications to other subscriber mobile devices 1004a-1004b that fall outside of the region 1008. The alert communications sent to the other subscriber mobile devices 1004a-1004b may be different than the alert communications sent to the subscriber mobile devices 1002a-1002c located within the region 1008. For example, the alert communications transmitted to the other subscriber mobile devices 1004a-1004b may omit incident location information or may provide different instructions or guidance.

FIGS. 11A-11B depict example user interfaces for a second type of distributed alert system. FIGS. 11A-11B may be displayed, for example, in response to an alert communication transmitted by a server (e.g., responder server 1020 of FIG. 10). As mentioned previously, an initial alert communication may launch the app or software program on selected subscriber mobile devices that are associated with a particular location or region.

FIG. 11A depicts an example screen, display, or user interface that may correspond to a home screen once an alert communication has been received. In particular, display 1100a includes an initial message or communication and may also include a graphical element or symbol. The message or communication may include instructions or guidance for handling an emergency situation. The message or communication may be updated as subsequent alert messages are received by the device.

As shown in FIG. 11A, the display 1100a also includes various selectable options or virtual button objects that may be used to trigger other functionality. In one example, a first button 1102a may trigger a telephone call to authorities. For example, the button 1102a may initiate a 9-1-1 call, which may be facilitated through the user's cellular communication network or through communication with a responder server, in accordance with some embodiments. A second button 1104a may be used to acknowledge the receipt of the communication. The acknowledgement may be transmitted to a responder server or other server or station. In some instances, the second button 1104a may initiate a map display (e.g., map display 1100b of FIG. 11B).

FIG. 11B depicts a map display 1100b for providing location information to a user. In the present example, the map display 1100b includes an image or graphical representation of a map 1110 that may correspond to a user's location or building. Similar to the previous example, the map 1110 may be updated in accordance with a change of location of the device. The map 1110 may also indicate information including escape routes or first aid stations or locations of other types of assistance. The map 1100 may also include an icon 1112 that represents an incident location, which may have been transmitted to the device by the responder server. The map 1110 may also include an icon 1114 that corresponds to the current location of the device and user. The map display 1100b may be useful in navigating away from a threat or planning a course of action.

As shown in FIG. 11B, the map display 1100A may also include a first button 1102b that may trigger a telephone call to authorities. For example, the button 1102b may initiate a 9-1-1 call similar to the example described above. The map display 1100b may also include a second button 1104b, which may return the user to a display showing incoming messages, similar to the display 1100a described above with respect to FIG. 11A.

### Methods and Systems for Emergencies

Described herein are methods for determining at least one action in an emergency. In an aspect, a method can include (a) receiving a set of user data associated with one or more users; (b) receiving a set of responder data associated with one or more responders; (c) processing, via a trained machine learning model, the set of user data or the set of responder data to generate the at least one action; and (d) transmitting the at least one action to one or more commanders, wherein the one or more commanders direct the one or more users or the one or more responders to perform the at least one action during the emergency. In some cases, methods may be performed on subscriber mobile devices described herein previously. In some cases, methods may be performed on subscriber mobile devices described herein below. In some cases, methods may be performed on subscriber mobile devices described herein previously or herein below.

In some embodiments, the method occurs in a mode comprising an actual emergency mode or a training emergency mode. For example, the distributed alert system of subscriber mobile devices may be configured to implement methods described herein upon generation of an alert communication by a user, a responder, or a commander. The alert communication may be in response to an actual emergency, e.g., an active threat. In some cases, all features associated with subscriber mobile devices of the distributed alert system can be functional to eliminate or mitigate the actual or active threat. For example, the distributed alert system may be configured to implement methods described herein upon generation of a training alert communication by a user, a responder, or a commander. The training alert communication may be in response to or associated with training users, training responders, or training commanders to use systems and methods describe herein. In some cases, a subset of features associated with subscriber mobile devices of the distributed alert system can be functional to train users, responders, or commanders for eliminating or mitigating virtual threats. In some embodiments, the emergency is associated with one or more active threats on a same or different campus, workplace, or commercial establishment.

### Methods Associated With Subscriber Mobile Devices

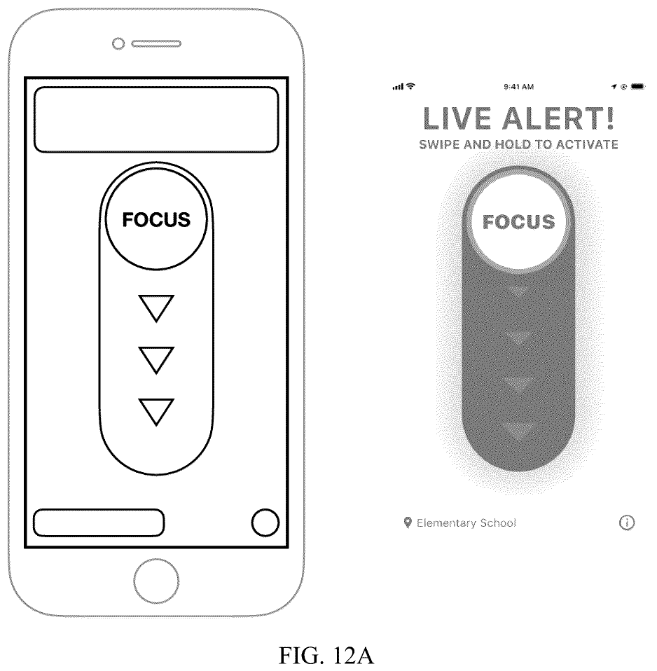

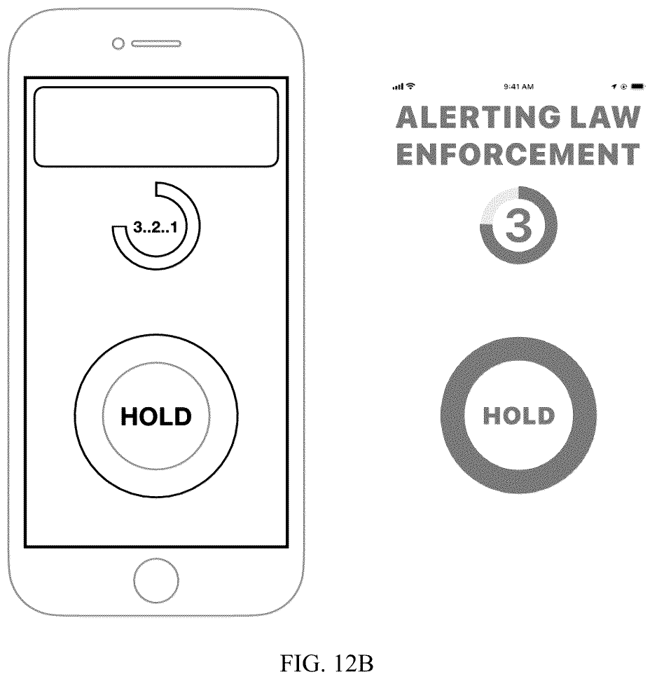

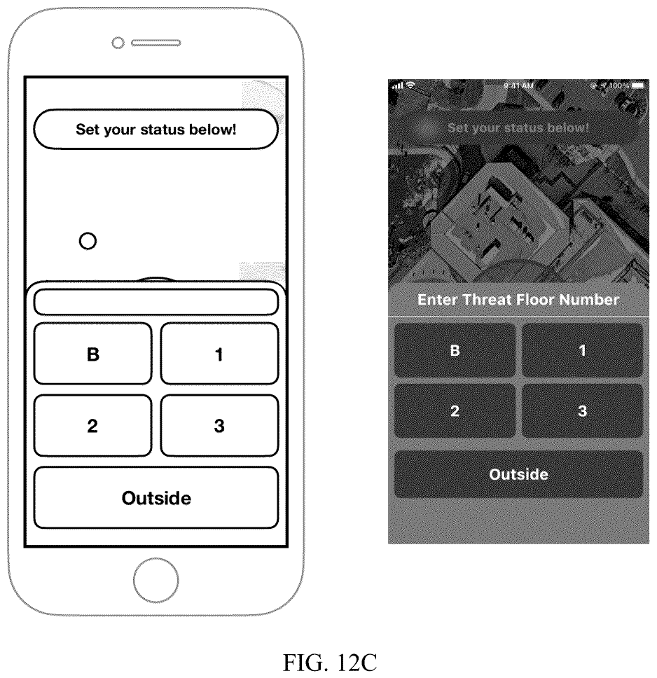

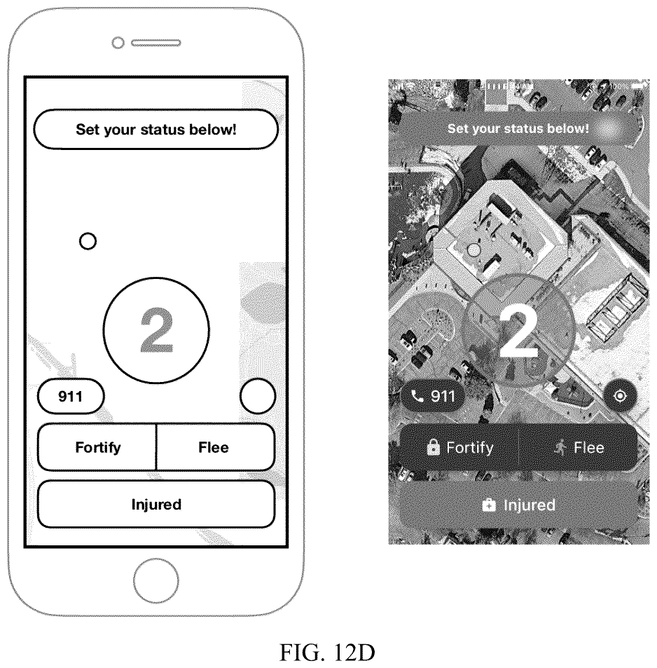

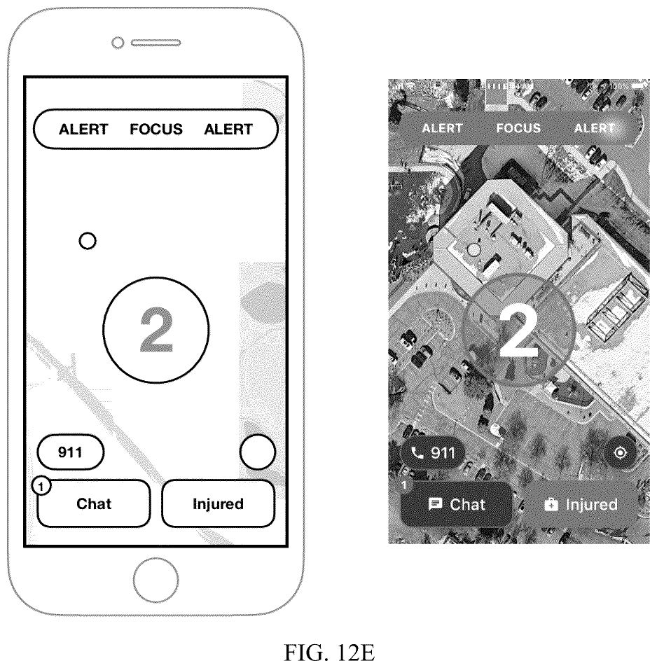

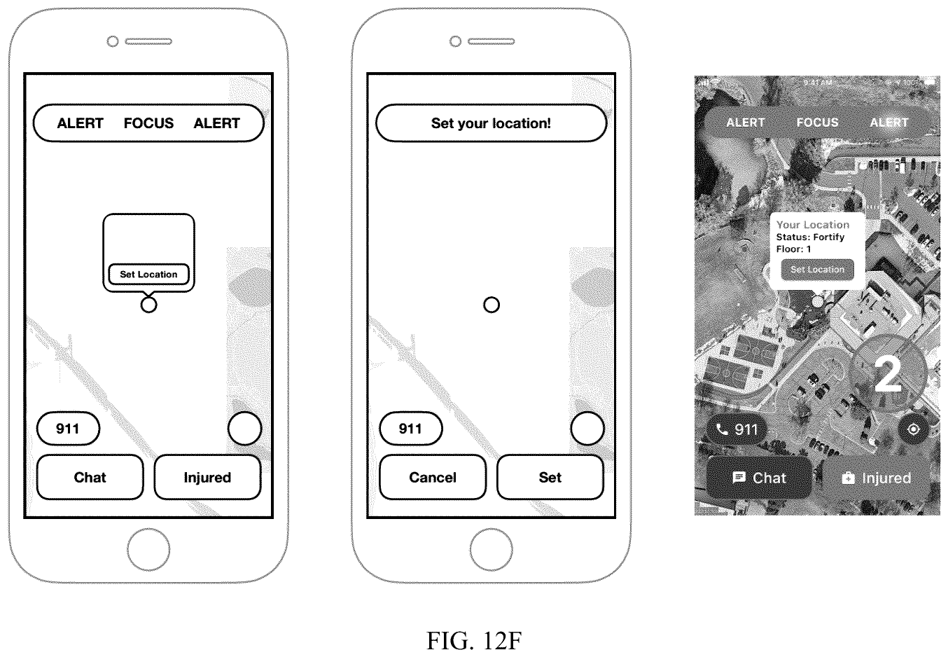

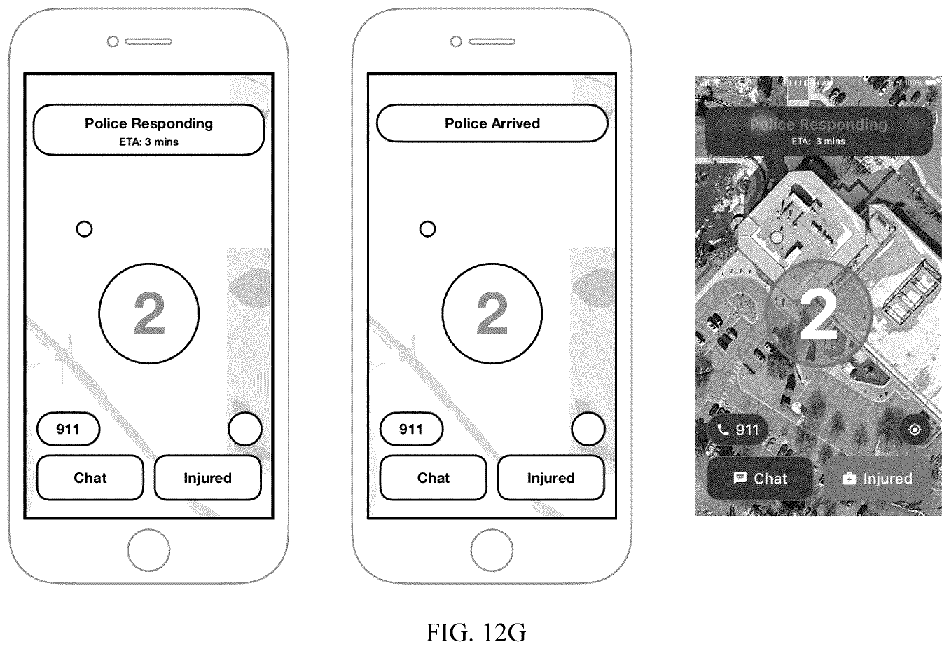

In some embodiments, the at least one action associated with the one or more users comprise user communication actions, fortify actions, flee actions, injury actions, or user status actions. In some cases, users may be associated with subscriber mobile devices, e.g., user devices illustrated in FIGS. 12A-12G. User devices can be configured to be in communication with other subscriber mobile devices via distributed alert systems described elsewhere herein. In some embodiments, before the at least one action is transmitted to the one or more commanders, the at least one action is transmitted to the one or more users to perform during the emergency. Users can include, for example, students, teachers, employees, or other members of an organization associated with or otherwise affected by emergencies. In some embodiments, the one or more users transmit the set of user data to the one or more responders, the one or more commanders, or at least another user of the one or more users. In some embodiments, the one or more users receive the set of responder data from the one or more responders or a set of commander data from the one or more commanders. User devices can be configured to generate, receive, or transmit user data via distributed alert systems, e.g., alert communications or other communications. In some embodiments, the set of user data comprises user communications data, user status data, or user location data.

FIGS. 12A-12B depict an example user interface for a user device configured to generate, receive, or transmit data. In particular, FIG. 12A depicts a user interface, which includes an initiate-alert feature implemented in an initiate-alert region. The initiate-alert region may be the initial or one of the initial interfaces displayed when the user interface is launched or initiated. The initiate-alert region may allow the user to initiate an alert communication with, e.g., responders or commanders, via the distributed alert system. The initiation of an alert communication may be performed in response to an active threat or potentially violent activity sensed or otherwise perceived by the user.

As with FIG. 3 described elsewhere herein and illustrated in FIG. 12A, the user interface for a user device can be configured to allow a user to initiate an alert communication via an initiate-alert feature implemented in an initiate-alert region. The initiate-alert region may include a graphical or textual feature to initiate an alert communication, e.g., “start alert.” Additionally, the user interface may include a user location feature as illustrated in FIG. 12A. For example, the user location feature may display the user's location, e.g., a geo-fence associated with the user at an elementary school. Additionally, the user interface may include an account feature as illustrated in FIG. 12A. For example, the account feature may allow a user to access the user's account information, sign out of the user's account, or delete the user's account. Additionally, upon starting an alert communication, the user interface may include an alert confirmation feature implemented in an alert confirmation region as illustrated in FIG. 12B. For example, the alert confirmation feature can be a countdown timer indicating how much longer a user may hold the “FOCUS” slider to successfully activate an alert communication. In some cases, the countdown timer may require at least 0.1, 0.5, 1, 2, 3, or more seconds to start an alert communication. The alert confirmation feature may graphically or textually warn the user that starting an alert communication will alert responders or commanders, e.g., police or law enforcement agencies, emergency responder services, private institutions, or organizations having authority (e.g., authenticated or trusted) to respond or command in emergencies.

As with FIG. 4A described elsewhere herein and illustrated in FIG. 12C, the user interface for a user device can be configured to receive location information from the user via a floor number feature implemented in a floor number region. Alternatively or additionally, the user device can be configured to automatically determine location, e.g., a floor number, for the user. Additionally, the user may select a location that is not associated with a floor number. For example, the user can select that the user is “outside” of a building. For example, the user can select that the user is located in a basement (“B”) of a building. In some cases, selection or automatic determination of location, e.g., floor number, outside, or basement, can be a location associated with an active threat. In some cases, if the user's location is a building with a single floor level, the floor number feature can be bypassed or skipped. Additionally to FIG. 4A, if the system is operating in a training emergency mode instead of an actual emergency mode, the user may be prompted to enter a training phone number that can be configured prior to activation of the training emergency mode.

As with FIG. 5 described elsewhere herein and illustrated in FIG. 12D, the user interface for a user device can be configured to allow a user to set the user's status via a status feature implemented in a status region. The status region can be configured to allow a user to select the user's status. For example, the user can select a status of “injured” in addition to “fortify” or “flee.” Each status may be graphically or textually depicted on a map with a symbol. For example, a different colored or shaped or sized symbol may be associated with each user status and located on the map at the user's location. In some cases, the symbol may change, e.g., a different color, different shape, or different size, when the user's status is updated. For example, the threat zone symbol (or threat location indicator) associated with an active threat may be updated to a red shaded circle when prescribed events occur. For example, a user may use the chat feature to communicate “shooter at my door.” Natural language processing (NLP) herein may be used to process the communication to aid in determining or predicting actions during emergencies. The threat zone symbol can be updated to an area near the location where the user communicated the message. In some cases, the threat location indicator can be displayed differently to users depending on the mechanism for the alert. For example, the threat location indicator can be a red shaded circle if an alert is triggered by a person. The threat location indicator can be a gray shaded square if an alert is triggered by an automated process, e.g., using machine learning to process data generated by cameras to determine an active threat. Additionally, the status feature may graphically or textually depict an approximate location of an active threat on a map. For example, the approximate location of the active threat may be depicted by a semi-transparent circle inscribed within the threat floor number. Additionally, status feature may provide a calling feature to communicate with responders or commanders. For example, the calling feature can include an ability for the user to call 9-1-1. Additionally, the status feature may provide a location selection feature to select the user's current location. For example, the user may select a location symbol to center the map on the user's location.

As with FIG. 6 described elsewhere herein and illustrated in FIGS. 12E-12G, the user interface for a user device can be configured to allow a user to update the user's status via an update status feature implemented in an update status region. Additionally, the update status feature may provide a communication feature (e.g., a chat messaging feature implemented in the status region as a chat button and chat window) configured to allow the user to chat with other users, responders, or commanders. Upon selecting the chat button, a new chat window can open along with a virtual or soft keyboard to allow the user to input messages to transmit to other users, responders, or commanders. The chat messaging feature can include an indication of new chat messages received by the user device from other users, responders, or commanders. For example, the indication can include a circular badge symbol that appears near or on the chat button indicating a number of unread chat messages. The chat messaging feature can allow communications between one and all (one-to-many) subscriber mobile devices, between all and one (many-to-one) subscriber mobile devices, between one and a subset of all subscriber mobile devices, or between subset of all subscriber mobile devices and one. As described elsewhere herein, natural language processing (NLP) may be used to process the communications to aid in determining or predicting actions during emergencies.

Additionally, the update status feature may be configured to allow the user to change the user's status via an injured button. For example, the user may select a status of injured upon sustaining a previously unreported injury. Upon selecting the injured button, a graphical or textual confirmation prompt (e.g., “yes” or “no”) can appear prompting the user to confirm the new status. Upon setting the user's status to injured, the user can be prompted to enter the user's location, e.g., floor number, outside, or basement. Setting the user's status to injured may change the status symbol associated with the user (e.g., red symbol for injured) and transmit the user's status to other users, responders or commanders. Additionally, the update status feature may provide a calling feature to communicate with responders or commanders. For example, the calling feature can provide an ability for the user to call 9-1-1.

Additionally, the update status feature may provide a location feature configured to allow a user to manually set the user's location on a map. For example, the user can select a location symbol representing the user's location on the map. Selecting the location symbol may open a graphical or textual dialogue confirming the user desires to select a new location. The user may move the map around underneath the location symbol. The user can confirm the new location by selecting a graphical or textual button, e.g., “set.” The user device can transmit the new location to other users, responders, or commanders. Alternatively, the user can cancel the new location by selecting a graphical or textual button, e.g., “cancel”, to return the location symbol to the previous location on the map. A graphical or textual button can allow the user to turn on automatic location tracking, e.g., “auto-locate”, by selecting the user's location symbol.

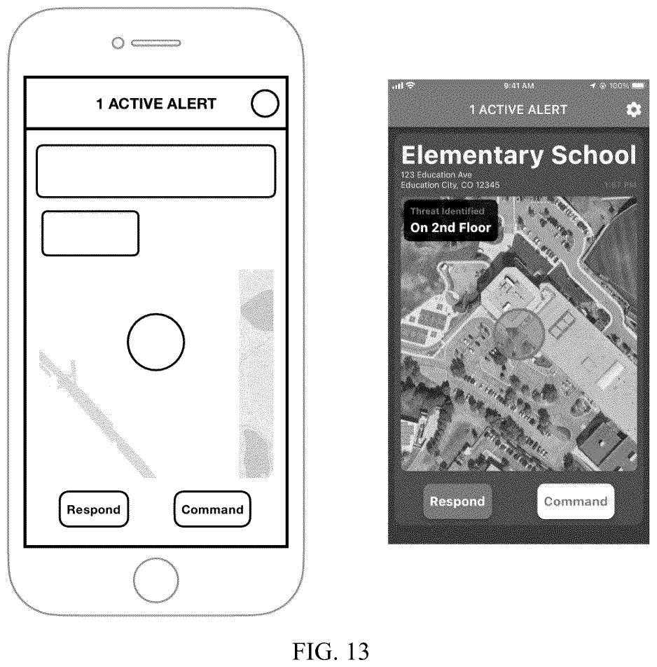

In some embodiments, the at least one action associated with the one or more responders comprises responder communication actions, respond actions, command actions, or responder status actions. In some cases, responders may be associated with subscriber mobile devices, e.g., responder devices illustrated in FIG. 13. Responder devices can be configured to be in communication with other subscriber mobile devices via distributed alert systems described elsewhere herein. In some embodiments, before the at least one action is transmitted to the one or more commanders, the at least one action is transmitted to the one or more responders to perform during the emergency. Responders can include, for example, emergency medical services or hospitals, police or law enforcement agencies, emergency responder services, private institutions, or organizations having authority (e.g., authenticated or trusted) to respond to emergencies. In some embodiments, the one or more responders transmit the set of responder data to the one or more users, the one or more commanders, or at least another responder of the one or more responders. In some embodiments, the one or more users receive the set of responder data from the one or more responders or a set of commander data from the one or more commanders. The responder devices can be configured to generate, receive, or transmit data via distributed alert systems, e.g., alert communications or other communications.

In some embodiments, the set of responder data comprises responder communications data, responder status data, responder location data, or responder navigation data. A responder interface for a responder device can be configured to allow a responder to respond to an alert communication via an alert preview feature implemented in an alert preview region. The alert preview region may include graphical or textual button to select a responder status, e.g., “respond” or “command.” For example, upon receiving an alert communication, the responder may choose to respond to the alert communication by selecting a responder status of “respond.” In this case, the responder may respond to eliminate or mitigate the actual or active threat. Alternatively, upon receiving an alert communication, the responder may choose to respond to the alert communication by selecting a responder status of “command.” In this case, the responder will assume a role of commander and direct users, responders, or other commanders to eliminate or mitigate the actual or active threat. The responder interface may be configured with an authentication feature requiring the responder to enter an authentication code before assignment of the commander role. In some cases, the responder device may receive more than one alert communication. The responder may preview each alert communication and choose to respond or command to one or more alert communications.

Additionally, the responder interface for a responder device can be configured with a responder navigation feature to provide navigation during emergencies via a responder navigation region, e.g., navigation to an active threat. For example, upon choosing to respond to the active threat, the responder navigation region may graphically or textually provide turn-by-turn navigation to the active threat. In some cases, the turn-by-turn navigation may be provided by a separate navigation application installed on the responder device, e.g., Google® Maps.

Additionally, the responder interface for a responder device can be configured with a responder preview feature to allow a responder to receive and display information associated with an alert communication via a responder preview region. Information can include, for example, name and address of the alerting facility, time the alert communication was activated, a map depicting an approximate location of the threat, or a floor number of the threat. Additionally, the responder interface can be configured with a responder account feature to allow a responder to access account information via a responder account region. For example, the responder account feature may allow a responder to access the responder's account information, sign out of the responder's account, or delete the responder's account.

Additionally, the responder interface for a responder device can be configured with a communications feature implemented in a communications region (e.g., a chat messaging feature in a chat messaging region). The chat messaging feature can allow communications between one and all (one-to-many) subscriber mobile devices, between all and one (many-to-one) subscriber mobile devices, between one and a subset of all subscriber mobile devices, or between subset of all subscriber mobile devices and one. As described elsewhere herein, natural language processing (NLP) may be used to process the communications to aid in determining or predicting actions during emergencies.

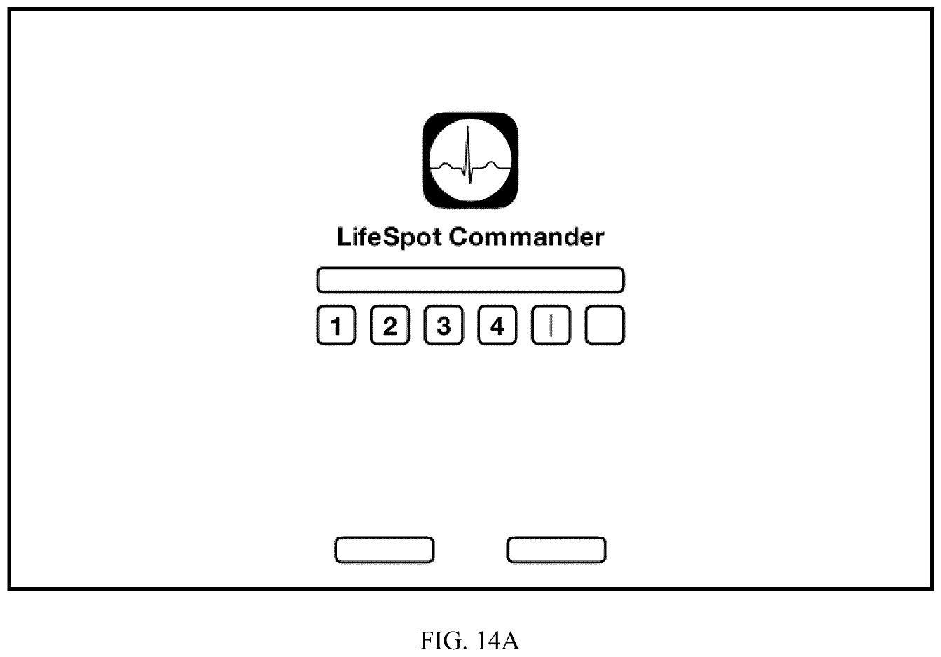

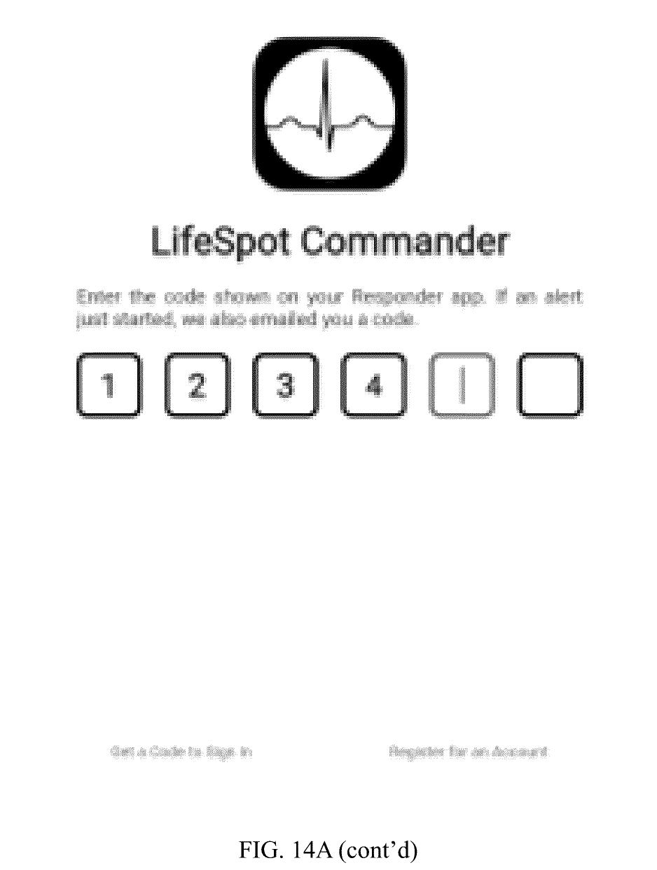

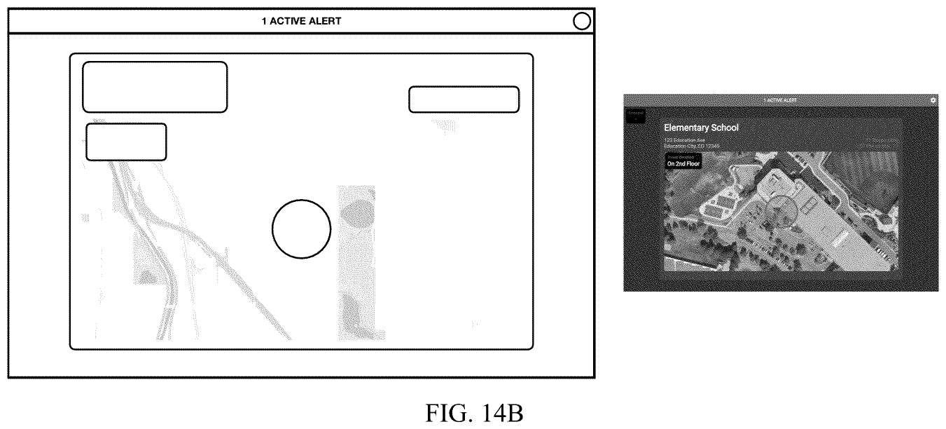

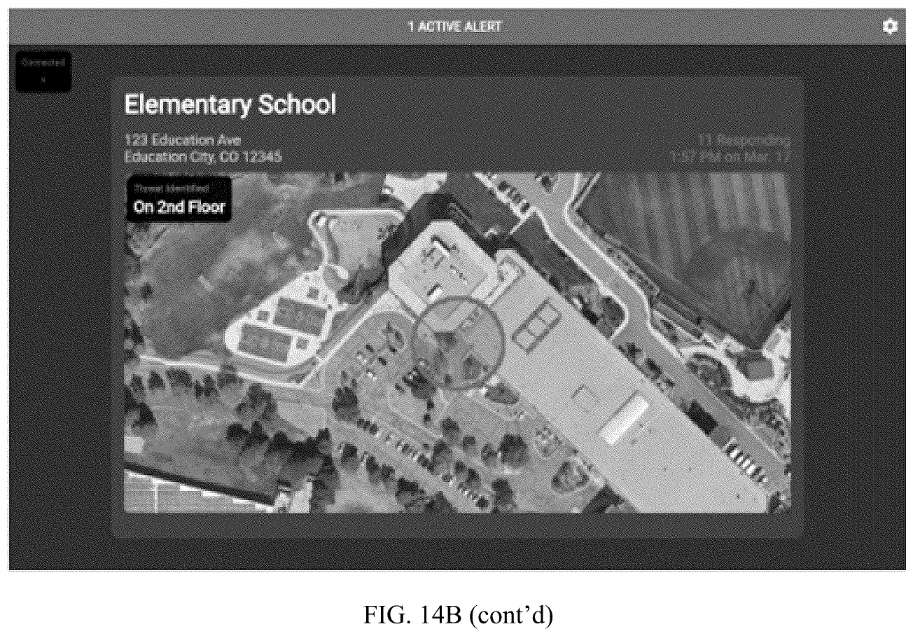

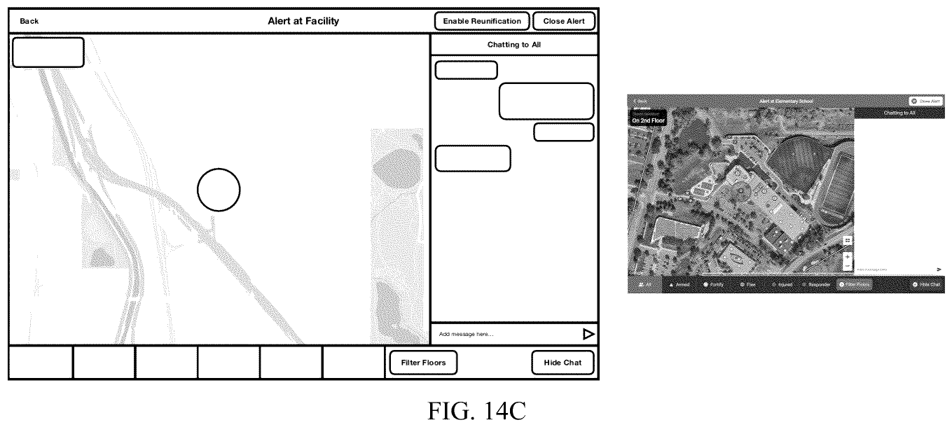

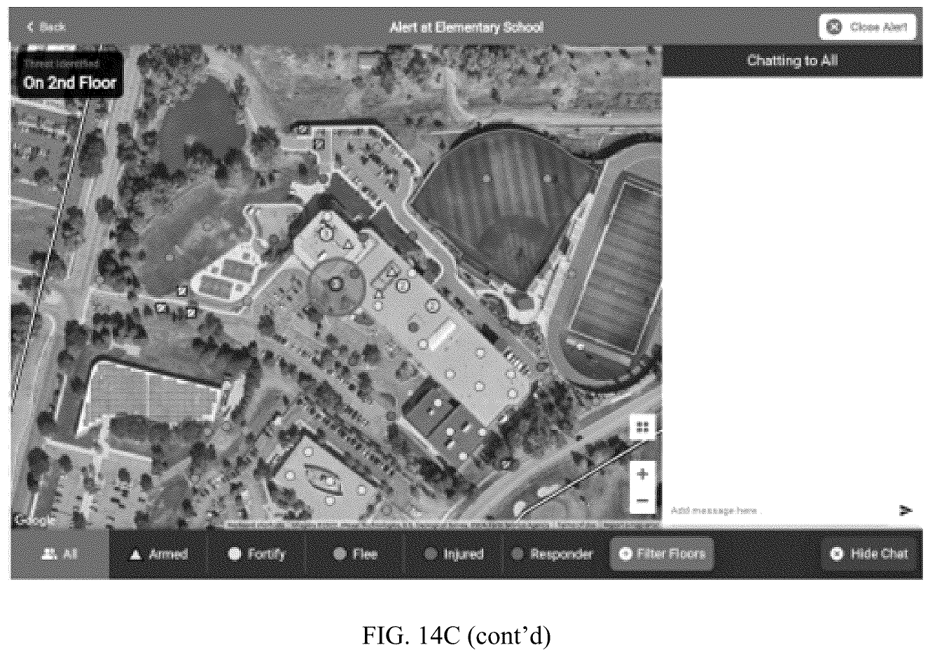

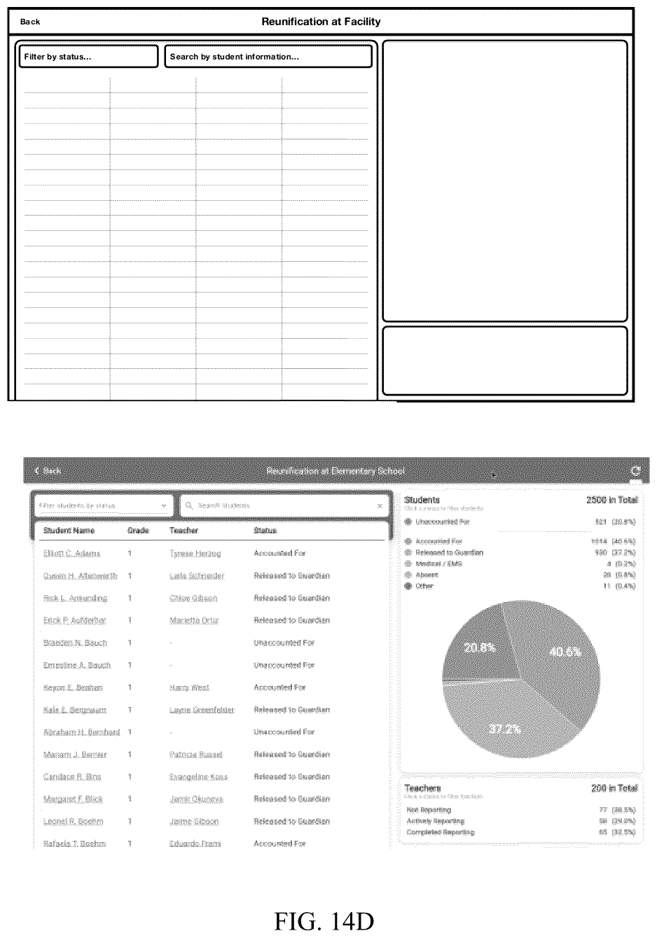

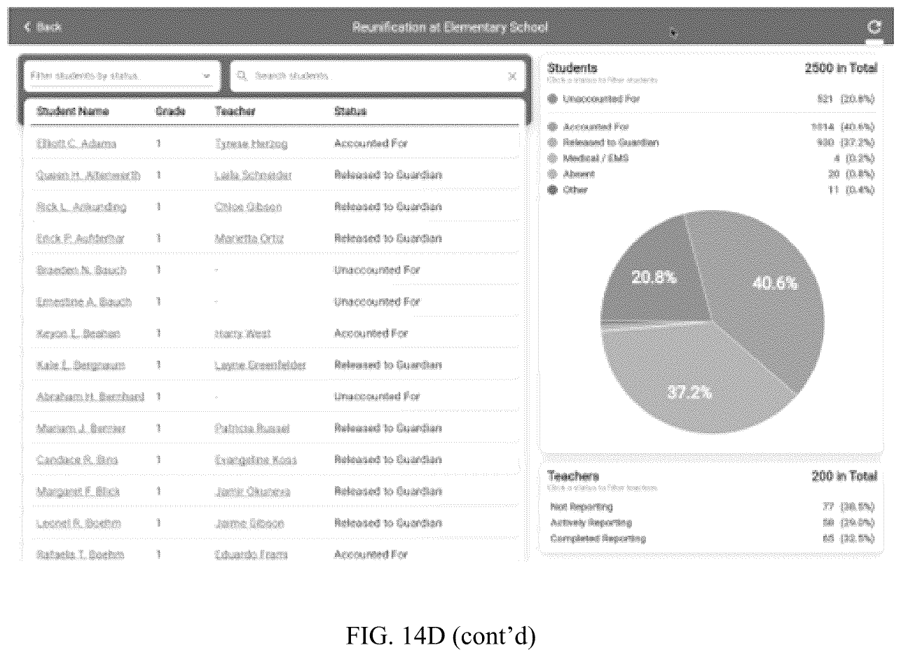

In some embodiments, the at least one action associated with the one or more commanders comprises a commander communication action, a respond action, an aerial action, a ground action, an intervention action, or a reunify action. In some cases, commanders may be associated with subscriber mobile devices, e.g., commander devices illustrated in FIGS. 14A-14D. Commander devices can be configured to be in communication with other subscriber mobile devices via distributed alert systems described elsewhere herein. In some embodiments, before the at least one action is transmitted to the one or more commanders, the at least one action is transmitted to the one or more users or the one or more responders to perform during the emergency. Commanders can include, for example, police or law enforcement agencies, emergency responder services, private institutions, or organizations having authority (e.g., authenticated or trusted) to command during emergencies. In some embodiments, the one or more commanders transmit a set of commander data to the one or more users, the one or more responders, or at least another commander of the one or more commanders. In some embodiments, the one or more commanders receive the set of user data from the one or more users or the set of responder data from the one or more commanders. The commander devices can be configured to generate, receive, or transmit data via distributed alert systems, e.g., alert communications or other communications. In some embodiments, the set of commander data comprises commander communications data, commander status data, commander location data, or commander navigation data. FIGS. 14A-14D depict an example commander interface for a commander device configured to generate, receive, transmit, or display data.

As illustrated in FIG. 14A, the commander interface can be configured with a commander authentication feature implemented via a commander authentication region. The commander authentication feature can provide a method for a responder or a commander to authenticate or associate a commander role with the responder or commander. Authentication can eliminate or reduce the risk of a third party accepting the role of a responder or a commander when the third party should not have the responder role or the commander role. For example, the third party may be associated with the active threat during an emergency and intend to undermine actions determined or predicted to eliminate or mitigate the actual or active threat. The commander authentication feature can include a responder or a commander signing into the commander device via a login in prompt region. For example, the log in prompt region may require the responder or the commander enter a temporary access code provided to previously authenticated or trusted responders or commanders. The commander role may provide features on commander devices different than features available to users via user devices or responders via responder devices. In some cases, responder devices can transition to commander devices when authenticated or trusted responders accept the role of a commander. Additionally, the commander interface may include an account feature implemented in an account feature region. For example, the account feature may allow a commander to access the commander's account information, sign out of the commander's account, or delete the commander's account.

As illustrated in FIG. 14B, the commander interface for a commander device can be configured with an alert preview feature to allow a commander to view a high level overview of an alert communication via an alert preview region. Commanders may view multiple alert communications on the alert preview region by cycling between the multiple alert communications via gesture inputs, e.g., swiping left or swiping right on the alert preview region. Additionally, the alert preview region may graphically or textually include information about the alert communication. For example, information can include location of alert communications, names of alerting communicating facilities, a time an alert communication was started or activated, and a number of responders who selected “respond” on a responder device. Additionally, the alert preview region can include a map for graphically or textually displaying data associated with emergencies. For example, data can include status data associated with users, status data associated with responders, status data associated with other commanders, or status data associated with active threats. The alert preview region may graphically or textually display locations associated with active threats, floor numbers associated with active threats, or status associated with active threats.

As illustrated in FIG. 14C, the commander interface for a commander device can be configured with an alert dashboard feature to allow a commander to direct actions or communications via an alert dashboard region. A commander can activate the alert dashboard feature by selecting any alert preview. In some cases, the alert dashboard region can include a map region and a communications region (e.g., a chat messaging region). The alert dashboard region may graphically or textually include data associated with emergencies. For example, data can include location of alert communications, names of alerting communication facilities, a time an alert communication was started or activated, or a number of responders who selected “respond” on a responder device. Additionally, the alert dashboard region can include a map for displaying data associated with emergencies. For example, data can include status data associated with users, status data associated with responders, status data associated with other commanders, or status data associated with active threats. The alert dashboard region may graphically or textually update any status when a status changes, e.g., a status symbol changes color, shape, or size. The alert dashboard region may graphically or textually display locations associated with active threats, floor numbers associated with active threats, or status associated with active threats. The alert dashboard region may graphically or textually update any location when a location changes. The alert dashboard region can display graphical or textual information, e.g., status or location of any user, responder, or commander, by selecting any symbol associated with a user, a responder, or a commander. For example, a commander may select a symbol associated with a user to determine that user is located on a floor number with a status of injured.

Further illustrated in FIG. 14C, the alert dashboard region can include a communications feature implemented in a communications region (e.g., a chat messaging feature in a chat messaging region). The chat messaging feature can allow communications between one and all (one-to-many) subscriber mobile devices, between all and one (many-to-one) subscriber mobile devices, between one and a subset of all subscriber mobile devices, or between subset of all subscriber mobile devices and one. As described elsewhere herein, natural language processing (NLP) may be used to process the communications to aid in determining or predicting actions during emergencies.

Further illustrated in FIG. 14C, the alert dashboard region can include filtering features. Filtering can apply to users, responders, or commanders such that the alert dashboard displays a subset of users, responders, or commanders. For example, users, responders, or commanders may be filtered by their associated status data. Users may be filtered by user status data, e.g., “fortify,” “flee,” or “injured.” Responders may be filtered responder status data, e.g., “responder.” Commanders may be filtered by commander status data, e.g., “commander.” For example, users, responders, or commanders may be filtered by their associated location. Users may be filtered by user location data, e.g., users associated with a floor number or users within a proximity to active threats. Responders may be filtered by responder location data, e.g., responders associated with a floor number or responders within a proximity to active threats. Commanders may be filtered by commander location data, e.g., commanders associated with a floor number or commanders within a proximity to active threats. Filtering can apply to users, responders, or commanders such that the alert dashboard automatically declutters the dashboard by displaying aggregated or clustered graphical or textual symbols of users, responders, or commanders. When a number of symbols associated with users, responders, or commanders exceeds a threshold level, individual user, responder, or commander symbols can be aggregated or clustered by a single user symbol, single responder symbol, or single commander symbol to declutter the dashboard. For example, user symbols associated with a user status of fortify that exceed a threshold level of 12 may appear as a single yellow dot inscribed with the number 12. In some cases, the commander may select an aggregated or clustered symbol to reveal individual symbols associated with users, responders, or commanders. Aggregation or clustering of symbols may be determined, in part, by the zoom level of the map associated with the alert dashboard region. For example, a zoom level greater than 100% may cause automatic aggregation or clustering of symbols associated with users, responders, or commanders. A zoom level less than 100% may cause the map to display individual symbols.

In some embodiments, the method further comprises determining a reunification status of the one or more users; and transmitting the reunification status to the one or more responders or the one or more commanders. As illustrated in FIG. 14D, the commander interface for a commander device can be configured with a reunification feature to allow a commander to determine or direct reunification of users implemented via a reunification region. In some cases, a commander can activate the reunification feature by selecting “enable reunification” from the alert dashboard. Activating the reunification feature can enable reunification features on other subscriber mobile devices, e.g., user devices, responder devices, or other commander devices. The reunification region can include a graphical or textual table for reunifying users. The table can be pre-populated with user data, e.g., names of students, grade levels of students, or assigned teachers or staff for students.

In some embodiments, the reunification status comprises: unaccounted for status, accounted for, released to a guardian status, released to emergency medical services (EMS) status, absent status, other status, or any combination thereof. Activating reunification features on other subscriber mobile devices allows trusted users, e.g., teachers or staff, to enter user status data associated with users. For example, a trusted teacher or trusted staff may be associated with a subset of students. The trusted teacher or trusted staff can set a status of each student. Status can include, for example, unaccounted for status, accounted for status, released to a guardian status, released to emergency medical services (EMS) status, absent status, other status, or any combination thereof. Selecting other status can provide a trusted person, e.g., a trusted teacher, trusted staff, trusted responder, or trusted commander, an ability to generate data associated with the other status, e.g., notes, associated with the user to further explain the user's status. In some cases, upon selecting accounted for status, the user device may be configured to provide a direct communication feature with a trusted person, e.g., a trusted teacher, trusted staff, trusted responder, or trusted commander. For example, a student may directly communicate via the chat messaging feature on the student's device with a trusted teacher via the chat messaging feature on the teacher's device. The reunification feature can automatically refresh at a reunification refresh rate. The reunification refresh rate can be least every 0.1, 1, 2, 3, or more seconds. The reunification feature can allow for filtering users by user data, e.g., user status, user name, user grade level, and the like.

Further illustrated in FIG. 14D, the reunification feature may include a graphical or textual display of metrics associated with the reunification process during emergencies. Metrics can include compiling and transforming data that is generated, received, or transmitted during reunification. For example, metrics can include graphics illustrating progress towards 100% completion of the reunification process; metrics associated with user status, e.g., percentage of users with a status of unaccounted for status, accounted for status, released to a guardian status, released to emergency medical services (EMS) status, absent status, or other status; metrics associated with trusted person status, e.g., percentage of trusted persons with a status of not reporting, actively reporting, or completed reporting. Selecting any metric associated with user status or trusted person status can provide detailed information about any single user or single trusted person associated with that status.

In some embodiments, the method further comprises receiving a set of aerial data, ground data, or structural data; and processing, via the trained machine learning model, the set of aerial data, ground data, or structural data to generate the at least one action. In addition to data that is generated, transmitted, or received by users via user devices, responders via responder devices, or commanders via commander devices, data may also be generated, received, or transmitted by other devices. Other devices may be configured to generate, receive, or transmit aerial data, ground data, or structural data. The other devices may be authenticated and trusted via the distributed alert system in a similar or same manner that users, responders, and commanders are authenticated and trusted described elsewhere herein. Upon authentication, other devices may be trusted to generate, receive, or transmit data via the distributed alert system. Users, responders, or commanders can use this data to generate or execute actions to eliminate or mitigate actual or active threats during emergencies. Additionally, the machine learning model can use this data to generate or predict actions to eliminate or mitigate actual or actual threats during emergencies.

In some embodiments, the set of aerial data comprises data associated with or received from one or more unmanned aerial vehicles, one or more manned aerial vehicles, or any combination thereof. For example, aerial data may be received by unmanned or manned platforms, e.g., unmanned aerial vehicles (UAVs) or manned vehicles. Such vehicles can be configured with sensor systems to generate the aerial data. Sensor systems may include sensors for collecting visual or optical data, infrared (IR) data, thermal data, light detection and ranging (LIDAR) data, ground penetrating radar (GPR) data, radiometer data, or multispectral data. For example, optical data may include optical imagery, e.g., digital images of weapons associated with active threats or digital images of persons associated with active threats. Users, responders, or commanders can use this aerial data to generate or execute actions to eliminate or mitigate actual or active threats during emergencies. Additionally, the machine learning model can use this data to generate or predict actions to eliminate or mitigate actual or active threats during emergencies.

Such vehicles can be configured with transmitter systems to transmit the aerial data. Transmitter systems may be configured to use transmission protocols suitable for transmitting data within the distributed alert system. For example, transmitter systems may include transmitters for transmitting the aerial data over Wi-Fi networks, cellular networks, or radiofrequency (RF) networks.

Such vehicles can be configured with communication systems to receive communications associated generating, receiving, or transmitting of the aerial data. Communication systems may be configured to use communication protocols suitable for communicating within the distributed alert system. For example, communication systems may include transmitters and receivers for transmitting or receiving communications over Wi-Fi networks, cellular networks, or radiofrequency (RF) networks.

Such vehicles can be configured with navigation systems configured to navigate the vehicles to locations associated with emergencies, e.g., locations within the geo-fence. Navigation systems can generate navigation routes to locations associated with emergencies based on actions generated by commanders. For example, a commander may direct the vehicle to loiter over a location, and the navigation system may determine a route to the location. Alternatively or additionally, navigation systems can generate navigation routes to locations associated with emergencies based on actions generated or predicted by the machine learning model. For example, the machine learning model may generate or predict the location of an active threat, and the navigations system may determine a route to the location. Navigation routes may start outside the geo-fence and route the vehicles to locations within the geo-fence. Upon arrival within the geo-fence, navigation systems may determine new routes to other locations within the geo-fence. Generating new routes to different locations can improve the aerial data collected by the vehicles. For example, the first location may not provide a clear view for the sensors to collect optical data of active threats because a building obstructs the view of active threats. The commander or the machine learning model may determine or predict a second location to provide a better optical view of active threats, and the navigation systems may determine a route to the second location. In some cases, the commander or the machine learning model may determine or predict both the location and the route to the location.

In some embodiments, the set of ground data comprises data associated with or received from one or more image devices, one or more security doors, one or more communications towers, one or more networked devices, or any combination thereof. Ground data may be generated by devices, e.g., cameras, security doors, communications towers, or other networked devices, associated with locations of emergencies, e.g., devices located within a geo-fence. In some cases, ground data can include images associated with active threats. For examples, images can include one or more weapons associated with active threats. Systems herein can process the images to automatically determine data or information associated with the one or more weapons to uniquely identify the one or more weapons, e.g., a rifle, a pistol, a knife, a bomb, and the like. The one or more weapons can be uniquely associated with each of the one or more active threats. The unique associations can aid in tracking each of the one or more active threats. Devices may be configured to use communication protocols suitable for communicating the ground data to subscriber mobile devices within the distributed alert system. Devices may be configured to use communication protocols suitable for receiving or executing actions generated by commanders. Alternatively or additionally, devices may be configured to use communication protocols suitable for receiving or executing actions generated or predicted by the machine learning model. For example, the commander or the machine learning model may generate or predict an action for a security door. The action may include locking the security door when the door is not secure. Locking the security door may eliminate or mitigate the actual or active threat during emergencies.

In some embodiments, the set of structural data comprises data associated with or received from one or more architectural plans, one or more aerial images, one or more satellite images, or any combination thereof. Structural data may be associated with or generated by devices, e.g., architectural plans, aerial images, satellite images, or any combination thereof. Devices may be configured to use communication protocols suitable for communicating the structural data to subscriber mobile devices within the distributed alert system. Structural data may be used by commanders to generate actions for eliminating or mitigating actual or active threats during emergencies. Alternatively or additionally, structural data may be used by the machine learning model to generate or predict actions for eliminating or mitigating actual or active threats during emergencies. For example, the commander or the machine learning model may generate or predict actions based, in part, on architectural plans. The architectural plans may depict a plan for a building associated with the emergency. The building plan may include: locations, sizes, and number of floors; locations, sizes, and number of rooms; locations, sizes, and number of doors; locations, sizes, and number of windows; layouts of electrical systems; layouts of plumbing systems; layouts of environmental HVAC systems; and the like. Commanders or machine learning models may use the structural data to, for example, generate or predict actions for routes by users to safe locations or generate or predict routes by responders to interpret active threats.

In some embodiments, the method further comprises transmitting the at least one action to the one or more users, the one or more responders, or the one or more commanders, wherein the transmitting is via a communications network configured with the one or more users in communication with the one or more responders or the one or more commanders. For example, actions may be transmitted to or received by users, responders, commanders, devices associated with aerial data, devices associated with ground data, or devices associated with structural data. Actions can be transmitted or received via the distributed alert system described elsewhere herein.

### Systems Associated With Subscriber Mobile Devices

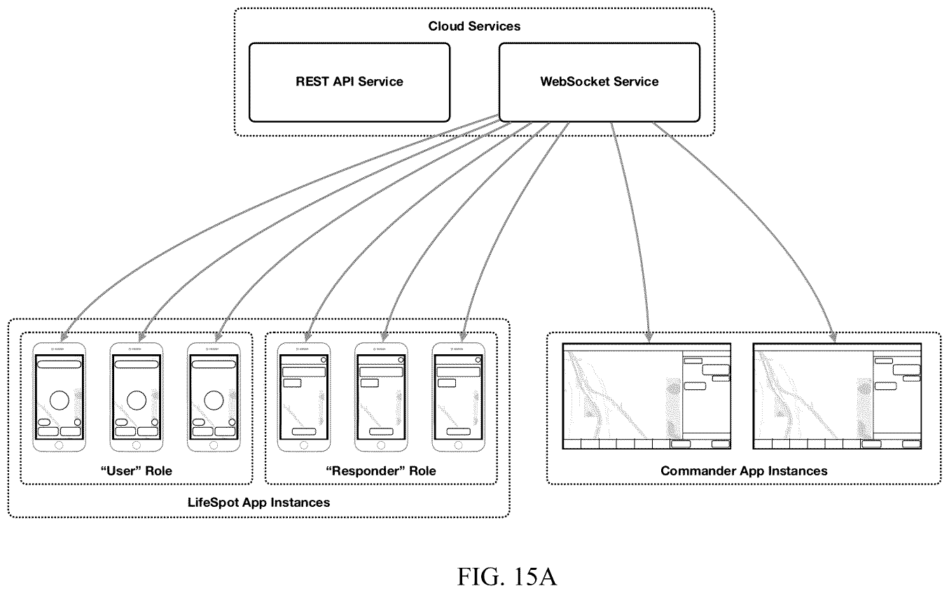

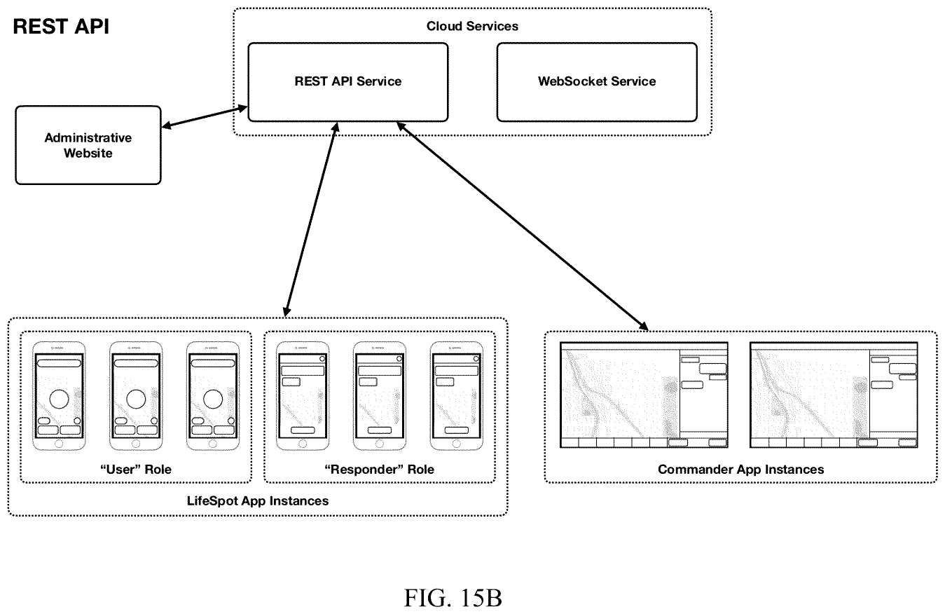

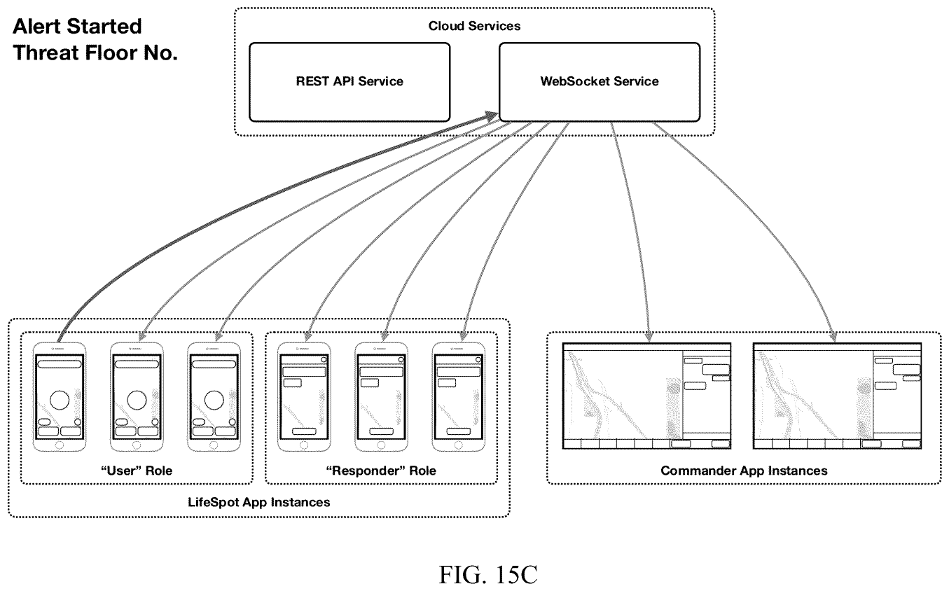

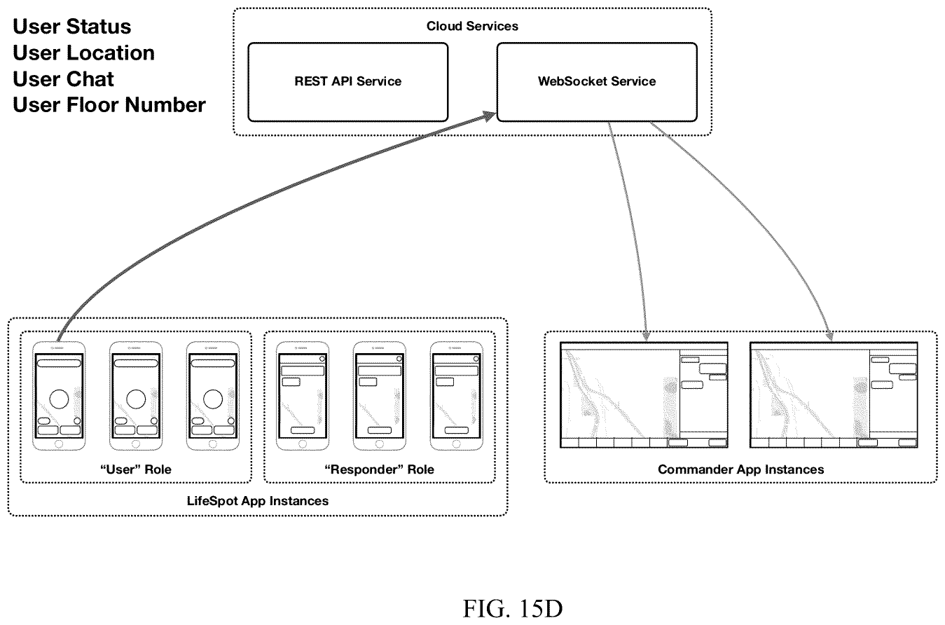

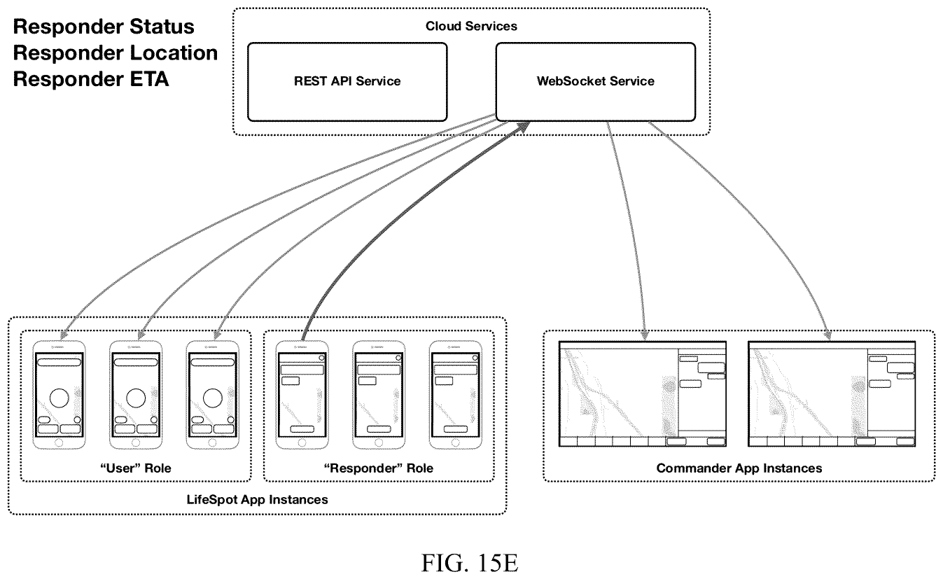

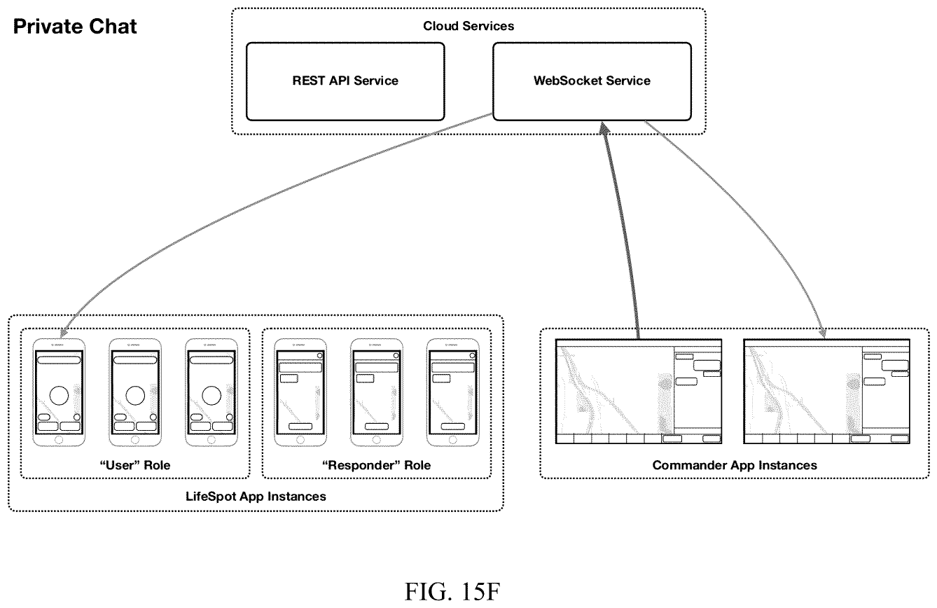

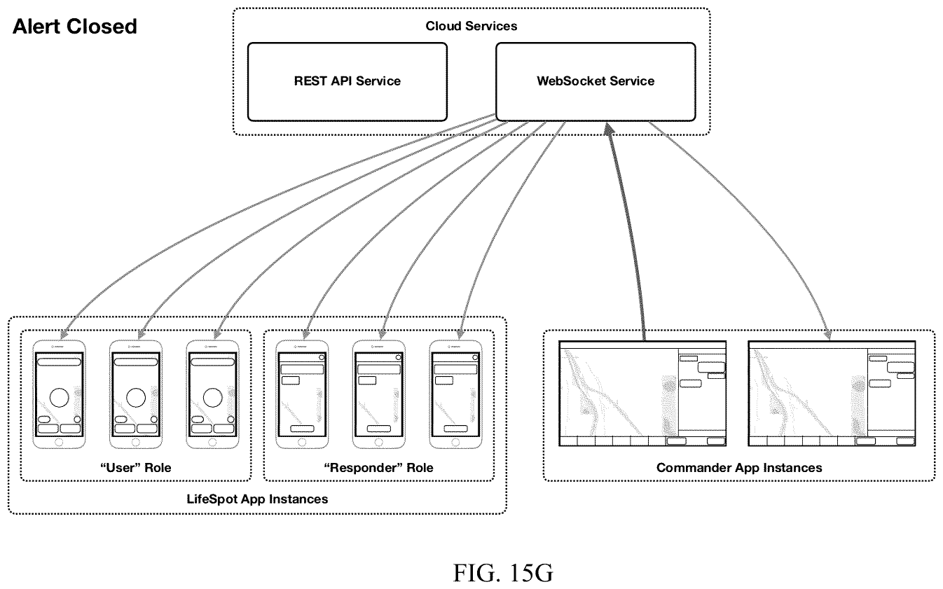

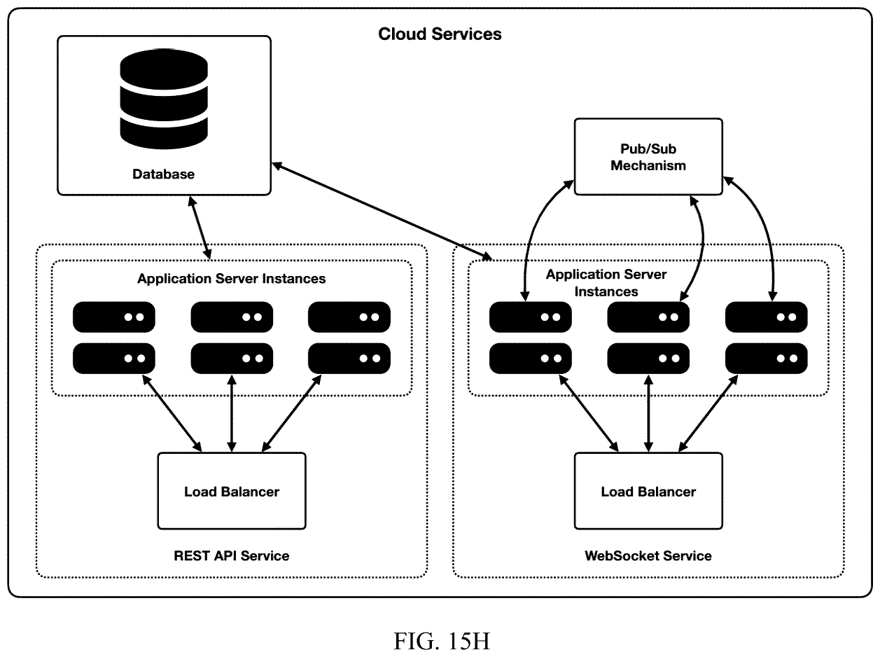

Described herein are systems for determining actions in an emergency. In an aspect, described herein is a system for determining at least one action in an emergency, comprising: a user module configured to received or transmit a set of user data associated with one or more users; a responder module configured to receive or transmit a set of responder data associated with one or more responders; a processing module configured to process, via a trained machine learning model, the set of user data or the set of responder data to generate the at least one action; a commander module configured to transmit the at least one action to the one or more commanders, wherein the one or more commanders direct the one or more users or the one or more responders to perform the at least one action during the emergency. User modules can be associated with user devices described elsewhere herein. Responder modules can be associated with responder devices described elsewhere herein. Commander modules can be associated with commander devices described elsewhere herein. In some cases, users associated with user devices, responders associated with responder devices, or commanders associated with commander devices may be connected via a distributed alert system described elsewhere herein and further in FIGS. 15A-15H.

As illustrated in FIG. 15A, the responder server may be configured in a cloud services application. The cloud services application may include websocket application programming interfaces (API). Websocket APIs can be configured to provide two-way interactive communication sessions between a user's device and a server. Configuration can include sending messages to a server and receiving event-driven responses without polling the server for a reply. For example, user devices, responder devices, or commander devices can generate, receive, or transmit data to other user devices, responder devices, or commander devices via the websocket APIs.

As illustrated in FIG. 15B, the cloud services application may include application programming interfaces (APIs), e.g. a representational state transfer (REST) APIs. REST APIS can be configured to build and integrate application software associated with the subscriber mobile devices of the distributed alert system described elsewhere herein. For example, REST APIs may provide for account-related activities such as: registering user devices, responder devices, or commander devices; signing into user devices, responder devices, or commander devices: or deleting accounts associated with user devices, responder devices, or commander devices. Additionally, REST APIs may provide for authenticating users, responders, or commanders. Upon authentication, users, responders, or commanders can become trusted users, trusted responders, or trusted commanders. Trusted users, trusted responders, or trusted commanders may participate during alert communications associated with emergencies via websocket APIs. Additionally, REST APIs may provide for authenticating devices associated with aerial data, ground data, or structural data. Upon authentication, devices associated with aerial data, ground data, or structural data can become trusted devices. Trusted devices may participate during alert communications associated with emergencies via websocket APIs.

FIGS. 15C-15G further illustrate example flows of data for data that is generated, received, or transmitted during alert communications associated with emergencies. FIG. 15C illustrates an example flow of data associated with location data, e.g., threat floor number, that may be generated, received, or transmitted via websocket services. Upon generation of an alert communication by a user, responder, or commander, data may be transmitted to websocket APIs and received by other users, other responders, or other commander devices. FIG. 15D illustrates an example flow of data associated with user data, e.g., user status, user location, user communications, or user floor number, that may be generated, received, or transmitted via websocket services. Upon generation of user data by a user, user data may be transmitted to websocket APIs and received by other users, other responders, or other commanders. FIG. 15E illustrates an example flow of data associated with responder data, e.g., responder status, responder location, or responder navigation, that may be generated, received, or transmitted via websocket services. Upon generation of responder data by a responder, responder data may be transmitted to websocket APIs and received by other users, other responders, or other commanders. FIG. 15F illustrates an example flow of data associated with communication data, e.g., communications or private chats generated by users, responders or commander. Upon generation of communication data by a user, a responder, or a commander, communication data may be transmitted to websocket APIs and received by other users, other responders, or other commanders. FIG. 15G illustrates an example flow of data associated with alert status data, e.g., terminating or closing alert. Upon generation of alert status data by a commander, alert status data may be transmitted to websocket APIs and received by other users, other responders, or other commanders.

FIG. 15H illustrates an example backend architecture for distributed alert systems to generate, transmit, receive, or store data. Websocket APIs and REST APIs can use load balancers to distribute network requests to instances of user devices, responder devices, or commander devices. Each instance can persist data as needed to a database. The backend architecture can include a Pub/Sub service configured to facilitate horizontal scaling of websocket API services by enabling inter-server communication (e.g.,. an “Alert Started” channel is listened to by all instances) allowing each instance to notify other instances when a subscriber mobile device has initiated an alert communication.

### Systems and Methods Associated With Door Locking Systems

In some cases, systems herein can be integrated with door locking systems to perform methods herein. In some cases, integration can be implemented via software architectures herein. In some cases, systems herein can be configured to seamlessly communicate with door locking system using secure communication protocols. In some cases, systems herein can be configured with interfaces and APIs configured to operate door locking systems, e.g., by controlling hardware of doors to close, lock, or open doors. In some cases, systems herein can be configured to send control signals or commands to door locking systems to automate the closing, locking, or opening of doors upon activation of alert systems herein.

In some cases, integration with door locking systems can include using an internet-connected control module configured to be compatible with a facility's (e.g., a school's) existing door locking systems. In some cases, the control module can act as an intermediary and can enable systems herein to communicate directly with door locking systems (e.g., the door locks). In some cases, systems herein can be configured to use a secure and reliable internet connection to facilitate uninterrupted communication between systems herein and door locking systems to ensure the control commands or signals are received and executed without delay.

In some cases, when a user initiates an alert, systems herein can send control signals or commands to designated door locking systems. The control signals or commands can instruct immediate operation (e.g., closing, locking, or opening doors) that have been registered or integrated with systems herein to ensure a safe and rapid response to potential threats.

In some cases, systems herein can be configured to transmit notifications to a predefined list of recipients (e.g., users, responders, or commanders). In some cases, the predefined list of recipients can include key stakeholders, school administrators, law enforcement, and the like

In some cases, systems herein that are integrated with door locking systems can be configured to perform operations with the door locking systems. For example, systems herein can be configured to: authorize commander to selectively unlock doors, which can facilitate controlled evacuation or access by emergency responders; automatically disengage door locks in the event of higher priority emergencies, e.g., response to a fire alarm prioritizes evacuation of students; allow facilities (e.g., schools) to implement varying degrees of lockdown protocols in response to different threat assessments; provide commanders with live updates on the status of each door to enhance situational awareness during emergencies; enable commanders to remotely control door status, allowing for dynamic adjustments to lockdown protocols as situations evolve; link the commander system with existing surveillance infrastructure, offering a unified platform for crisis management and response; or provide comprehensive crisis management solutions by developing an integrated ecosystem of safety technologies.

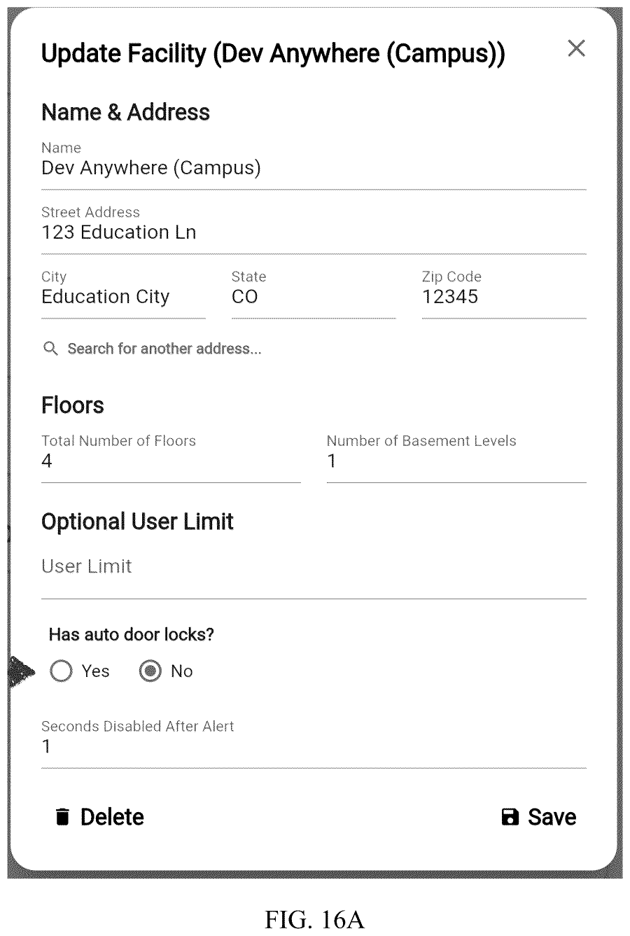

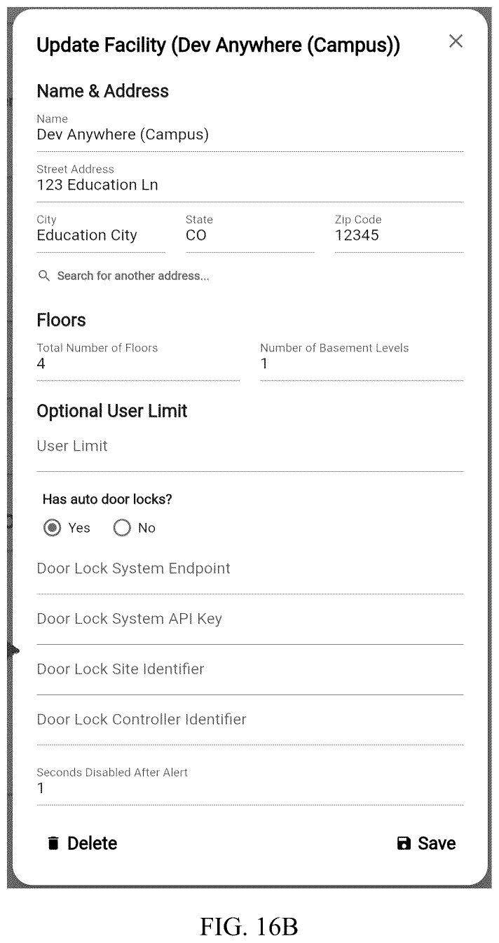

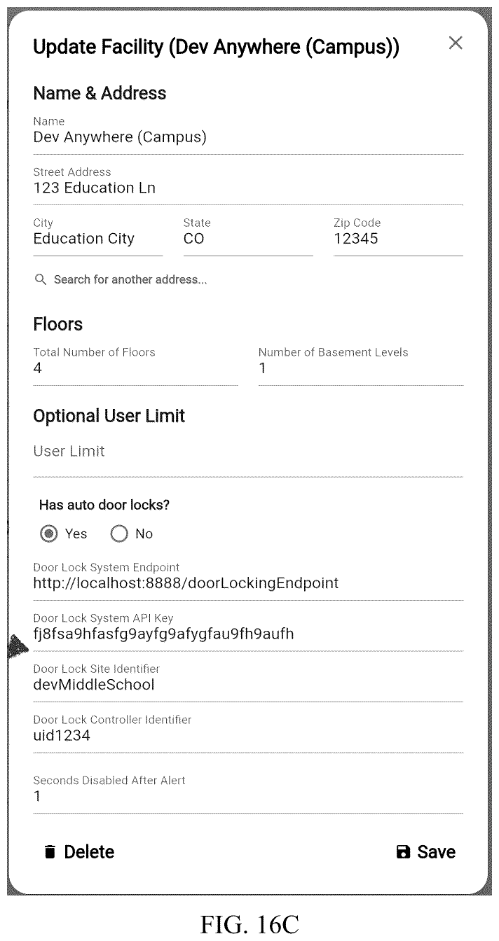

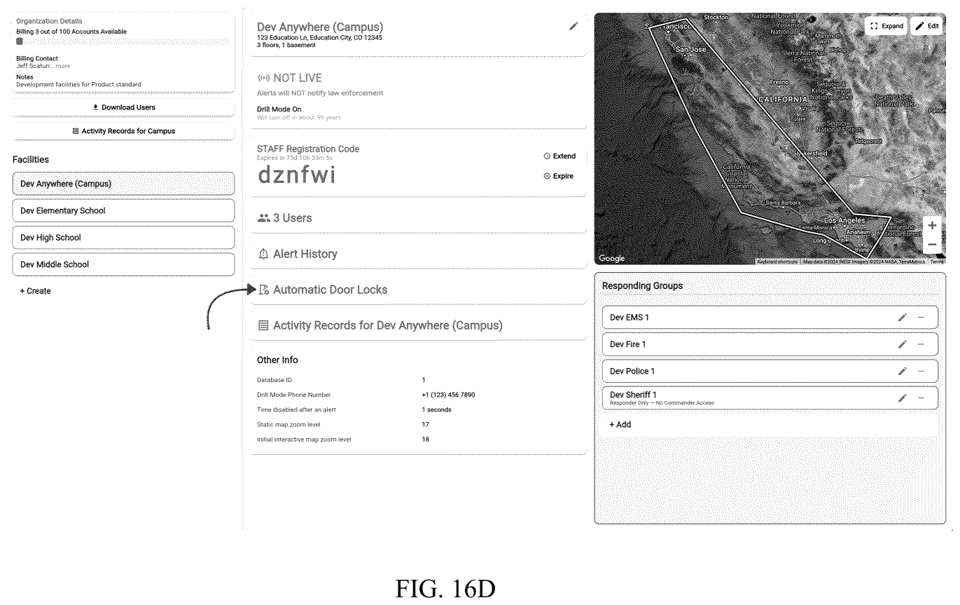

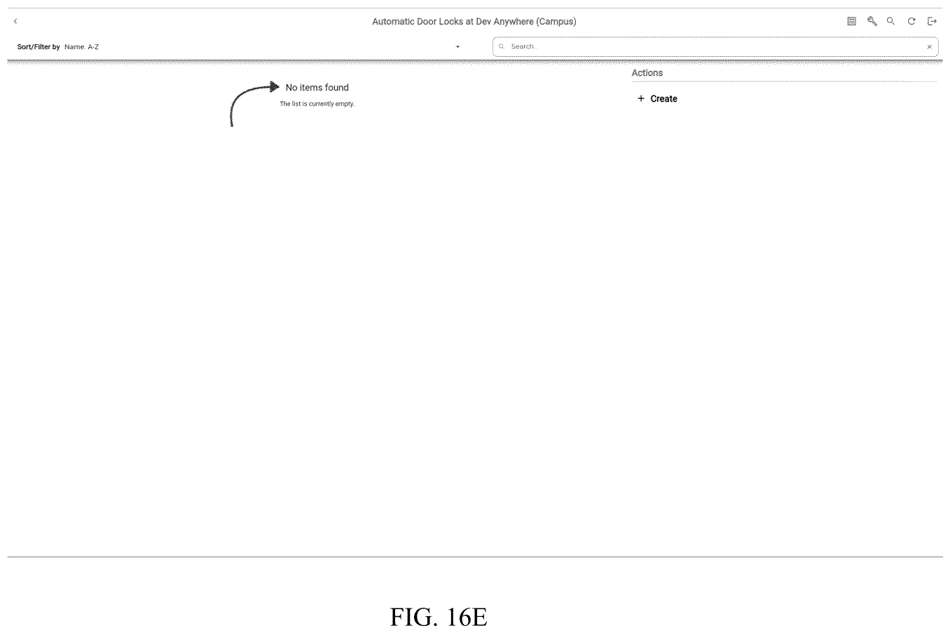

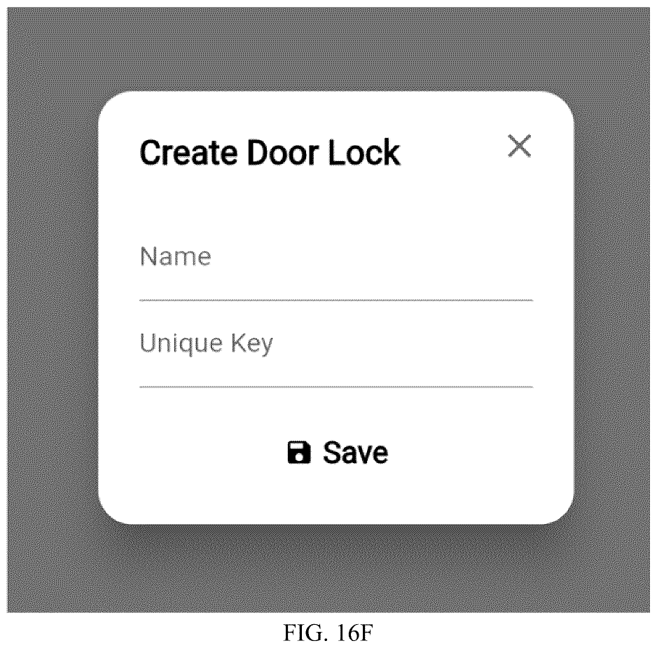

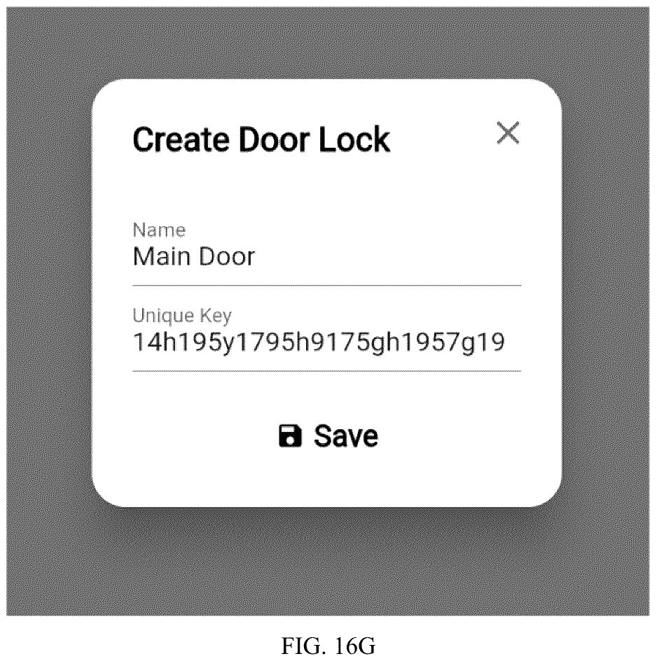

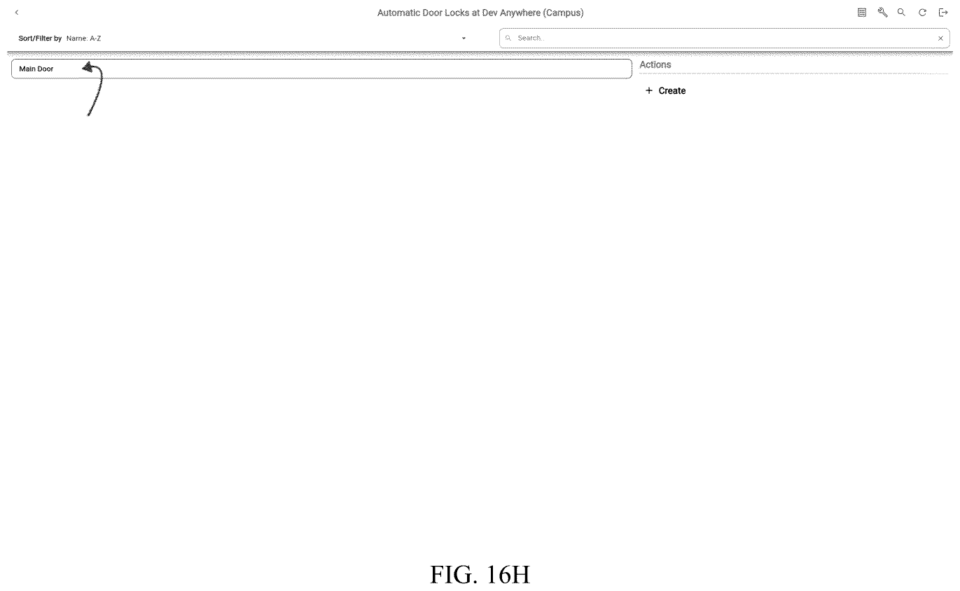

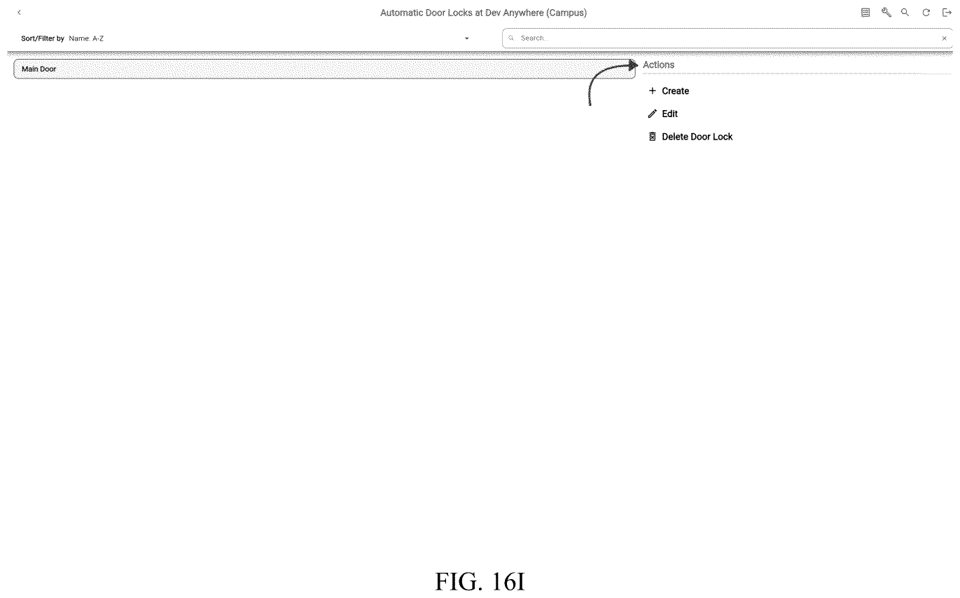

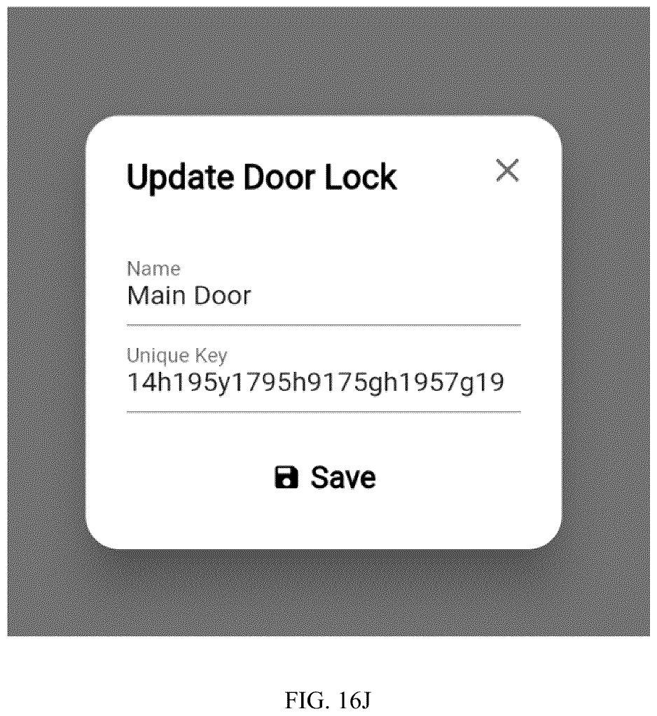

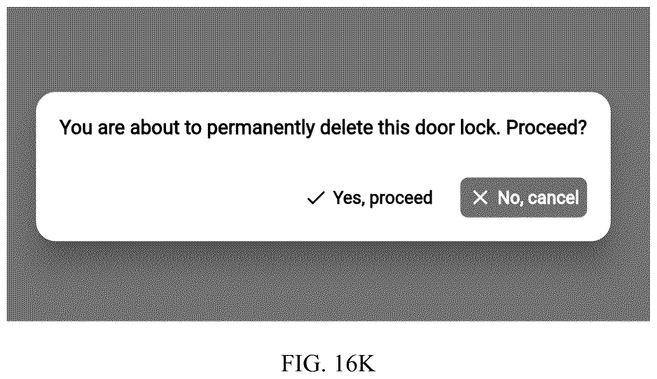

FIGS. 16A-16K depict example user interfaces for configuring or integrating door locking systems with systems herein. FIG. 16A depicts an example user interface for integration of a door locking system. The user interface can include data such as: name, address, number of floors, number of basement levels, optional user limit, whether the school has auto door locks, and the like. FIG. 16B depicts an example user interface for integration of a door locking system. For example, if the school has auto door locks (or if the auto door locks are installed), the user interface can ask for inputs, e.g., door lock system endpoint, door lock system API key, door lock site identifier, door lock controller identifier to configure the auto door locks with the alert system, and the like. FIG. 16C depicts an example user interface with the auto door lock data or information entered. FIG. 16D depicts an example user interface after the door information is entered. A button of Automatic Door Locks can appear that allows school staff, e.g., an administrator, to view and maintain the doors. The user interface can include additional data, e.g., organization details, facilities, name, address, number of users, alert history, activity records, responding groups (e.g., law enforcement, EMS, Fire department, police, sheriff), and the like. FIG. 16E depicts an example user interface for the user to create an action. The user can click on “Create” to create an action. FIG. 16F depicts an example user interface for the user to create a door lock action. It can ask for a name of the door and a unique key known by and associated with the door locking system. FIG. 16G depicts an example user interface for entering the name and unique key of the door. The name and unique key can be saved by clicking “Save”. FIG. 16H depicts an example user interface with a door entered and saved to the system herein. The user interface can populate a list of doors that have been configured. FIG. 16I depicts an example user interface to create actions, edit the door information or action, delete a door lock for the configured door, and the like. FIG. 16J depicts an example user interface to edit the action if “Edit” is clicked. The name and/or unique key can be updated. FIG. 16K depicts an example user interface if “Delete Door Lock” is clicked. The user can have the option to delete the door lock by clicking “Yes, proceed” or not delete the door lock by clicking “No, cancel”.

### Systems and Methods Associated With Aerial Vehicles

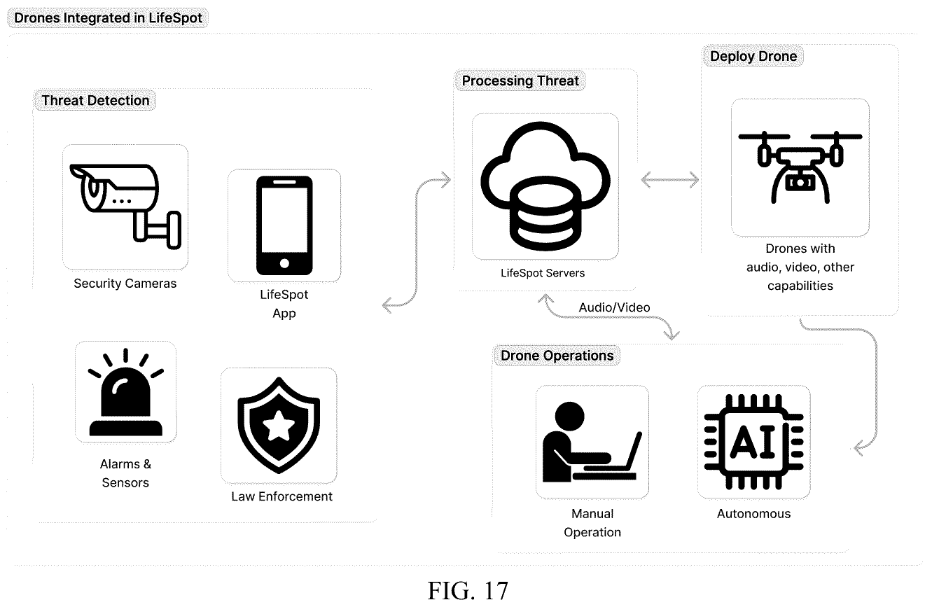

In some cases, systems herein can be integrated with aerial vehicles to perform methods herein. FIG. 17 depicts an example architecture or system configured to integrate with aerial vehicles. In some cases, aerial vehicles can include unmanned aerial vehicles (UAVs or drones), manned aerial vehicles, or combinations thereof. As an example, as illustrated in FIG. 17, UAVs or drones can be integrated into systems herein. The UAVs can be configured to generate, receive, or transmit data, e.g., aerial data, ground data, or combinations thereof. The UAVs can be deployed to respond with threat countermeasures described herein. The UAVs can be deployed to respond to threats by autonomous operation, by user operation, or any combination thereof. The UAVs may be deployed after systems herein determine a threat by processing data associated with threats. Data can be received from sensors, e.g., cameras or alarms, and processed to determine threat assessments. Data can be received from commanders, responders, or users via mobile devices described herein, and processed to determine threat assessments.

In some embodiments, the set of aerial data comprises data associated with or received from one or more unmanned aerial vehicles, one or more manned aerial vehicles, or any combination thereof. For example, aerial data may be received by unmanned or manned platforms, e.g., unmanned aerial vehicles (UAVs) or manned vehicles. Such vehicles can be configured with sensor systems to generate the aerial data. Sensor systems may include sensors for collecting visual or optical data, infrared (IR) data, thermal data, light detection and ranging (LIDAR) data, ground penetrating radar (GPR) data, radiometer data, or multispectral data. For example, optical data may include optical imagery, e.g., digital images of weapons associated with active threats or digital images of persons associated with active threats. Users, responders, or commanders can use this aerial data to generate or execute actions to eliminate or mitigate actual or active threats during emergencies. Additionally, the machine learning model can use this data to generate or predict actions to eliminate or mitigate actual or active threats during emergencies.

In some cases, systems herein can automatically deploy aerial vehicles (UAVs or drones) to respond to threats. Aerial vehicles can be configured with cameras and sensors for live video and audio streaming to provide real-time surveillance and recording capabilities. Aerial vehicles can be configured to autonomously follow threats or guided by human operators. Data from sensors (e.g., video and audio data) can be transmitted to and received by systems herein. Data can be transmitted to or shared with third party systems in real-time for immediate assessment and response. Once a threat is detected and confirmed, systems herein can transmit data to operators (e.g., drone deployment units) for deploying aerial vehicles to threat locations, e.g., GPS locations of threats. In some cases, aerial vehicle operators or drone deployment units may be associated with systems herein or with third party systems.

### Systems and Methods Associated With Threat Countermeasures

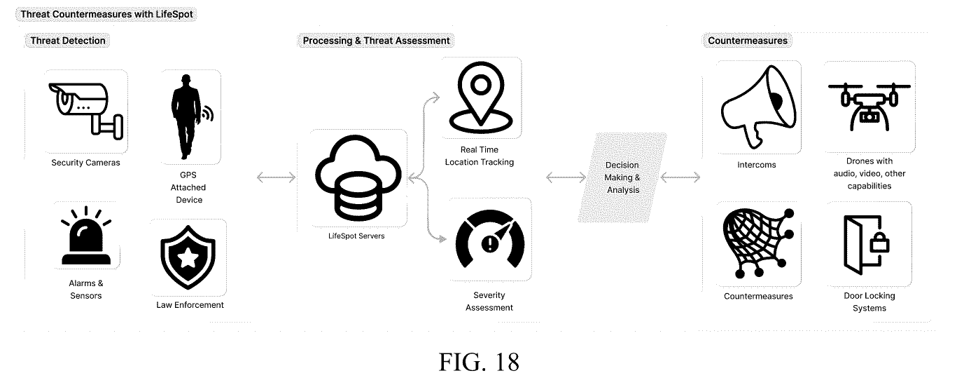

In some cases, systems herein can be integrated with threat countermeasures to perform methods herein FIG. 18 depicts an example architecture or system configured to integrate threat countermeasures and deploy countermeasures against threats, e.g., active shooters. As an example, as illustrated in FIG. 18, systems herein can be configured to (i) detect threats with different sensors, (ii) receive data associated with the different sensors, (iii) process the data to determine a threat assessment, and (iv) deploy countermeasures to mitigate or defeat threats.

In some cases, sensors can include cameras (e.g., security cameras), alarms and sensors, communications from law enforcement about threats, real-time location tracking devices attached to or proximate to threats, or any combination thereof. Real-time location tracking devices can include, e.g., GPS devices attached to or proximate to threats. In some cases, systems herein can receive data from the sensors. The data can be processed by systems herein to automatically determine a threat assessment.

In some cases, the threat assessment can include a severity of the threat. The severity of the threat can include information about the type of the threat or the location of the threat. For example, a threat with a weapon (e.g., a gun) may be associated with a higher threat severity than a threat with a knife or a threat without a weapon. For example, a threat located in a classroom with children may be associated with a higher threat severity than a threat in a hallway near children or a threat that is not located near children. Based at least in part on the threat severity, systems herein can automatically determine one or more threat countermeasures to deploy based on predefined criteria of the threat assessment.

In some cases, threat countermeasures can include loud alarms, bright flashing lights, intercoms, munitions (e.g., lethal or nonlethal), operating doors (e.g., closing, locking, or opening doors), or any combination thereof. In some cases, aerial vehicles herein can be configured to deploy threat countermeasures. For example, aerial vehicles can be configured with loud alarms, bright flashing lights, intercoms, munitions (e.g., lethal or nonlethal), or any combination thereof. In some cases, systems herein may be configured deploy threat countermeasures of third parties. For example, threat countermeasures of third parties can include systems or devices maintained by law enforcement agencies, private security services, emergency response teams, or any combination thereof. For example, a law enforcement agency may maintain or operate robots configured to perform reconnaissance, surveillance, threat detection, threat mitigation, or threat defeat.

In some cases, systems herein may be configured to integrate with systems of third parties. For example, systems of third parties can include databases and networks configured to dispatch emergency response teams, notify public safety organizations, activate community alert systems, or any combination thereof. Systems of third parties can include on-site threat countermeasures, e.g., deployable nets, gas, and the like. Systems of third parties can include door locking systems configured to automatically close doors, lock doors, or open doors. Systems of third parties can include aerial vehicles, e.g., UAVs or drones.

In some cases, upon identifying a potential threat, systems herein can transmit data to third party systems through secure channels, e.g., encrypted channels. Data can include type of the threat, location of the threat, threat assessment, severity of the threat, type of countermeasures, deployed countermeasures, or any other data collected and processed by systems herein. Sharing of data can ensure timely and coordinated responses from different agencies to improve threat response thereby enhancing overall safety and security.

### Machine Learning or Natural Language Processing Associated With Subscriber Mobile Devices

In another aspect, methods can use trained machine learning (ML) models to generate or predict actions for execution by users, responders, or commanders during emergencies. Trained ML models may determine or predict actions by users, responders, or commanders to improve responses during emergencies thereby improving outcomes. Improving outcomes can include reducing or eliminating casualties or injuries caused by active threats during emergencies. For example, trained ML models can determine, predict, or prioritize actions to reduce uncertainty in decision making by users, responders, or commanders. Trained ML models can determine, predict, or prioritize actions to reduce time in decision making by users, responders, or commanders. In some embodiments, the at least one action comprises the one or more responders or the one or more commanders mitigating one or more active threats associated with the emergency.

In some embodiments, the trained machine learning model is obtained by: training the model using (1) a first and second set subset of the set of user data, (2) a first and second subset of the responder data, and (3) associating an action score with each of the first and second subsets of the user data or responder data; validating the model on an independent subset of the user data or the responder data; and selecting a threshold performance for the validated model such that the validated model determines the at least action based at least on each of the action scores, wherein the threshold performance is indicative of a likelihood of the at least one action resolving the emergency.

In some cases, the first subset of the user data can be used to train the ML model, and the second subset of the user data can be used to test the ML model. In some cases, features may be extracted from the user data to train and test the ML model. Additionally, the user data can be labeled to aid in training and testing the ML model. Labeling can include assigning action scores to the user data. The action score can comprise a value from 0 to 1 indicating a likelihood of the data or features being strongly associated (values near 1) or weakly associated (values near 0) with a positive outcome for resolving the emergency, e.g., eliminating or mitigating the actual or active threat with minimum or no casualties or injuries. The action score may be associated with classifying the user actions as likely or unlikely to be successful. For example, user location data indicating that (1) the user is in a building and structural data indicating (2) nearness to an emergency exit may assign a higher action score (e.g., classify the action as more likely to succeed) to fleeing through the emergency exit than another user who is further away from the emergency exit (e.g., classify the action as less likely to succeed).

In some cases, the first subset of the responder data can be used to train the ML model, and the second subset of the responder data can be used to test the ML model. In some cases, features may be extracted from the responder data to train and test the ML model. Additionally, the responder data can be labeled to aid in training and testing the ML model. Labeling can include assigning action scores to the responder data. The action score can comprise a value from 0 to 1 indicating a likelihood of the data or features being strongly associate (values near 1) or weakly associated (values near 0) with a positive outcome for resolving the emergency, e.g., eliminating or mitigating the actual or active threat with minimum or no casualties or injuries. The action score may be associated with classifying the responder actions as likely or unlikely to be successful. For example, responder location data indicating that (1) the responder is near a user and user status data indicating (2) the user is injured may assign a higher action score (e.g., classify the action as more likely to succeed) to responding to the injured user than another responder who is further away from the injured user (e.g., classify the action as less likely to succeed).

In some cases, the model can be validated on independent subset of the user data or features or the responder data or features. The user data or the responder data for validation may different than the data used for training and testing. Additionally, the user data or the responder data may not be labeled. The model may be considered validated upon meeting a threshold performance. Threshold performance of ML models can include typical metrics for assessing performance of ML models, e.g., area under the curve (AUC), positive predictive value (PPV), negative predictive (NPV), or accuracy. For example, the model may be validated when the threshold performance obtains an accuracy. The accuracy can be an accuracy of at least about 60%, 70%, 80%, 90%, or more likelihood of resolving the emergency.

Different machine learning methods implemented as algorithms are suitable as approaches to perform the methods described herein. Such methods include but are not limited to supervised learning approaches, unsupervised learning approaches, semi-supervised approaches, or any combination thereof.

Machine learning algorithms may include, without limitation, neural networks (e.g., artificial neural networks (ANN), multi-layer perceptrons (MLP)), support vector machines, k-nearest neighbors, Gaussian mixture model, Gaussian, naive Bayes, decision trees, or radial basis functions (RBF). Linear machine learning algorithms may include without limitation linear regression, logistic regression, naive Bayes classifier, perceptron, or support vector machines (SVMs). Other machine learning algorithms for use with methods according to the disclosure may include without limitation quadratic classifiers, k-nearest neighbor, boosting, decision trees, random forests, neural networks, pattern recognition, Bayesian networks, or Hidden Markov models. Other machine learning algorithms, including improvements or combinations of any of these, commonly used for machine learning, can also be suitable for use with the methods described herein. Any use of a machine learning algorithm in a workflow can also be suitable for use with the methods described herein. The workflow can include, for example, training, testing, validation, cross-validation, nested-cross-validation, feature selection, row compression, data transformation, binning, normalization, standardization, or algorithm selection.

A machine learning algorithm can generally be trained by the following methodology to build a trained machine learning model.
1. Gather a dataset for “training” and “testing” the machine learning algorithm. The dataset can include many features, for example, features associated with user data, responder data, commander data, aerial data, ground data, structural data. The training dataset is used to “train” the machine learning algorithm. The testing dataset is used to “test” the machine learning algorithm. In some cases, the datasets may include labeling of datasets for training and testing.
2. Determine “features” for the machine learning algorithm to use for training and testing. The accuracy of the machine learning algorithm may depend on how the features are represented. For example, feature values may be transformed using one-hot encoding, binning, standardization, or normalization. Also, not all features in the dataset may be used to train and test the machine learning algorithm. Selection of features may depend on, for example, available computing resources and time or importance of features discovered during iterative testing and training.
3. Choose an appropriate machine learning algorithm. For example, a machine learning algorithm described elsewhere herein may be chosen. The chosen machine learning algorithm may depend on, for example, available computing resources and time or whether the prediction is continuous or categorical in nature. The machine learning algorithm is used to build the machine learning model.
4. Build the machine learning model. The machine learning algorithm is run on the gathered training dataset. Parameters (e.g., hyperparameters) of the machine learning algorithm may be adjusted by optimizing performance on the testing dataset or via cross-validation (e.g., nested cross-validation) datasets. After parameter adjustment and learning, the performance of the machine learning algorithm may be validated on a dataset of naive samples (e.g., data that has not been labelled or used during training or testing) that are separate from the training dataset and testing dataset. The built machine learning model can involve feature coefficients, importance measures, or weightings assigned to individual features.

Once the machine learning model is determined as described above (“trained”), it can be used to determine actions in an emergency.

In some embodiments, the trained machine learning model comprises a natural language processing (NLP) model for processing one or more communications associated with the one or more users, the one or more responders, or the one or more commanders to determine the at least one action. As described elsewhere herein, messaging features (e.g., chat features) may be included in user interfaces associated subscriber mobile devices. Subscriber mobile devices can include user devices having user interfaces, responder devices having responder interfaces, or commander devices having commander interfaces. Additionally, subscriber mobile devices can include devices associated with aerial data, devices associated with ground data, or devices associated with structural data. The chat feature can allow communications between one and all (one-to-many) devices, between all and one (many-to-one) device, between one and a subset of all devices, or between subset of all devices and one. Selection thereof can be made through filtering features described elsewhere herein.

The quantity of communication data generated, transmitted, or received via messaging features poses a problem for users, responders, or commanders. Problems can include inefficient human processing of the communication data, inaccurate human understanding of the communication data, and untimely human generation of actions based on the communications data. These problems can cause untimely or inaccurate actions for the users, responders, or commanders and further result in failure to eliminate or mitigate active threats. Natural language processing (NLP) of communication data can help users, responders, or commanders better understand the threat posed and take more appropriate and timely actions to eliminate or mitigate active threats.

Natural language processing can include lexical analysis, syntactic analysis, semantic analysis, disclosure integration, or pragmatic analysis. Lexical analysis can include analyzing the structure of words, e.g., dividing text into paragraphs, sentences, and words. Syntactic analysis can include analyzing grammar, arrangements of words, or the interrelationship between the words. Semantic analysis can include analyzing the possible meanings of a sentence that is clear or semantically correct to determine meaningful insights from text. Disclosure integration can include analyzing the context of a word in a sentence when the word depends upon that sentence. Pragmatic analysis can include analyzing insights from the text in the text's given language.

An example of NLP, e.g., bidirectional encoder representations from transformers (BERT), that can be used to implement methods described herein follows. The present disclosure provides systems and methods for parsing, using NLP, communication data (e.g., chat messages) to extract variables related to user communications, responder communications, or commander communications. System and methods can obtain a plurality of communication data from user devices, responder devices, or commander devices. Systems and methods can process the communication data to be able to categorize and annotate them. An NLP algorithm may be trained on written, dictated, typed, or transcribed communication data. The communication data may be indicative of user status, responder status or commander status described elsewhere herein.

An NLP model may include an encoder, which may convert text from chat messages into vectors of real numbers (i.e., embeddings) in a continuous vector space. The vectors may represent individual words. Vectors that are close to each other in the vector space may represent words that are semantically similar in that such words often appear together in text or are otherwise associated with each other. An encoder may use several different models or techniques to convert transcribed speech to vectors. For example, the encoder can use an n-gram or skip-gram model, a feedforward or recurrent neural network, matrix factorization, byte pair encoding, sub-word regularization, or any combination of such models and techniques. An encoder may convert words, syllables, phenomes, or characters from the transcribed speech into vectors, depending on the particular model or technique the encoder may use.

An NLP model or ensemble of NLP models may comprise a neural network. For example, an NLP model may have a long short-term memory (LSTM) network. An LSTM network is a type of recurrent neural network (RNN). RNNs are neural networks with cyclical connections that can encode dependencies in time-series data, e.g., in communication data. An RNN can include an input layer that is configured to receive a sequence of time-series inputs. An RNN may additionally include one or more hidden recurrent layers that maintain a state. At each time step, each hidden recurrent layer can compute an output and a next state for the layer. The next state may depend on the previous state and the current input. The state may be maintained across time steps and may capture dependencies in the input sequence.

An LSTM network may be made of LSTM units. An LSTM unit may include of a cell, an input gate, an output gate, and a forget gate. The cell may be responsible for keeping track of the dependencies between the elements in the input sequence. The input gate can control the extent to which a new value flows into the cell, the forget gate can control the extent to which a value remains in the cell, and the output gate can control the extent to which the value in the cell is used to compute the output activation of the LSTM unit. The activation function of the LSTM gate may be the logistic function.

Alternatively, an NLP model may comprise a transformer. A transformer may be a model without recurrent connections. Instead, it may rely on an attention mechanism. Attention mechanisms may focus on, or attend to, certain input regions while ignoring others. This may increase model performance because certain input regions may be less relevant. At each time step, an attention unit can compute a dot product of a context vector and the input at the time step, among other operations. The output of the attention unit may define where the most relevant information in the input sequence is located. The transformer may rely on non-language-related metadata information in determining what input regions to attend to.

An NLP model may include one or more classifiers. For example, an NLP model may include a binary classifier or a regression classifier. A softmax function may be applied to the output layer of a regression classifier to produce a probability range.

The NLP model described above may have a specificity of at least about 60%, 65%, 70%, 80%, 85%, 90%, 95%, or more. The NLP model may have a sensitivity of at least about 60%, 65%, 70%, 80%, 85%, 90%, 95%, or more. Increasing the specificity of the model may require decreasing the sensitivity, and vice versa. The NLP model may have an AUC of at least about 60%, 65%, 70%, 80%, 85%, 90%, 95%, or more. The NLP model may provide a relative performance (e.g., sensitivity, specificity, or AUC) improvement of at least about 1%, 2%, 3%, 4%, 5%, 10%, 15%, 20%, 25%, or more over prior systems.

The following is a description of an example BERT encoder which may be used to implement aspects of this disclosure. The below description should not be construed to limit any other section of this disclosure. The described process may be used to create contextual embeddings of words in a text document, to enable downstream processing (e.g., NLP or NLU) tasks. For example, the contextual embeddings created in the process described herein, or a similar process, applied to chat messages, may be used downstream to assist with determining or predicting actions in response to emergencies.

BERT may begin with text processing by dividing the text into segments or “tokens.” Tokens may correspond roughly to words and punctuation, although a word can also be split into several tokens if it contains a common prefix or suffix.

Next, BERT may associate each token with an embedding, which may be a vector of real numbers. For example, trained embeddings may be provided by responders or commanders. Additionally, one may use a token dictionary to convert the tokens into embedding vectors. For example, a dictionary may be a data structure that stores tokens as keys and their corresponding embeddings as values. The values inside an embedding may carry information about the meaning of the token, but they also may be configured to be mathematically manipulated. The mathematical operations performed on the embeddings may correspond to semantic changes (e.g., changing the gender of a noun or the tense of a verb). Because embeddings may be associated with tokens by a straight dictionary lookup, a particular token may be associated with a particular embedding, regardless of the context of the token in the original text.

BERT may use an attention mechanism such as scaled dot (or scalar)-product self-attention. This form of attention may transform default embeddings associated with particular tokens by incorporating information derived from the whole sequence of tokens in the text to be analyzed. In this way, the transformed embeddings may be more representative of the tokens they represent in the context of the sentence or note.

For example, for a particular sequence of tokens, “leg is shot and blood is bright red”, each token may be initially replaced by its default embedding, which in this case may be a vector with 768 components. BERT may then proceed to calculating scalar products between pairs of embeddings, including embeddings with themselves. When two vectors are more correlated, their scalar product is larger in magnitude, signifying a strong relationship between the two. In the case of embedding vectors, correlated vectors may imply that the tokens corresponding to the embeddings have similar content. Conversely, a lower scalar product may imply that two embeddings are less related. BERT may calculate the scalar product for every possible pair of embedding vectors in the input sequence. The calculated products may be downscaled or normalized to avoid producing large values, improving the behavior of the algorithm. For example, here, the calculated products may be divided by the square root of 768, the size of the embedding vectors.

Following downscaling or normalization, the scaled products may be processed by softmax activation function. The softmax may exponentially amplify large values, while sharply reducing negative and small positive values towards zero. Each input token's scaled product with every other token may get processed by the softmax function together. The softmax function performs a normalization so that the softmax-processed scaled products for a particular token can together sum to 1. For example, for tokens A, B, C, and D, after processing with the softmax, the normalized embeddings for A*A+A*B+A*C,+A*D=1, and B*A+B*B+B*C+B*D=1, and so too can corresponding processed products for embeddings for tokens C and D.

BERT may then create a new embedding vector for each token using a linear combination of the input embeddings scaled by the softmax results. The new embedding vectors may be contextualized because they may now have incorporated fractions of every input embeddings corresponding to the particular sequence of tokens. In particular, if a token has a strong relationship with another token, a large fraction of its new contextualized embedding will comprise the related embedding. If a token doesn't relate much to any other, as measured by the scalar product between their input embeddings, its contextualized embedding will be nearly identical its original (default) embedding.

In the disclosed example (“leg is shot and blood is bright red.”), the vector space may encode an “injury” that corresponds to the idea of “severity” (in actuality, the ML process may learn a representation that may not correspond with any human-conceivable idea). The input embeddings of the tokens “shot” and “blood” can both have large magnitude components in that “direction,” and may thus have a stronger relationship and may be more similar. As a result, contextualized embeddings of the “shot” and “blood” tokens may combine both input embeddings in roughly equal parts. On the other hand, the preposition “and” may not implicate the same “injury” concept, so its embedding may show a weak relationship between “and” and the other terms. Thus, little modification of the embedding vector may occur through the attention process.

BERT may modify the input embedding vectors before applying the attention mechanism. To do this, BERT may first linearly project the input vectors to create key, query, and value vectors. The projections may also map input embeddings onto a lower-dimension space. In some embodiments, the key, query, and value vectors all may have 64 components. Each projection may be with respect to a different direction of the vector space, which may correspond to different semantic aspects (e.g., part of speech, topic, sentiment) of the input text. For a human interpretable example, one may imagine that a key is the projection of an embedding onto the direction of “prepositions”, while a query is the projection of an embedding along the direction of “locations”. In the present example, the key of the token “and” may have a strong relationship with every other query, since “and” may be strongly associated (have large magnitude) in the direction of “prepositions”. By contrast, the other tokens (“shot”, “blood”, “red”) may be strongly associated (have large magnitude) in the direction of “injury.” The scalar product of the key and query vectors may be used instead of the scalar product of the default embeddings as in the previous section.

The values may come from yet another projection that is relevant, for example, the direction of “physical places.” The values may be linearly combined with the softmax-processed and normalized scalar products of the key and query vectors to create the contextualized embeddings. This process can be repeated many times with different key, query, and value projections, forming a multi-head attention system. Each head may focus on different projections of the input embeddings. For instance, one head may calculate the preposition/location relationships, while another head can calculate subject/verb relationships, simply by using different projections to create the key, query, and value vectors. The outputs from each head may then be concatenated back in a large vector.

BERT may also be configured to operate using positional embeddings. Positional embeddings are vectors that may include information about a position of a token in the sequence, rather than about the meaning of a token. Using positional embeddings may add information about the token sequence even before attention is applied, and may enable attention to calculate relationships knowing the relative order of the tokens. Because of the nonlinearity introduced by the softmax function, BERT can then achieve even more complex transformations of the embeddings by applying attention repeatedly. BERT may use 12 layers of attention, each with its own set of projections.

### Computing Systems

In another aspect, disclosed herein is a computer program product for determining at least one action in an emergency, the computer program product comprising at least one non-transitory computer-readable medium having computer-readable program code portions embodied therein, the computer-readable program code portions comprising: an executable portion configured to receive or transmit a set of user data associated with one or more users; an executable portion configured to receive or transmit a set of responder data associated with one or more responders; an executable portion configured to process, via a trained machine learning model, the set of user data or the set of responder data to generate the at least one action; and an executable portion configured to transmit the at least one action to the one or more commanders, wherein the one or more commanders direct the one or more users or the one or more responders to perform the at least one action during the emergency.

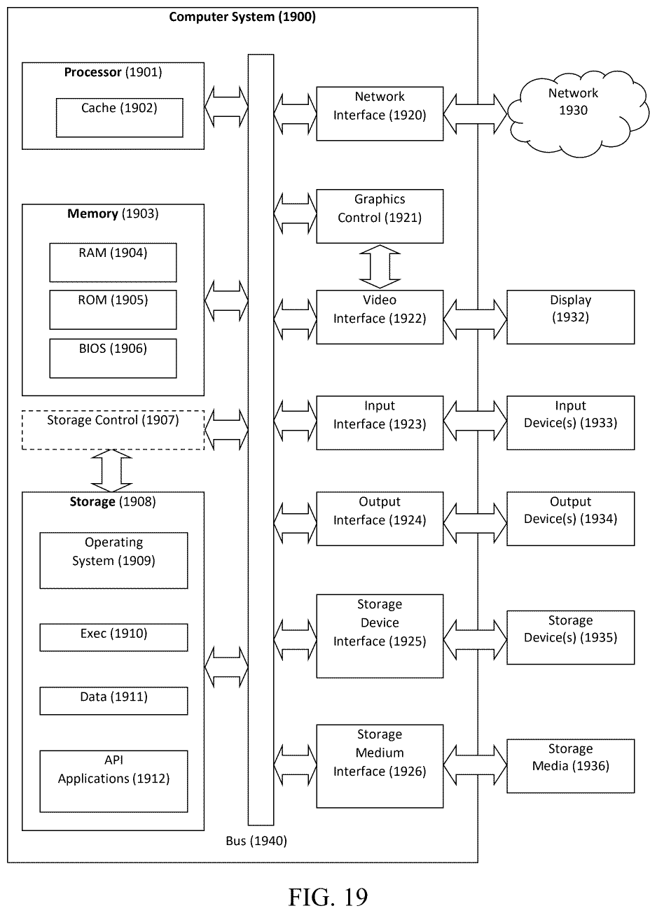

Referring to FIG. 19, a block diagram is shown depicting an exemplary machine that includes a computer system 1900 (e.g., a processing or computing system) within which a set of instructions can execute for causing a device to perform or execute any one or more of the aspects and/or methodologies herein. The components in FIG. 19 are examples only and do not limit the scope of use or functionality of any hardware, software, embedded logic component, or a combination of two or more such components implementing particular embodiments.

Computer system 1900 may include one or more processors 1901, a memory 1903, and a storage 1908 that communicate with each other, and with other components, via a bus 1940. The bus 1940 may also link a display 1932, one or more input devices 1933 (which may, for example, include a keypad, a keyboard, a mouse, a stylus, etc.), one or more output devices 1934, one or more storage devices 1935, and various tangible storage media 1936. All of these elements may interface directly or via one or more interfaces or adaptors to the bus 1940. For instance, the various tangible storage media 1936 can interface with the bus 1940 via storage medium interface 1926. Computer system 1900 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1900 includes one or more processor(s) 1901 (e.g., central processing units (CPUs) or general purpose graphics processing units (GPGPUs)) that carry out functions. Processor(s) 1901 optionally contains a cache memory unit 1902 for temporary local storage of instructions, data, or computer addresses. Processor(s) 1901 are configured to assist in execution of computer readable instructions. Computer system 1900 may provide functionality for the components depicted in FIG. 19 as a result of the processor(s) 1901 executing non-transitory, processor-executable instructions embodied in one or more tangible computer-readable storage media, such as memory 1903, storage 1908, storage devices 1935, and/or storage medium 1936. The computer-readable media may store software that implements particular embodiments, and processor(s) 1901 may execute the software. Memory 1903 may read the software from one or more other computer-readable media (such as mass storage device(s) 1935, 1936) or from one or more other sources through a suitable interface, such as network interface 1920. The software may cause processor(s) 1901 to carry out one or more processes or one or more steps of one or more processes described or illustrated herein. Carrying out such processes or steps may include defining data structures stored in memory 1903 and modifying the data structures as directed by the software.

The memory 1903 may include various components (e.g., machine readable media) including, but not limited to, a random access memory component (e.g., RAM 1904) (e.g., static RAM (SRAM), dynamic RAM (DRAM), ferroelectric random access memory (FRAM), phase-change random access memory (PRAM), etc.), a read-only memory component (e.g., ROM 1905), and any combinations thereof. ROM 1905 may act to communicate data and instructions unidirectionally to processor(s) 1901, and RAM 1904 may act to communicate data and instructions bidirectionally with processor(s) 1901. ROM 1905 and RAM 1904 may include any suitable tangible computer-readable media described below. In one example, a basic input/output system 1906 (BIOS), including basic routines that help to transfer information between elements within computer system 1900, such as during start-up, may be stored in the memory 1903.

Fixed storage 1908 is connected bidirectionally to processor(s) 1901, optionally through storage control unit 1907. Fixed storage 1908 provides additional data storage capacity and may also include any suitable tangible computer-readable media described herein. Storage 1908 may be used to store operating system 1909, executable(s) 1910, data 1911, applications 1912 (application programs), and the like. Storage 1908 can also include an optical disk drive, a solid-state memory device (e.g., flash-based systems), or a combination of any of the above. Information in storage 1908 may, in appropriate cases, be incorporated as virtual memory in memory 1903.

In one example, storage device(s) 1935 may be removably interfaced with computer system 1900 (e.g., via an external port connector (not shown)) via a storage device interface 1925. Particularly, storage device(s) 1935 and an associated machine-readable medium may provide non-volatile and/or volatile storage of machine-readable instructions, data structures, program modules, and/or other data for the computer system 1900. In one example, software may reside, completely or partially, within a machine-readable medium on storage device(s) 1935. In another example, software may reside, completely or partially, within processor(s) 1901.

Bus 1940 connects a wide variety of subsystems. Herein, reference to a bus may encompass one or more digital signal lines serving a common function, where appropriate. Bus 1940 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1900 may also include an input device 1933. In one example, a user of computer system 1900 may enter commands and/or other information into computer system 1900 via input device(s) 1933. Examples of an input device(s) 1933 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect®, Leap Motion®, or the like. Input device(s) 1933 may be interfaced to bus 1940 via any of a variety of input interfaces 1923 (e.g., input interface 1923) including, but not limited to, serial, parallel, game port, USB, FIREWIRE, THUNDERBOLT, or any combination of the above.

In particular embodiments, when computer system 1900 is connected to network 1930, computer system 1900 may communicate with other devices, specifically mobile devices and enterprise systems, distributed computing systems, cloud storage systems, cloud computing systems, and the like, connected to network 1930. Communications to and from computer system 1900 may be sent through network interface 1920. For example, network interface 1920 may receive incoming communications (such as requests or responses from other devices) in the form of one or more packets (such as Internet Protocol (IP) packets) from network 1930, and computer system 1900 may store the incoming communications in memory 1903 for processing. Computer system 1900 may similarly store outgoing communications (such as requests or responses to other devices) in the form of one or more packets in memory 1903 and communicated to network 1930 from network interface 1920. Processor(s) 1901 may access these communication packets stored in memory 1903 for processing.

Examples of the network interface 1920 include, but are not limited to, a network interface card, a modem, and any combination thereof. Examples of a network 1930 or network segment 1930 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1930, may employ a wired and/or a wireless mode of communication. In general, any network topology may be used.

Information and data can be displayed through a display 1932. Examples of a display 1932 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1932 can interface to the processor(s) 1901, memory 1903, and fixed storage 1908, as well as other devices, such as input device(s) 1933, via the bus 1940. The display 1932 is linked to the bus 1940 via a video interface 1922, and transport of data between the display 1932 and the bus 1940 can be controlled via the graphics control 1921. In some embodiments, the display is a video projector. In some embodiments, the display is a head-mounted display (HMD) such as a VR headset. In further embodiments, suitable VR headsets include, by way of non-limiting examples, HTC Vive®, Oculus Rift®, Samsung Gear VR®, Microsoft HoloLens®, Razer OSVR®, FOVE VR®, Zeiss VR One®, Avegant Glyph®, Freefly VR® headset, and the like. In still further embodiments, the display is a combination of devices such as those disclosed herein.

In addition to a display 1932, computer system 1900 may include one or more other peripheral output devices 1934 including, but not limited to, an audio speaker, a printer, a storage device, and any combinations thereof. Such peripheral output devices may be connected to the bus 1940 via an output interface 1924. Examples of an output interface 1924 include, but are not limited to, a serial port, a parallel connection, a USB port, a FIREWIRE port, a THUNDERBOLT port, and any combinations thereof.

In addition or as an alternative, computer system 1900 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD®, OpenBSD®, NetBSD®, Linux®, Apple® Mac OS X Server®, Oracle Solaris®, Windows Server®, and Novell NetWare®. Suitable personal computer operating systems include, by way of non-limiting examples, Microsoft Windows®, Apple Mac® OS X, UNIX®, and UNIX-like operating systems such as GNU/Linux®. In some embodiments, the operating system is provided by cloud computing. Suitable mobile smartphone operating systems include, by way of non-limiting examples, Nokia Symbian® OS, Apple® iOS, Research In Motion BlackBerry® OS, Google® Android®, Microsoft® Windows Phone® OS, Microsoft® Windows Mobile OS, Linux®, and Palm® WebOS. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft® Xbox 360®, Microsoft Xbox One®, Nintendo Wii®, Nintendo Wii U®, and Ouya®. Suitable virtual reality headset systems include, by way of non-limiting example, Meta Oculus®.

### Non-Transitory Computer Readable Storage Mediums

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Applications

In some embodiments, a computer program includes a web application. In light of the disclosure provided herein, a web application, in various embodiments, utilizes one or more software frameworks and one or more database systems. In some embodiments, a web application is created upon a software framework such as Microsoft® .NET or Ruby on Rails® (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® structured query language (SQL) Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML® (AJAX), Flash Actionscript, Javascript®, or Silverlight®. In some embodiments, a web application is written to some extent in a server-side coding language such as Active Server Pages® (ASP), ColdFusion®, Perl®, Java®, JavaServer Pages® (JSP), Hypertext Preprocessor® (PHP), Python®, Ruby®, Tcl®, Smalltalk®, WebDNA®, or Groovy®. In some embodiments, a web application is written to some extent in a database query language such as Structured Query Language (SQL). In some embodiments, a web application integrates enterprise server products such as IBM Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java®, and Unity®.

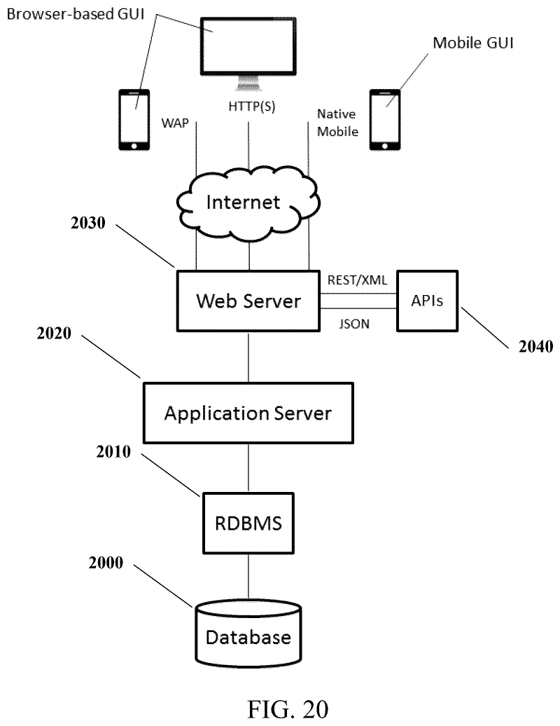

Referring to FIG. 20, in a particular embodiment, an application provision system comprises one or more databases 2000 accessed by a relational database management system (RDBMS) 2010. Suitable RDBMSs include Firebird®, MySQL®, PostgreSQL®, SQLite®, Oracle Database®, Microsoft SQL Server®, IBM DB2®, IBM Informix®, SAP Sybase®, SAP Sybase®, Teradata®, PostGIS®, time-series databases, graph databases, and the like. In this embodiment, the application provision system further comprises one or more application severs 2020 (such as Java® servers, .NET® servers, PHP® servers, and the like) and one or more web servers 2030 (such as Apache®, IIS®, GWS® and the like). The web server(s) optionally expose one or more web services via app application programming interfaces (APIs) 2040. Via a network, such as the Internet, the system provides browser-based and/or mobile native user interfaces.

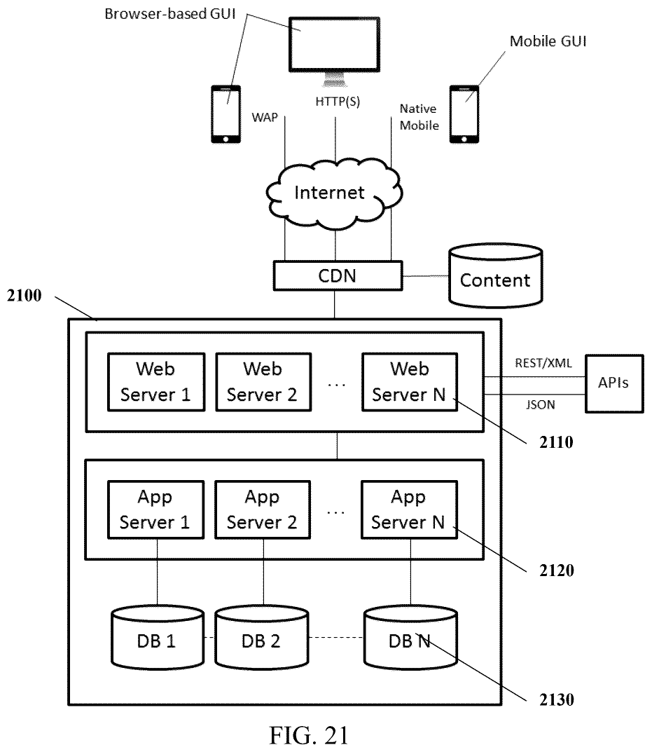

Referring to FIG. 21, in a particular embodiment, an application provision system alternatively has a distributed, cloud-based architecture 2100 and comprises elastically load balanced, auto-scaling web server resources 2110 and application server resources 2120 as well synchronously replicated databases 2130.

### Mobile Applications

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques using hardware, languages, and development environments. Mobile applications are written in several languages. Suitable programming languages include, by way of non-limiting examples, C, C++, C#, Objective-C, Java®, Javascript®, Pascal®, Object Pascal®, Python™, Ruby®, VB.NET®, WML®, and XHTML/HTML with or without CSS, or combinations thereof.

Suitable mobile application development environments are available from several sources. Commercially available development environments include, by way of non-limiting examples, AirplaySDK®, alcheMo®, Appcelerator®, Celsius®, Bedrock®, Flash Lite®, .NET Compact Framework®, Rhomobile®, and WorkLight Mobile Platform®. Other development environments are available without cost including, by way of non-limiting examples, Lazarus®, MobiFlex®, MoSync®, and Phonegap®. Also, mobile device manufacturers distribute software developer kits including, by way of non-limiting examples, iPhone® and iPad® (iOS) SDK, Android® SDK, BlackBerry® SDK, BREW SDK, Palm® OS SDK, Symbian® SDK, webOS® SDK, and Windows® Mobile SDK.

Several commercial forums are available for distribution of mobile applications including, by way of non-limiting examples, Apple® App Store, Google® Play, Chrome® WebStore, BlackBerry® App World, App Store® for Palm devices, App Catalog® for webOS, Windows® Marketplace for Mobile, Ovi Store for Nokia® devices, Samsung® Apps, and Nintendo® DSi Shop.

### Standalone Applications

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C®, COBOL®, Delphi®, Eiffel®, Java®, Lisp®, Python®, Visual Basic®, and VB .NET®, or combinations thereof. Compilation is often performed, at least in part, to create an executable program. In some embodiments, a computer program includes one or more executable compiled applications. Additionally, microservices related to Python® and JavaScript® may be used.

### Web Browser Plug-Ins

In some embodiments, the computer program includes a web browser plug-in (e.g., web extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins may include Adobe Flash Player®, Microsoft Silverlight®, and Apple QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, several plug-in frameworks are available that enable development of plug-ins in various programming languages, including, by way of non-limiting examples, C++, Delphi®, Java®, PHP®, Python®, and VB. NET®, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft Internet Explorer®, Mozilla Firefox®, Google Chrome®, Apple Safari®, Opera Software Opera®, and KDE Konqueror®. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android® browser, RIM BlackBerry® Browser, Apple Safari®, Palm Blazer®, Palm WebOS® Browser, Mozilla Firefox® for mobile, Microsoft Internet Explorer Mobile®, Amazon Kindle Basic Web®, Nokia Browser®, Opera Software Opera Mobile®, and Sony PSP® browser.

### Software Modules

In some embodiments, the platforms, systems, media, and methods disclosed herein include software, server, and/or database modules, or use of the same. In view of the disclosure provided herein, software modules are created by techniques using machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases (DB), or use of the same. In view of the disclosure provided herein, many databases are suitable for storage and retrieval data. In various embodiments, suitable databases include, by way of non-limiting examples, relational databases, non-relational databases, object oriented databases, object databases, entity-relationship model databases, associative databases, XML databases, time-series databases, graph databases, and the like. Further non-limiting examples include SQL, PostgreSQL®, MySQL®, Oracle®, DB2®, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Terms and Definitions

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, in some cases, the terms “machine learning,” “artificial intelligence,” or “natural language processing” can be used interchangeably.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations or relative proportions set forth herein which depend upon a variety of conditions and variables. It can be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

1. A method for determining at least one action in an emergency, the method comprising:
(a) receiving a set of user data associated with one or more users;
(b) receiving a set of responder data associated with one or more responders;
(c) processing, via a trained machine learning model, the set of user data or the set of responder data to generate the at least one action; and
(d) transmitting the at least one action to one or more commanders, wherein the one or more commanders direct the one or more users or the one or more responders to perform the at least one action during the emergency.

2. The method of claim 1, wherein the emergency is associated with one or more active threats on a same or different campus, workplace, or commercial establishment.

3. The method of claim 1, wherein the trained machine learning model is obtained by:
(a) training the model using (1) a first and second set subset of the set of user data, (2) a first and second subset of the responder data, and (3) associating an action score with each of the first and second subsets of the user data or responder data;
(b) validating the model on an independent subset of the user data or the responder data; and
(c) selecting a threshold performance for the validated model such that the validated model determines the at least one action based at least on each of the action scores, wherein the threshold performance is indicative of a likelihood of the at least one action resolving the emergency.

4. The method of claim 1, wherein the trained machine learning model comprises a natural language processing (NLP) model for processing one or more communications associated with the one or more users, the one or more responders, or the one or more commanders to determine the at least one action.

5. The method of claim 1, wherein the method occurs in a mode comprising an actual emergency mode or a training emergency mode.

6. The method of claim 1, wherein the set of user data comprises user communications data, user status data, or user location data.

7. The method of claim 1, wherein the set of responder data comprises responder communications data, responder status data, responder location data, or responder navigation data.

8. The method of claim 1, wherein the one or more commanders are associated with a set of commander data comprising commander communications data, commander status data, commander location data, or commander navigation data.

9. The method of claim 1, wherein the at least one action associated with the one or more users comprises a user communication action, a fortify action, a flee action, an injury action, or a user status action.

10. The method of claim 1, wherein the at least one action associated with the one or more responders comprises a responder communication action, a respond action, a command action, or a responder status action.

11. The method of claim 1, wherein the at least one action associated with the one or more commanders comprises a commander communication action, a respond action, an aerial action, a ground action, an intervention action, or a reunify action.

12. The method of claim 1, wherein the at least one action comprises the one or more responders or the one or more commanders mitigating one or more active threats associated with the emergency.

13. The method of claim 1, further comprising:
(a) receiving a set of aerial data, ground data, or structural data; and
(b) processing, via the trained machine learning model, the set of aerial data, ground data, or structural data to generate the at least one action.

14. The method of claim 13, wherein the set of aerial data comprises data associated with or received from one or more unmanned aerial vehicles, one or more manned aerial vehicles, or any combination thereof.

15. The method of claim 13, wherein the set of ground data comprises data associated with or received from one or more image devices, one or more security doors, one or more communications towers, one or more networked devices, or any combination thereof.

16. The method of claim 13, where the set of structural data comprises data associated with or received from one or more architectural plans, one or more aerial images, one or more satellite images, or any combination thereof.

17. The method of claim 1, further comprising:
(a) transmitting the at least one action to the one or more users, the one or more responders, or the one or more commanders,
wherein the transmitting is via a communications network configured with the one or more users in communication with the one or more responders or the one or more commanders.

18. The method of claim 1, further comprising:
(a) determining a reunification status of the one or more users; and
(b) transmitting the reunification status to the one or more responders or the one or more commanders.

19. The method of claim 18, wherein the reunification status comprises: unaccounted for status, accounted for status, released to a guardian status, released to emergency medical services (EMS) status, absent status, other status, or any combination thereof.

20. The method of claim 1, wherein the one or more users transmit the set of user data to the one or more responders, the one or more commanders, or at least another user of the one or more users.

21. The method of claim 1, wherein the one or more responders transmit the set of responder data to the one or more users, the one or more commanders, or at least another responder of the one or more responders.

22. The method of claim 1, wherein the one or more commanders transmit a set of commander data to the one or more users, the one or more responders, or at least another commander of the one or more commanders.

23. The method of claim 1, wherein the one or more users receive the set of responder data from the one or more responders or a set of commander data from the one or more commanders.

24. The method of claim 1, wherein the one or more responders receive the set of user data from the one or more users or a set of commander data from the one or more commanders.

25. The method of claim 1, wherein the one or more commanders receive the set of user data from the one or more users or the set of responder data from the one or more commanders.

26. The method of claim 1, wherein before the at least one action is transmitted to the one or more commanders, the at least one action is transmitted to the one or more users to perform during the emergency.

27. The method of claim 1, wherein before the at least one action is transmitted to the one or more commanders, the at least one action is transmitted to the one or more responders to perform during the emergency.

28. The method of claim 1, wherein before the at least one action is transmitted to the one or more commanders, the at least one action is transmitted to the one or more users or the one or more responders to perform during the emergency.

29. The method of claim 28, wherein the one or more users and the one or more responders transmit the at least one action to each other to perform during the emergency.

30. The method of claim 1, further comprising determining, via the trained machine learning model, a threat assessment of one or more active threats.

31. The method of claim 30, wherein the at least one action comprises automatically deploying one or more threat countermeasures based at least on the threat assessment.

32. The method of claim 30, wherein the at least one action comprises automatically controlling at least one security door based at least on the threat assessment.

33.-34. (canceled)
